SEQUENCE LISTING (2 sequences)

SEQ ID NO: 1 - DNA, 21 bp, Artificial Sequence
  Amplification Primer
caggcctaacacatgcaagtc

SEQ ID NO: 2 - DNA, 18 bp, Artificial Sequence
  Primer Sequence
acgggcggtgtgtacaag

(19) United States
(12) Patent Application Publication
(10) Pub. No.: US 2010/0093064 A1
(43) Pub. Date: Apr. 15, 2010

(54) Metagenomic Functional Selection

(75) Inventors: GEORGE M. CHURCH, Brookline, MA (US); MORTEN O. SOMMER, Boston, MA (US); Gautam Dantas, University City, MO (US)

Correspondence Address: BANNER & WITCOFF, LTD., 28 STATE STREET, SUITE 1800, BOSTON, MA, 02109-1701, US

(73) Assignee: PRESIDENT AND FELLOWS OF HARVARD COLLEGE, CAMBRIDGE, MA (US)

(21) Appl. No.: 12/579,533

(22) Filed: Oct. 15, 2009

Related U.S. Application Data
(60) Provisional application No. 61/105,597, filed on Oct. 15, 2008.

(51) Int. Cl. A62D 3/02; C40B 30/06

(52) U.S. Cl. 435/262.5; 506/10

(57) ABSTRACT

Methods and compositions for directly selecting a nucleic acid sequence that confers resistance to an inhibitory compound are provided. Methods and compositions for decontaminating contaminated substances are provided. Microorganisms having resistance to an inhibitory compound are also provided.

### PRIORITY INFORMATION

This application claims priority to U.S. Provisional Patent Application No. 61/105,597, filed on Oct. 15, 2008 and is hereby incorporated herein by reference in its entirety for all purposes.

### STATEMENT OF GOVERNMENT INTERESTS

This invention was made with Government support under DE-FG02-03ER63445 (T-103693) awarded by the U.S. Department of Energy. The Government has certain rights in the invention.

### BACKGROUND

Current methods for improving microbial characteristics by complementation with exogenous DNA have primarily relied on culturing a first set of organisms which harbors the target characteristic(s), significant genotypic and phenotypic characterization of the set of organisms, cloning of the genetic machinery suspected to encode the target characteristic(s), transfer of this genetic machinery to the host organism of interest, and functional testing of whether the genetic transfer also results in the intended phenotypic improvement in the host. This process is extremely tedious, and more importantly, does not access the 99-99.9% of environmental microbes which are not culturable by standard laboratory techniques.

### SUMMARY

Methods and compositions described herein replace the tedious process of microbial isolation, characterization, phenotypic selection and subsequent genetic transfer with direct selection of the exogenous microbial genetic machinery in the host organism, and additionally accesses significantly more microbial diversity since it is independent of initial culturing of environmental microbes. Methods and compositions described herein also offer a significant advance over the few previously reported approaches for successfully harvesting genes and operons conferring novel or improved functionality from metagenomic libraries, which have relied on costly screening of large numbers of clones for desirable phenotypes. The methods and compositions described herein replace large-scale screening with a significantly more efficient selection, since the library population is selected in bulk and only library transformants that confer tolerance to the normally inhibitory physical or chemical condition being assayed will survive the selection. Even compared with extremely high-throughput screening techniques, direct bulk selection provides the ability to assay many orders of magnitude more genetic diversity, concomitantly increasing the chance of discovering novel functional genes and operons.

Accordingly, in certain exemplary embodiments, a method of directly selecting a nucleic acid sequence that confers resistance to an inhibitory compound is provided. The method includes the steps of isolating a plurality of first microorganisms, creating a nucleic acid insert library directly from the isolated plurality of first microorganisms, transforming a plurality of second microorganisms with the nucleic acid insert library, contacting the transformed plurality of second microorganisms with an inhibitory concentration of the inhibitory compound, and isolating a transformed second microorganism that is resistant to an inhibitory effect of the compound. In certain aspects, the plurality of first microorganisms is a plurality of bacteria. In other aspects, the plurality of first microorganisms is isolated from an endogenous source such as, e.g., one or more of a biomass, a mammalian sample and an environmental sample (e.g., one or both of water and soil). In certain aspects, the environmental sample is obtained from a toxic environment. In other aspects, the mammalian sample is derived from a human. In certain aspects, the inhibitory compound is one or more of an antibiotic, a heavy metal, a radioactive compound, a compound present in untreated biomass and a biomass byproduct. In other aspects, the plurality of second microorganisms is E. coli. In yet other aspects, the nucleic acid insert library is a genomic insert library, wherein the inserts are optionally about 30 kilobases or larger, about 40 kilobases or larger, or between about 40 kilobases and about 50 kilobases.

In certain exemplary embodiments, a method of creating a microorganism having resistance to an inhibitory compound is provided. The method includes isolating a plurality of first microorganisms, creating a nucleic acid insert library directly from the isolated plurality of first microorganisms, transforming a plurality of second microorganisms with the nucleic acid insert library, contacting the transformed plurality of second microorganisms to an inhibitory concentration of the inhibitory compound, isolating a transformed second microorganism that is resistant to an inhibitory effect of the compound, isolating a nucleic acid sequence from the second microorganism that confers resistance, and introducing the nucleic acid sequence into a third microorganism to create a microorganism having resistance to the inhibitory compound. In certain aspects, the plurality of first microorganisms is a plurality of bacteria. In other aspects, the inhibitory compound is selected from the group consisting of an antibiotic, a heavy metal, a radioactive compound, a compound present in untreated biomass and a biomass byproduct.

In certain exemplary embodiments, a method of using the microorganism described above to decontaminate a contaminated substance is provided. The method includes contacting a contaminated substance with the microorganism, and culturing the microorganism with the contaminated substance for an amount of time sufficient to reduce contamination of the contaminated substance. In certain aspects, the contaminated substance is selected from the group consisting of contaminated soil, contaminated water and a contaminated work surface. In other aspects, the contaminated substance is a byproduct of a manufacturing process. In still other aspects, the contaminated substance is an antibiotic, a radioactive compound or a heavy metal.

Further features and advantages of certain embodiments of the present invention will become more fully apparent in the following description of the embodiments and drawings thereof, and from the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The foregoing and other features and advantages of the present invention will be more fully understood from the following detailed description of illustrative embodiments taken in conjunction with the accompanying drawings in which:

FIG. 1 schematically depicts a functional metagenomic platform for discovery of novel functional parts from diverse environmental microbiomes. Shown is a schematic detailing the key steps required for selecting functional parts from diverse environments that confer a desired selective advantage to a microbial catalyst. Metagenomic DNA is directly extracted from arbitrary environmental samples without prior culturing steps, purified, and transformed into a microbial chassis of interest. The entire library of putative functional parts is subjected to a selection pressure (e.g. chemicals at inhibitory concentrations or recalcitrant substrates) which only allows survival of chassis-containing functional parts which counteract the selection pressure (e.g. by allowing utilization of the recalcitrant substrates or by conferring tolerance by intracellular or extracellular inactivation or efflux of the inhibitory compound). This scheme is ideally suited for discovery of novel functional parts for biomass conversion to biofuels.

FIGS. 2A-2B graphically depict selection and characterization of functional parts from metagenomic libraries conferring biomass inhibitor tolerance to E. coli. 1-2 gigabase metagenomic libraries derived from 5 different soils were transformed into E. coli and selected on 14 biomass chemicals at concentrations that inhibit the growth of untransformed E. coli. (A) Heat-map illustrating successful selection of E. coli clones containing metagenomically-derived functional parts which confer tolerance to 7 of 14 biomass inhibitors. Black squares indicate successful selection of tolerant metagenomic clones. Three clones tolerant to 4-methylcatechol (mgMetCat), 2-furoic acid (mgFurAc) and syringaldehyde (mgSyrAld), respectively, were selected for further characterization of the improved tolerance phenotype. (B) Inhibitor concentrations resulting in 90% reductions in growth yield were determined for wild-type E. coli as 1.05 g/L, 1.33 g/L and 0.33 g/L for 2-furoic acid, syringaldehyde and methylcatechol, respectively. Improvements in biomass yield at these concentrations due to mgFurAc, mgSyrAld and mgMetCat, respectively, were 6.9-fold, 5.7-fold and 6.0-fold, respectively, displayed here as the mean (and standard deviation) of triplicate readings.

FIGS. 3A-3B schematically depict sequence annotation and functional analysis of selected parts improving biomass inhibitor tolerance in E. coli. Metagenomic inserts conferring tolerance to 2-furoic acid (mgFurAc) and syringaldehyde (mgSyrAld) in E. coli were selected from 2 gigabase metagenomic DNA libraries created from two different soils. The selected inserts were sequenced at 3× coverage, assembled using Phred/Phrap, and annotated with the Rapid Annotation using Subsystem Technology Server version 2.0 (R. K. Aziz et al., BMC Genomics 9:75 (2008)). Annotated genes for (A) mgFurAc and (B) mgSyrAld are shown as filled arrows, with the orientation denoting the relative direction of transcription based on an arbitrary sense strand. Transposon mutagenesis, followed by reselection of the tolerance phenotypes, was used to identify functional genetic parts in mgFurAc and mgSyrAld that contribute to the selected phenotypes (genes colored red and labeled). Vertical bars along the bottom of each sequence-position axis denote positions of transposon insertion in the loss-of-function study (black denotes no effect, red denotes loss-of-function).

FIG. 4 graphically depicts growth kinetics of E. coli containing selected metagenomic functional parts encoding resistance to three lignocellulosic inhibitors. Growth kinetics of E. coli containing mgFurAc (left panels, blue), mgSyrAld (middle panels, green) and mgMetCat (right panels, yellow) versus the E. coli control (all panels, red) are shown at 6 different concentrations of 2-furoic acid, syringaldehyde and 4-methylcatechol, respectively. Each plot shows the mean of triplicate readings with standard-deviation shown as error-bars for each mgDNA clone and E. coli control, measured as 600 nm readings every 5 minutes over 24 hours at 37° C. with shaking in a Versamax microplate reader.

FIG. 5 graphically depicts membrane topology prediction of the 111 amino-acid mgFurAc hypothetical protein responsible for the 2-furoic acid tolerance phenotype, as predicted by the Phobius Server (L. Kall, A. Krogh, E. L. Sonnhammer, J Mol Biol 338, 1027 (May 14, 2004)).

FIG. 6 graphically depicts soil microbiomes selected for the ability to subsist on lignocellulosic compounds. The heat-map illustrates growth results from all combinations of 5 soils with 17 lignocellulosic compounds, where blue squares represent the successful selection of bacteria from a given soil that were able to use that lignocellulosic compound as their carbon source at a concentration of 1 g/L. Soil samples labeled I-IV are farm soils, and the soil sample labeled V is a pH 4.5 bog soil.

FIGS. 7A-7B depict clonal bacterial isolates subsisting on antibiotics. (A) Heat-map illustrating growth results from all combinations of 11 soils by 18 antibiotics, where blue squares represent successful isolation of bacteria from a given soil that are able to utilize that antibiotic as sole carbon source at 1 g/L. Soil samples labeled F1-3 are farm soils and U1-3 are urban soils. Soil samples P1-5 are pristine soils, collected from non urban areas with minimal human exposure over the last 100 years (Table 8). (B) High performance liquid chromatography (HPLC) traces at 214 nm of representative penicillin and carbenicillin catabolizing clonal isolates and corresponding un-inoculated media controls for different time points over 20 or 28 days of growth, respectively.

FIG. 8 depicts the phylogenetic distribution of bacterial isolates subsisting on antibiotics. 16S ribosomal DNA (rDNA) was sequenced from antibiotic catabolizing clonal isolates using universal bacterial rDNA primers. High-quality, non-chimeric sequences were classified using Greengenes (DeSantis et al. (2006) Applied and Environmental Microbiology 72:5069), with consensus annotations from RDP (Cole et al. (2007) Nucleic Acids Res. 35:D169) and NCBI taxonomies (Wheeler et al. (2000) Nucleic Acids Res. 28:10). Phylogenetic trees were constructed using the neighbor-joining algorithm in ARB (Ludwig et al. (2004) Nucleic Acids Res. 32:1363) using the Greengenes aligned 16S rDNA database. Placement in the tree was confirmed by comparing automated Greengenes taxonomy to the annotated taxonomies of nearest neighbors of each sequence in the aligned database. Branches of the tree are color coded by bacterial orders, and clonal isolates represented as squares. Accession numbers of certain of these bacterial isolates that have been deposited are from EU515334 to EU515623 (GenBank), and are hereby incorporated by reference in their entirety.

FIGS. 9A-9C depict the antibiotic resistance profiling of 75 clonal isolates capable of subsisting on antibiotics. (A) Heat map illustrating the resistance profiles of a representative subset of 75 clonal isolates capable of utilizing antibiotics as sole carbon source (Table 7). Resistance was determined as growth after 4 days at 22° C. in Luria Broth media containing 20 mg/L antibiotic (top panel) and 1 g/L antibiotic (bottom panel). (B) Percentage of clonal isolates resistant to each of 18 antibiotics. Antibiotics are color coded by class, the full height of each bar corresponds to the percentage of clonal isolates resistant at 20 mg/L and the solid colored section of each bar corresponds to the percentage of clonal isolates resistant at 1 g/L. (C) Histogram depicting the distribution of the number of antibiotics at 20 mg/L (top panel) and 1 g/L (bottom panel) that the clonal isolates are resistant to.

FIGS. 10A-10B depict distribution of antibiotic catabolizing bacterial isolates with respect to antibiotics and soil. (A) Number of antibiotic catabolizing bacteria isolated from 11 soils color-coded by antibiotic class catabolized. (B) Percentage of soils containing antibiotic catabolizing bacteria, color-coded by chemical origin of antibiotic.

FIG. 11 depicts the phylogenetic distribution of bacterial isolates subsisting on antibiotics. Full set of bacteria subsisting on antibiotics is displayed in the center, with branches color coded by bacterial orders, and clonal isolates represented as squares. Subsets comprising clonal isolates catabolizing each antibiotic are represented as trees around the periphery, grouped by antibiotic class. 16S ribosomal DNA (rDNA) was sequenced from antibiotic catabolizing clonal isolates using universal bacterial rDNA primers. High-quality, non-chimeric sequences were classified using Greengenes, with consensus annotations from RDP and NCBI taxonomies. Phylogenetic trees were constructed using the neighbor-joining algorithm in ARB using the Greengenes aligned 16S rDNA database. Placement in the tree was confirmed by comparing automated Greengenes taxonomy to the annotated taxonomies of nearest neighbors of each sequence in the aligned database. The phylogenetic distributions of species isolated from different antibiotics as sole carbon source exhibit some interesting trends. For instance, the fluoroquinolone antibiotics, ciprofloxacin and levofloxacin, have similar phylogenetic distributions, as do the aminoglycoside antibiotics, gentamicin and amikacin, but the two sets are notably different from each other. Interestingly, the orders of bacteria subsisting on amikacin appear more similar to gentamycin than kanamycin despite amikacin being a semi-synthetic kanamycin derivative.

FIGS. 12A-12C depict a mass spectrometry analysis of growth media from penicillin subsisting bacterial culture. (A) Mass spectra of day 0 growth media from penicillin culture with a major peak at m/z of 335.10 corresponding exactly to the protonated penicillin G molecule. (B) Mass spectra of day 4 growth media from penicillin culture with two major peaks at m/z values 353.11 and 309.12 corresponding to protonated benzylpenicilloic acid and benzylpenilloic acid, respectively. (C) First steps of a proposed penicillin G degradation pathway.

FIG. 13 depicts a list of antibiotic catabolizing isolates described in FIG. 8. AIB2: Antibiotic Box 2; S*: section; YDM-TM: 1× YDM, trace metals, pH 5.5; Extr: extraction; RT: room temperature.

FIG. 14 depicts a list of antibiotic catabolizing isolates described in FIG. 8. AIB3: Antibiotic Box 3; S*: section; YDM-TM: 1× YDM, trace metals, pH 5.5; Extr: extraction; RT: room temperature.

FIG. 15 depicts a list of antibiotic catabolizing isolates described in FIG. 8. AIB4: Antibiotic Box 4; S*: section; YDM-TM: 1× YDM, trace metals, pH 5.5; Extr: extraction; RT: room temperature.

FIG. 16 depicts a list of antibiotic catabolizing isolates described in FIG. 8. AIB5: Antibiotic Box 5; S*: section; YDM-TM: 1× YDM, trace metals, pH 5.5; Extr: extraction; RT: room temperature.

FIG. 17 depicts a list of antibiotic catabolizing isolates described in FIG. 8. AIB6: Antibiotic Box 6; S*: section; YDM-TM: 1× YDM, trace metals, pH 5.5; Extr: extraction; RT: room temperature.

FIG. 18 depicts a list of antibiotic catabolizing isolates described in FIG. 8. AIB7: Antibiotic Box 7; S*: section; YDM-TM: 1× YDM, trace metals, pH 5.5; Extr: extraction; RT: room temperature.

FIG. 19 depicts a list of antibiotic catabolizing isolates described in FIG. 8. AIB8: Antibiotic Box 8; S*: section; YDM-TM: 1× YDM, trace metals, pH 5.5; Extr: extraction; RT: room temperature.

FIG. 20 depicts a heat map of resistance of 1102 bacteria from 5 oral and gut human-associated microbiomes to 18 antibiotics. 19,836 growth measurements of microbiome isolates in rich media containing antibiotics at concentrations of 20 mg/L are displayed as linear color scaled bars, where white denotes no growth, and color intensity is proportional to growth in the presence of antibiotic scaled to growth in the absence of antibiotic per individual isolate. Color codes of microbiome isolates from samples O1, O2, O3, G1, and G2 are green, red, blue, orange and purple, respectively. On average, only 7% of the microbiome isolates were resistant to chloramphenicol, whereas over 70% were resistant to D-cycloserine, amikacin, kanamycin, nalidixic acid, trimethoprim and the sulphonamides. On average, oral microbiome isolates (O1, O2 and O3) were resistant to 8 out of 18 antibiotics, compared to gut microbiome isolates (G1 and G2) which were resistant to 14 out of 18 antibiotics.

FIG. 21 graphically depicts the temporal dynamics of antibiotic resistance profiles and distributions of 5 oral and gut human-associated microbiomes. Left panels show the percentage of isolates from each microbiome sample at day 1, day 140 and day 141 that were resistant to each of the 18 antibiotics. Right panels show the distribution of multiple antibiotic resistance of the corresponding isolates from each microbiome sample. Resistance towards D-cycloserine, the aminoglycosides, nalidixic acid, the sulphonamides, and trimethoprim was maintained within all microbiomes over a 141 day time period. While the distributions of multiple antibiotic resistance of most microbiome samples appeared stable over this time course, a striking exception was the O3 day 1 isolates, which were highly resistant to all antibiotics, in comparison to O3 isolates from day 140 and 141. Since all individuals were free of antibiotic therapy at least 1 year before the initial sampling as well as during the course of the study, the antibiotic resistance profile dynamics are not a result of direct antibiotic dosing. This highlights that other factors can also modulate the reservoir of antibiotic resistance in human-associated microbiomes of healthy individuals.

FIGS. 22A-22B schematically depict the genetic exchange of antibiotic resistance determinants in and out of human-associated microbiome isolates. Of 95 experiments, antibiotic resistance determinants were exchanged in both directions between 11 microbiome G1 day isolates and an E. coli B strain, after 24 hours of co-incubation in the absence of antibiotic selection pressure. (A) 10 microbiome isolates acquired plasmid-borne chloramphenicol resistance from the E. coli B strain. (B) In one case, the E. coli B strain served as a recipient of plasmid-borne penicillin and carbenicillin resistance from a microbiome isolate. Plasmids from the 11 resultant clones were re-transformed into an E. coli K-12 strain, conferring resistance to chloramphenicol, penicillin and carbenicillin. This demonstrates that the microbiome antibiotic resistance reservoir could be enriched as well as transferred through extra-chromosomal DNA.

FIG. 23 graphically depicts the phylogenetic distribution of oral and gut microbiome isolates.

FIG. 24 depicts heat maps of antibiotic resistance of bacterial isolates from oral microbiome O1 at days 1, 140 and 141.

FIG. 25 depicts heat maps of antibiotic resistance of bacterial isolates from oral microbiome O2 at days 1, 140 and 141.

FIG. 26 depicts heat maps of antibiotic resistance of bacterial isolates from oral microbiome O3 at days 1, 140 and 141.

FIG. 27 depicts heat maps of antibiotic resistance of bacterial isolates from gut microbiome G1 at days 1, 140 and 141.

FIG. 28 depicts heat maps of antibiotic resistance of bacterial isolates from gut microbiome G2 at days 1, 140 and 141.

### DETAILED DESCRIPTION

The present invention is based in part on a novel method for identifying DNA fragments encoding useful properties from large collections of DNA fragments isolated directly from e.g., a mixture of organisms (e.g., one or more mixed microbial communities) present in one or more samples (e.g., one or more environmental samples such as water and/or soil). These methods are useful for creating microbes that can be used for biological production of industrially valuable compounds from complex input mixtures (e.g., plant biomass, waste products and the like). In certain aspects, microbial resistance towards inhibitory chemicals present in the input substrate material or produced as byproducts of the microbial catalysis can be increased by complementing the genome of the microorganism with exogenous DNA isolated from other specific organisms or directly from mixed microbial communities present in environmental samples.

In certain exemplary embodiments, methods and compositions for catalytic microbial processing of complex substrates (e.g., production of biofuels such as ethanol from plant biomass) are provided. Various microorganisms are capable of fermenting pure sugars into ethanol. However, due to the low value of fuels it is not cost efficient to produce biofuels from pure sugars in large scale. Instead, it is desirable to use untreated or minimally-treated plant biomass from crops or plant waste as growth substrates for ethanol producing microorganisms. Unfortunately, organisms currently used for ethanol production are inhibited by numerous compounds present in treated and untreated plant biomass, including, but not limited to, phenolic acids, alcohols, and aldehydes, resulting in low process efficiencies and ethanol yields. One way to improve the productivity of the catalytic microorganism is to increase its tolerance towards the inhibitors, be they contaminants or product. This can be achieved, for example, by introducing fragments of DNA encoding single gene-products or full pathways that enable the microorganism to better tolerate the inhibitor(s).

In certain exemplary embodiments, a microorganism capable of converting a particular growth substrate into industrially valuable products such as biofuels, amino acids, pharmaceuticals and the like is provided. Typically, the growth substrate is one or a few molecules (such as, e.g., simple sugars (e.g., glucose)). In many cases it is difficult or not economically feasible to provide the growth substrate in high purity, and hence microbial catalysis must proceed in the presence of numerous contaminants (e.g., chemicals) present with the growth substrate. These contaminants may inhibit the growth and or the productivity of the catalytic microorganism. Furthermore, in some cases, the microorganism may also be inhibited by one or more catalytic products and/or byproducts, resulting in lower productivity.

As used herein, the term “biofuel” refers to solid, liquid or gas fuel consisting of or derived from recently dead biological material (e.g., biomass), most commonly plants. As used herein, the term “biomass” refers to material derived from recently living organisms, such as plants, animals and their by-products. Biofuels include, but are not limited to: first generation biofuels including, but not limited to vegetable oil, biodiesel (e.g., fatty acid methyl (or ethyl) ester), bioalcohols (e.g., ethanol, propanol, butanol and the like), biogas, syngas and the like; second generation biofuels including, but not limited to, biohydrogen, biomethanol, biohydrogen, biomethanol, 2,5-Dimethylfuran (DMF), Bio-DME, Fischer-Tropsch diesel, biohydrogen diesel, mixed alcohols, wood diesel and the like; and third generation biofuels including, but not limited to, algae fuel and the like.

In certain aspects, a cell, cell lysate, cell extract, cell fraction, protein(s), polypeptide(s), isolated antibiotic(s) and the like of one or more of the microorganisms (e.g., bacteria) described herein are incubated in the presence of a contaminated substance to reduce or eliminate contamination. A cell, cell lysate, cell extract, cell fraction, protein(s), polypeptide(s), isolated antibiotic(s) and the like can be applied to a contaminated substance via aerosols, slurries, cleaning solutions, animal feeds, seeds, fertilizer and the like to partially or completely decontaminate the substance.

As used herein, the terms “toxic environment” and “contaminated substance” refer to an environment or substance, respectively, that contains one or more adverse compound(s) and/or physical condition(s) that can inhibit growth, inhibit productivity and/or lead to the death of one or more microorganisms exposed to the compound(s) and/or physical condition(s). A toxic environment includes, but is not limited to, the following: the presence of inhibitory compounds (e.g., antibiotics, radioactive compounds, heavy metals and the like) high or low salinity, extreme temperatures (e.g., high temperature (e.g., in thermal vents) and/or cold temperature (e.g., in icy conditions), water scarcity, darkness, light, catalytic products (e.g., cell waste, alcohol and the like) and the like. For example, a toxic environment can include the presence of a concentration (e.g., high or low concentrations) of a compound and/or a condition that is considered non-toxic to the microorganism in typical concentrations and/or in typical conditions, as well as the presence of a compound or a physical condition that would be typically considered to be detrimental to the organism.

In certain embodiments, the toxicity (of a toxic environment) or contamination (of a contaminated substance) is eliminated or reduced to non-toxic or non-contaminated levels. In certain aspects, the toxicity and/or contamination is reduced by about 5%, 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, 99%, 99.9% or more.

In certain exemplary embodiments, a method for identifying the DNA fragments encoding useful properties from large collections of DNA fragments isolated from either specific organisms or directly from mixed microbial communities present in environmental samples, e.g., soil, water and the like, is provided. The collections of DNA fragments are isolated from one or more toxic environments which may reasonably be expected to contain DNA that confer resistance to the inhibitors.

In certain exemplary embodiments, identification of useful DNA fragments is performed by introducing a diverse library of DNA fragments into a clonal population of a production microorganism creating a population of cells harboring different DNA fragments. The population of cells (e.g., microorganisms) harboring the DNA fragment library is subjected to growth in the presence of high concentration of the inhibitor(s) which would normally suppress growth of the host organism. If a cell in the population contains a DNA fragment which encodes for resistance to the high concentrations of inhibitor(s), the cell will selectively grow and can be identified. The DNA fragment that enabled the cell to tolerate the inhibitor can then be isolated, characterized and subsequently introduced into the production microorganism improving its catalytic productivity in the presence of the inhibitor.

As used herein, the term “organism” includes, but is not limited to, a human, a non-human primate, a cow, a horse, a sheep, a goat, a pig, a dog, a cat, a rabbit, a mouse, a rat, a gerbil, a frog, a toad, a fish (e.g., Danio Rerio) a roundworm (e.g., C. elegans) and any transgenic species thereof. The term “organism” further includes, but is not limited to, a yeast (e.g., S. cerevisiae) cell, a yeast tetrad, a yeast colony, a bacterium, a bacterial colony, a virion, virosome, virus-like particle and/or cultures thereof, and the like.

As used herein, the terms “microorganism” and “microbe” refer to tiny organisms. Most microorganisms and microbes are unicellular, although some multicellular organisms are microscopic, while some unicellular protists and bacteria (e.g., T. namibiensis) called are visible to the naked eye. Microorganisms and microbes include, but are not limited to, bacteria, fungi, archaea and protists, microscopic plants, and animals (e.g., plankton, the planarian, the amoeba) and the like.

Certain aspects of the invention pertain to vectors, such as, for example, expression vectors, containing a nucleic acid encoding one or more bipolar cell-specific regulatory sequences. As used herein, the term “vector” refers to a nucleic acid sequence capable of transporting another nucleic acid to which it has been linked. One type of vector is a “plasmid,” which refers to a circular double stranded DNA loop into which additional DNA segments can be ligated. Another type of vector is a viral vector, wherein additional DNA segments can be ligated into the viral genome. By way of example, but not of limitation, a vector of the invention can be a single-copy or multi-copy vector, including, but not limited to, a BAC (bacterial artificial chromosome), a fosmid, a cosmid, a plasmid, a suicide plasmid, a shuttle vector, a P1 vector, an episome, YAC (yeast artificial chromosome), a bacteriophage or viral genome, or any other suitable vector. The host cells can be any cells, including prokaryotic or eukaryotic cells, in which the vector is able to replicate.

Certain vectors are capable of autonomous replication in a host cell into which they are introduced (e.g., bacterial vectors having a bacterial origin of replication and episomal mammalian vectors). Other vectors (e.g., non-episomal mammalian vectors) are integrated into the genome of a host cell upon introduction into the host cell, and thereby are replicated along with the host genome. Moreover, certain vectors are capable of directing the expression of genes to which they are operatively linked. Such vectors are referred to herein as “expression vectors.” In general, expression vectors of utility in recombinant DNA techniques are often in the form of plasmids. In the present specification, “plasmid” and “vector” can be used interchangeably. However, the invention is intended to include such other forms of expression vectors, such as viral vectors (e.g., replication defective retroviruses, adenoviruses and adeno-associated viruses), which serve equivalent functions.

The recombinant expression vectors of the invention comprise a nucleic acid of interest (e.g., a nucleic acid sequence from a microorganism) in a form suitable for expression of the nucleic acid in a host cell, which means that the recombinant expression vectors include one or more regulatory sequences, selected on the basis of the host cells to be used for expression, which is operatively linked to the nucleic acid sequence to be expressed. Within a recombinant expression vector, “operably linked” is intended to mean that the nucleotide sequence of interest is present in the vector in a manner which allows for expression of the nucleotide sequence (e.g., in an in vitro transcription/translation system or in a host cell when the vector is introduced into the host cell). The term “regulatory sequence” is intended to include promoters, enhancers and other expression control elements (e.g., polyadenylation signals). Such regulatory sequences are described, for example, in Goeddel; Gene Expression Technology: Methods in Enzymology 185, Academic Press, San Diego, Calif. (1990). Regulatory sequences include those which direct constitutive expression of a nucleotide sequence in many types of host cells and those which direct expression of the nucleotide sequence only in certain host cells (e.g., tissue-specific regulatory sequences).

It will be appreciated by those skilled in the art that the design of the expression vector can depend on such factors as the choice of the host cell to be transformed, the level of expression of protein desired, and the like. The expression vectors of the invention can be introduced into host cells to thereby produce proteins or portions thereof, including fusion proteins or portions thereof, encoded by nucleic acids as described herein.

In certain exemplary embodiments, a nucleic acid described herein is expressed in bacterial cells using a bacterial expression vector such as, e.g., a fosmid. A fosmid is a cloning vector that is based on the bacterial F-plasmid. The host bacteria will typically only contain one fosmid molecule, although an inducible high-copy ori can be included such that a higher copy number can be obtained (e.g., pCC1FOS™, pCC2FOS™). Fosmid libraries are particularly useful for constructing stable libraries from complex genomes. Fosmids and fosmid library production kits are commercially available (EPICENTRE® Biotechnologies, Madison, Wis.). For other suitable expression systems for both prokaryotic and eukaryotic cells see chapters 16 and 17 of Sambrook, J., Fritsh, E. F., and Maniatis, T. Molecular Cloning: A Laboratory Manual. 2nd, ed., Cold Spring Harbor Laboratory, Cold Spring Harbor Laboratory Press, Cold Spring Harbor, N.Y., 1989.

Another aspect of the invention pertains to host cells into which a recombinant expression vector of the invention has been introduced. The terms “host cell” and “recombinant host cell” are used interchangeably herein. It is understood that such terms refer not only to the particular subject cell but to the progeny or potential progeny of such a cell. Because certain modifications may occur in succeeding generations due to either mutation or environmental influences, such progeny may not, in fact, be identical to the parent cell, but are still included within the scope of the term as used herein.

A host cell can be any prokaryotic or eukaryotic cell. For example, one or more bipolar cell-specific regulatory elements and/or portion(s) thereof can be reproduced in bacterial cells such as E. coli, viruses such as retroviruses, insect cells, yeast or mammalian cells (such as Chinese hamster ovary cells (CHO) or COS cells). Other suitable host cells are known to those skilled in the art.

Delivery of nucleic acid sequences described herein (e.g., vector DNA) can be by any suitable method in the art. For example, delivery may be by injection, gene gun, by application of the nucleic acid in a gel, oil, or cream, by electroporation, using lipid-based transfection reagents, or by any other suitable transfection method.

As used herein, the terms “transformation” and “transfection” are intended to refer to a variety of art-recognized techniques for introducing foreign nucleic acid (e.g., DNA) into a host cell, including calcium phosphate or calcium chloride co-precipitation, DEAE-dextran-mediated transfection, lipofection (e.g., using commercially available reagents such as, for example, LIPOFECTIN® (Invitrogen Corp., San Diego, Calif.), LIPOFECTAMINE® (Invitrogen), FUGENE® (Roche Applied Science, Basel, Switzerland), JETPEI™ (Polyplus-transfection Inc., New York, N.Y.), EFFECTENE® (Qiagen, Valencia, Calif.), DREAMFECT™ (OZ Biosciences, France) and the like), or electroporation (e.g., in vivo electroporation). Suitable methods for transforming or transfecting host cells can be found in Sambrook, et al. (Molecular Cloning: A Laboratory Manual. 2nd, ed., Cold Spring harbor Laboratory, Cold Spring Harbor Laboratory Press, Cold Spring Harbor, N.Y., 1989), and other laboratory manuals.

In certain exemplary embodiments, one or more host microorganisms described herein are engineered with various isolation and/or safety features such as, e.g., novel genetic codes, broad restriction systems, extreme sensitivity to substances common in nature (e.g., UV light), dependency on lab metabolites uncommon in nature (e.g., diaminopimelic acid) and the like in order to decrease the spread of antibiotic and/or toxin resistance gene(s) from one or more host cells. A non-limiting example of a broad restriction system is expression in the same cell of endonucleases aimed at both the methylated and non-methylated forms of a DNA sequence (e.g., DpnI and DpnII aimed at G-mA-T-C and GATC). This would require the removal of all sites (GATC in the above example) throughout the host genome.

In certain exemplary embodiments, one or more microorganisms (e.g., bacteria) described herein are used to develop novel antibiotics. Novel antibiotics are useful for overcoming the multi-drug resistance (MDR) that is increasingly observed among pathogenic bacteria. In certain exemplary aspects, one or more microorganisms (e.g., bacteria) described herein are used to manufacture novel antibiotics either harvested metagenomically from diverse natural microbial cells or engineered from combinatorial libraries. Even the trace amounts needed to detect biosynthesis of novel compounds could be enough to kill the host (or put undesired pressure to be unproductive). In another aspect, one or more microorganisms (e.g., bacteria) described herein are used in hybrid biological/chemical manufacturing or decontamination systems where resistance to high levels of various chemicals is helpful in the process engineering.

Novel antibiotics can be manufactured, for example by metagenomic harvesting from natural microbial cells or by engineering from combinatorial libraries. In certain exemplary embodiments, one or more microorganisms that are resistant to one or more compounds that typically kill and/or inhibit the growth of the microorganism (e.g., antibiotics, toxins and the like) are used in screening assays for identifying novel antibiotics, e.g., candidate or test compounds or agents (e.g., antibodies, peptides, cyclic peptides, peptidomimetics, small molecules, small organic molecules) which kill or have an inhibitory effect on the growth of one or more microorganisms are provided. In certain aspects, such screening assays can identify antibiotics as well as antibiotics that are effective in killing or reducing the growth of one or more multiple antibiotic resistant microorganisms.

As used herein, the term “antibiotic” refers to a chemotherapeutic agent (e.g., an agent produced by microorganisms and/or synthetically) that has the capacity to inhibit the growth of and/or to kill, one or more microorganisms (e.g., bacteria, fungi, parasites and the like) or aberrantly growing cells (e.g., tumor cells). As used herein, antibiotics are well-known to those of skill in the art. Classes of antibiotics include, but are not limited to, aminoglycosides (e.g., amikacin, gentamicin, kanamycin, neomycin, netilmicin, streptomycin, tobramycin, paromomycin and the like), ansamycins (e.g., geldanamycin, herbimycin and the like), carbacephem (e.g., loracarbef), carbapenems (e.g., ertapenem, doripenem, imipenem/cilastatin, meropenem and the like) cephalosporins (e.g., first generation (e.g., cefadroxil, cefazolin, cefalotin, cefalexin and the like), second generation (e.g., cefaclor, cefamandole, cefoxitin, cefprozil, cefuroxime and the like), third generation (e.g., cefixime, cefdinir, cefditoren, cefoperazone, cefotaxime, cefpodoxime, ceftazidime, ceftibuten, ceftizoxime, ceftriaxone and the like), fourth generation (e.g., cefepime and the like) and fifth generation (e.g., ceftobiprole and the like)), glycopeptides (e.g., teicoplanin, vancomycin and the like), macrolides (e.g., azithromycin, clarithromycin, dirithromycin, erythromycin, roxithromycin, troleandomycin, telithromycin, spectinomycin and the like), monobatams (e.g., aztreonam and the like), penicillins (e.g., amoxicillin, ampicillin, azlocillin, carbenicillin, cloxacillin, dicloxacillin, flucloxacillin, mezlocillin, meticillin, nafcillin, oxacillin, penicillin, piperacillin, ticacillin and the like), polypeptides (e.g., bacitracin, colistin, polymyxin B and the like) quinolones (e.g., ciprofloxacin, enoxacin, gatifloxacin, levofloxacin, lomefloxacin, moxifloxacin, norfloxacin, ofloxacin, trovafloxacin and the like), sulfonamides (e.g., mafenide, prontosil, sulfacetamide, sulfamethizole, sulfanilamide, sulfasalazine, sulfisoxazole, trimethoprim, trimethoprim-sulfamethoxazole and the like), tetracyclines (e.g., demeclocycline, doxycycline, minocycline, oxytetracycline, tetracycline and the like) and others (e.g., arsphenamine, chloramphenicol, clindamycin, lincomycin, ethambutol, fosfomycin, fusidic acid, furazolidone, isoniazid, linezolid, metronidazole, mupirocin, nitrofurantoin, platensimycin, pyrazinamide, quinupristin/dalfopristin, rifampin, tinidazol and the like) (See, e.g., Robert Berkow (ed.) The Merck Manual of Medical Information—Home Edition. Pocket (September 1999), ISBN 0-671-02727-1).

In certain exemplary embodiments, assays for screening candidate or test compounds (e.g., antibiotics) which bind to or modulate (e.g., kill or have an inhibitory effect on the growth of) a microorganism are provided. The antibiotics described herein can be obtained using any of the numerous approaches in combinatorial library methods known in the art, including: biological libraries; spatially addressable parallel solid phase or solution phase libraries; synthetic library methods requiring deconvolution; the “one-bead one-compound” library method; and synthetic library methods using affinity chromatography selection. The biological library approach is limited to peptide libraries, while the other four approaches are applicable to peptide, non-peptide oligomer or small molecule libraries of compounds (Lam, K. S. (1997) Anticancer Drug Des. 12:145).

In certain exemplary embodiments, one or more antibiotics described herein can be incorporated into pharmaceutical compositions suitable for administration. Such compositions typically comprise the nucleic acid molecule or protein and a pharmaceutically acceptable carrier. As used herein the language “pharmaceutically acceptable carrier” is intended to include any and all solvents, dispersion media, coatings, antibacterial and antifungal agents, isotonic and absorption delaying agents, and the like, compatible with pharmaceutical administration. The use of such media and agents for pharmaceutically active substances is well known in the art. Except insofar as any conventional media or agent is incompatible with the active compound, use thereof in the compositions is contemplated. Supplementary active compounds can also be incorporated into the compositions.

In certain exemplary embodiments, a pharmaceutical composition is formulated to be compatible with its intended route of administration. Examples of routes of administration include parenteral, e.g., intravenous, intradermal, subcutaneous, oral (e.g., inhalation), transdermal (topical), transmucosal, and rectal administration. Solutions or suspensions used for parenteral, intradermal, or subcutaneous application can include the following components: a sterile diluent such as water for injection, saline solution, fixed oils, polyethylene glycols, glycerin, propylene glycol or other synthetic solvents; antibacterial agents such as benzyl alcohol or methyl parabens; antioxidants such as ascorbic acid or sodium bisulfite; chelating agents such as ethylenediaminetetraacetic acid; buffers such as acetates, citrates or phosphates and agents for the adjustment of tonicity such as sodium chloride or dextrose. pH can be adjusted with acids or bases, such as hydrochloric acid or sodium hydroxide. The parenteral preparation can be enclosed in ampoules, disposable syringes or multiple dose vials made of glass or plastic.

Pharmaceutical compositions suitable for injectable use include sterile aqueous solutions (where water soluble) or dispersions and sterile powders for the extemporaneous preparation of sterile injectable solutions or dispersion. For intravenous administration, suitable carriers include physiological saline, bacteriostatic water, CREMOPHOR EL™ (BASF, Parsippany, N.J.) or phosphate buffered saline (PBS). In all cases, the composition must be sterile and should be fluid to the extent that easy syringability exists. It must be stable under the conditions of manufacture and storage and must be preserved against the contaminating action of microorganisms such as bacteria and fungi. The carrier can be a solvent or dispersion medium containing, for example, water, ethanol, polyol (for example, glycerol, propylene glycol, and liquid polyethylene glycol, and the like), and suitable mixtures thereof The proper fluidity can be maintained, for example, by the use of a coating such as lecithin, by the maintenance of the required particle size in the case of dispersion and by the use of surfactants. Prevention of the action of microorganisms can be achieved by various antibacterial and antifungal agents, for example, parabens, chlorobutanol, phenol, ascorbic acid, thimerosal, and the like. In many cases, it will be preferable to include isotonic agents, for example, sugars, polyalcohols such as mannitol, sorbitol, sodium chloride in the composition. Prolonged absorption of the injectable compositions can be brought about by including in the composition an agent which delays absorption, for example, aluminum monostearate and gelatin.

Sterile injectable solutions can be prepared by incorporating one or more antibiotics in the required amount in an appropriate solvent with one or a combination of ingredients enumerated above followed by filtered sterilization. Generally, dispersions are prepared by incorporating the active compound into a sterile vehicle which contains a basic dispersion medium and the required other ingredients from those enumerated above. In the case of sterile powders for the preparation of sterile injectable solutions, the preferred methods of preparation are vacuum drying and freeze-drying which yields a powder of the active ingredient plus any additional desired ingredient from a previously sterile-filtered solution thereof.

Oral compositions generally include an inert diluent or an edible carrier. They can be enclosed in gelatin capsules or compressed into tablets. For the purpose of oral therapeutic administration, the active compound can be incorporated with excipients and used in the form of tablets, troches, or capsules. Oral compositions can also be prepared using a fluid carrier for use as a mouthwash, wherein the compound in the fluid carrier is applied orally and swished and expectorated or swallowed. Pharmaceutically compatible binding agents, and/or adjuvant materials can be included as part of the composition. The tablets, pills, capsules, troches and the like can contain any of the following ingredients, or compounds of a similar nature: A binder such as microcrystalline cellulose, gum tragacanth or gelatin; an excipient such as starch or lactose, a disintegrating agent such as alginic, acid, Primogel, or corn starch; a lubricant such as magnesium stearate or Sterotes; a glidant: such as colloidal silicon dioxide; a sweetening agent such as sucrose or saccharin; or a flavoring agent such as peppermint, methyl salicylate, or orange flavoring.

In one embodiment, the one or more antibiotics are prepared with carriers that will protect the one or more antibiotics against rapid elimination from the body, such as a controlled release formulation, including implants and microencapsulated delivery systems. Biodegradable, biocompatible polymers can be used, such as ethylene vinyl acetate, polyanhydrides, polyglycolic acid, collagen, polyorthoesters, and polylactic acid. Methods for preparation of such formulations will be apparent to those skilled in the art. The materials can also be obtained commercially from Alza Corporation and Nova Pharmaceuticals, Inc. Liposomal suspensions (including liposomes targeted to infected cells with monoclonal antibodies to viral antigens) can also be used as pharmaceutically acceptable carriers. These may be prepared according to methods known to those skilled in the art, for example, as described in U.S. Pat. No. 4,522,811.

Nasal compositions generally include nasal sprays and inhalants. Nasal sprays and inhalants can contain one or more active components and excipients such as preservatives, viscosity modifiers, emulsifiers, buffering agents and the like. Nasal sprays may be applied to the nasal cavity for local and/or systemic use. Nasal sprays may be dispensed by a non-pressurized dispenser suitable for delivery of a metered dose of the active component. Nasal inhalants are intended for delivery to the lungs by oral inhalation for local and/or systemic use. Nasal inhalants may be dispensed by a closed container system for delivery of a metered dose of one or more active components.

In one embodiment, nasal inhalants are used with an aerosol. This is accomplished by preparing an aqueous aerosol, liposomal preparation or solid particles containing the compound. A non-aqueous (e.g., fluorocarbon propellant) suspension could be used. Sonic nebulizers may be used to minimize exposing the agent to shear, which can result in degradation of the compound.

Ordinarily, an aqueous aerosol is made by formulating an aqueous solution or suspension of the agent together with conventional pharmaceutically acceptable carriers and stabilizers. The carriers and stabilizers vary with the requirements of the particular compound, but typically include nonionic surfactants (Tweens, Pluronics, or polyethylene glycol), innocuous proteins like serum albumin, sorbitan esters, oleic acid, lecithin, amino acids such as glycine, buffers, salts, sugars or sugar alcohols. Aerosols generally are prepared from isotonic solutions.

Systemic administration can also be by transmucosal or transdermal means. For transmucosal or transdermal administration, penetrants appropriate to the barrier to be permeated are used in the formulation. Such penetrants are generally known in the art, and include, for example, for transmucosal administration, detergents, bile salts, and fusidic acid derivatives. Transmucosal administration can be accomplished through the use of nasal sprays or suppositories. For transdermal administration, the active compounds are formulated into ointments, salves, gels, or creams as generally known in the art.

The one or more antibiotics can also be prepared in the form of suppositories (e.g., with conventional suppository bases such as cocoa butter and other glycerides) or retention enemas for rectal delivery.

In one embodiment, one or more antibiotics are prepared with carriers that will protect them against rapid elimination from the body, such as a controlled release formulation, including implants and microencapsulated delivery systems. Biodegradable, biocompatible polymers can be used, such as ethylene vinyl acetate, polyanhydrides, polyglycolic acid, collagen, polyorthoesters, and polylactic acid. Methods for preparation of such formulations will be apparent to those skilled in the art. The materials can also be obtained commercially from Alza Corporation and Nova Pharmaceuticals, Inc. Liposomal, suspensions (including liposomes targeted to infected cells with monoclonal antibodies to viral antigens) can also be used as pharmaceutically acceptable carriers. These can be prepared according to methods known to those skilled in the art, for example, as described in U.S. Pat. No. 4,522,811.

It is especially advantageous to formulate oral or parenteral compositions in dosage unit form for ease of administration and uniformity of dosage. Dosage unit form as used herein refers to physically discrete units suited as unitary dosages for the subject to be treated; each unit containing a predetermined quantity of active compound calculated to produce the desired therapeutic effect in association with the required pharmaceutical carrier. The specification for the dosage unit forms of the invention are dictated by and directly dependent on the unique characteristics of the active compound and the particular therapeutic effect to be achieved, and the limitations inherent in the art of compounding such an active compound for the treatment of individuals.

Toxicity and therapeutic efficacy of antibiotic(s) can be determined by standard pharmaceutical procedures in cell cultures or experimental animals, e.g., for determining the LD50 (the dose lethal to 50% of the population) and the ED50 (the dose therapeutically effective in 50% of the population). The dose ratio between toxic and therapeutic effects is the therapeutic index and it can be expressed as the ratio LD50/ED50. In certain exemplary embodiments, antibiotic(s) which exhibit large therapeutic indices are provided. While compounds that exhibit toxic side effects may be used, care should be taken to design a delivery system that targets such compounds to the site of affected tissue in order to minimize potential damage to uninfected cells and, thereby, reduce side effects.

Data obtained from cell culture assays and/or animal studies can be used in formulating a range of dosage for use in humans. The dosage typically will lie within a range of circulating concentrations that include the ED50 with little or no toxicity. The dosage may vary within this range depending upon the dosage form employed and the route of administration utilized. For any compound used in the method of the invention, the therapeutically effective dose can be estimated initially from cell culture assays. A dose may be formulated in animal models to achieve a circulating plasma concentration range that includes the IC50 (i.e., the concentration of the test compound which achieves a half-maximal inhibition of symptoms) as determined in cell culture. Such information can be used to more accurately determine useful doses in humans. Levels in plasma may be measured, for example, by high performance liquid chromatography.

In certain exemplary embodiments, a method for treatment of infection by a microorganism includes the step of administering a therapeutically effective amount of an antibiotic which modulates (e.g., kills and/or inhibits the growth of), one or more microorganisms to a subject. As defined herein, a therapeutically effective amount of antibiotic (i.e., an effective dosage) ranges from about 0.001 to 30 mg/kg body weight, from about 0.01 to 25 mg/kg body weight, from about 0.1 to 20 mg/kg body weight, or from about 1 to 10 mg/kg, 2 to 9 mg/kg, 3 to 8 mg/kg, 4 to 7 mg/kg, or 5 to 6 mg/kg body weight. The skilled artisan will appreciate that certain factors may influence the dosage required to effectively treat a subject, including but not limited to the severity of the disease or disorder, previous treatments, the general health and/or age of the subject, and other diseases present. Moreover, treatment of a subject with a therapeutically effective amount of an antibiotic can include a single treatment or, in certain exemplary embodiments, can include a series of treatments. It will also be appreciated that the effective dosage of antibiotic used for treatment may increase or decrease over the course of a particular treatment. Changes in dosage may result from the results of diagnostic assays as described herein. The pharmaceutical compositions can be included in a container, pack, or dispenser together with instructions for administration.

In certain embodiments, monitoring the influence of antibiotics on the killing and/or inhibiting cell growth of one or more microorganisms can be applied not only in basic drug screening, but also in clinical trials. In certain exemplary embodiments, a method is provided for monitoring the effectiveness of treatment of a subject with an antibiotic comprising the steps of (i) obtaining a pre-administration sample from a subject prior to administration of the agent; (ii) detecting the level of a microorganism in the preadministration sample; (iii) obtaining one or more post-administration samples from the subject; (iv) detecting the level the microorganism in the post-administration samples; (v) comparing the level of microorganism in the pre-administration sample with the level of microorganism in the post-administration sample or samples; and (vi) altering the administration of the antibiotic to the subject accordingly. For example, increased administration of the agent may be desirable to increase the effectiveness of the antibiotic. Alternatively, decreased administration of the agent may be desirable to decrease the effectiveness of the antibiotic.

It is to be understood that the embodiments of the present invention which have been described are merely illustrative of some of the applications of the principles of the present invention. Numerous modifications may be made by those skilled in the art based upon the teachings presented herein without departing from the true spirit and scope of the invention. The contents of all references, patents and published patent applications cited throughout this application are hereby incorporated by reference in their entirety for all purposes.

The following examples are set forth as being representative of the present invention. These examples are not to be construed as limiting the scope of the invention as these and other equivalent embodiments will be apparent in view of the present disclosure, tables, figures, and accompanying claims.

### Example I

### Functional Metagenomic Mining for Synthetic Biology Parts for Biomass Conversion

One of the primary roadblocks in realizing sustainable biofuel alternatives to current fossil fuel energy is recalcitrance and toxicity of biomass substrates. A synthetic biology approach to solving these problems requires a rich and diverse inventory of functional parts enabling utilization and tolerance of the constituent biomass chemicals. Given the continuous recycling of plants in the environment, relevant functional parts are likely widely distributed in nature. A culturing-independent, functional, metagenomic platform for accessing this vast enzymatic reservoir is presented herein. This methodology has been applied to improve the tolerance of a microbial biocatalyst to 7 out of 14 important biomass inhibitors, by selection of tolerance-encoding machinery from soil microbiomes. Accordingly, this novel platform provides a starting point for synthetic biology efforts to engineer robust chassis for applications such as, e.g., biofuel generation.

Global environmental problems related to the combustion of fossil fuels and increasing concerns about their supply underscore the importance of developing renewable fuel alternatives with a reduced environmental footprint. The application of synthetic biology (Ro et al., Nature 440, 940 (Apr. 13, 2006); S. Atsumi, T. Hanai, J. C. Liao, Nature 451, 86 (January, 2008); D. Endy, Nature 438, 449 (Nov. 24, 2005)) to engineer biocatalysts that produce biofuels from diverse lignocellulosic materials including waste and low agricultural intensity biomass holds promise to deliver one such sustainable alternative (A. E. Farrell et al., Science 311, 506 (Jan. 27, 2006); D. Tilman, J. Hill, C. Lehman, Science 314, 1598 (December, 2006); T. Searchinger et al., Science 319, 1238 (Feb. 29, 2008); J. Fargione, J. Hill, D. Tilman, S. Polasky, P. Hawthorne, Science 319, 1235 (Feb. 29, 2008)). However, bioconversion of lignocellulose to biofuels is currently limited by biomass recalcitrance (M. E. Himmel et al., Science 315, 804 (Feb. 9, 2007)) and toxicity of non-fermentable compounds in the original substrate and formed as byproducts of biomass pretreatment (J. Zaldivar, L. O. Ingram, Biotechnol Bioeng 66, 203 (1999); J. Zaldivar, A. Martinez, L. O. Ingram, Biotechnol Bioeng 68, 524 (Jun. 5, 2000); J. Zaldivar, A. Martinez, L. O. Ingram, Biotechnol Bioeng 65, 24 (Oct. 5, 1999); H. B. Klinke, A. B. Thomsen, B. K. Ahring, Appl Microbiol Biotechnol 66, 10 (November, 2004)). While the identity and inhibitory concentrations of these compounds have been characterized, their mechanisms of toxicity are poorly understood, and functional parts conferring tolerance to most of these compounds have not been identified. In order to design efficient biocatalysts for biofuel generation, a diverse inventory of functional parts allowing utilization of or conferring tolerance towards these compounds is required.

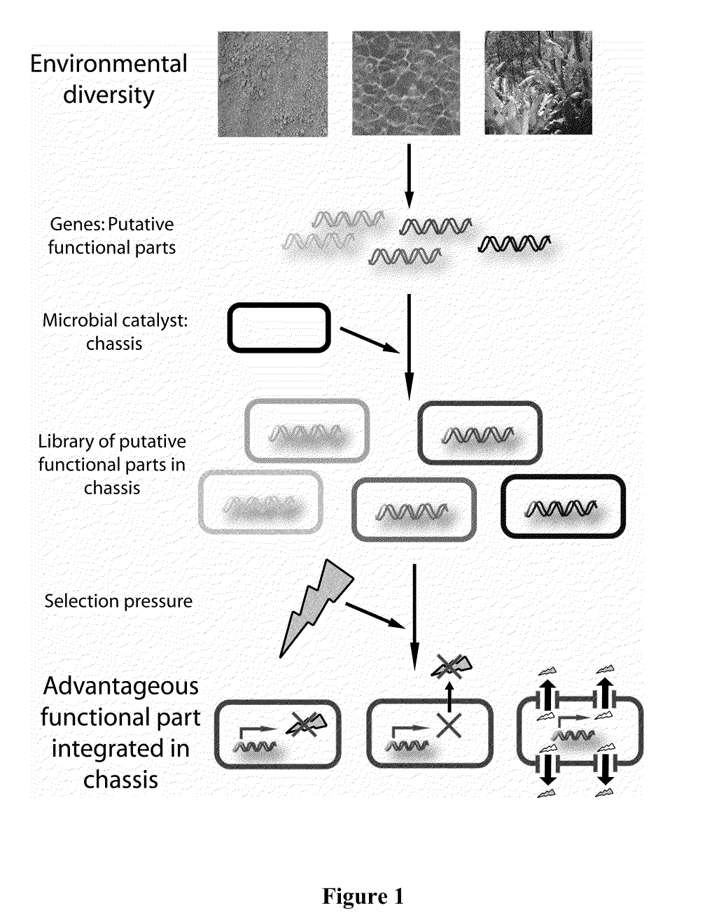

Since plant biomass is constantly recycled in the environment (T. K. Kirk, R. L. Farrell, Annu Rev Microbiol 41, 465 (1987)), a reservoir of enzymatic machinery must exist in the soil microbiome that allows for the tolerance and complete processing of its constituent chemicals. However, the majority of this machinery has remained inaccessible to synthetic biology and metabolic engineering due to culturing bias (V. Torsvik, F. L. Daae, R. A. Sandaa, L. Ovreas, J Biotechnol 64, 53 (Sep. 17, 1998)). A culturing-independent, functional, metagenomic platform for discovery of novel functional parts relevant to biofuel generation is presented herein. Key steps of this platform include extraction of metagenomic DNA from arbitrary environmental sources (M. R. Rondon et al., Appl Environ Microbiol 66, 2541 (June, 2000)), transformation of environmental metagenomic libraries into the bio-chassis of interest, and direct selection of functional parts conferring the desired phenotype compatible with the chosen bio-chassis (FIG. 1). This platform is well suited for biomass conversion, since the functional parts which allow the bio-chassis to utilize recalcitrant substrates and tolerate toxic chemicals can be directly selected.

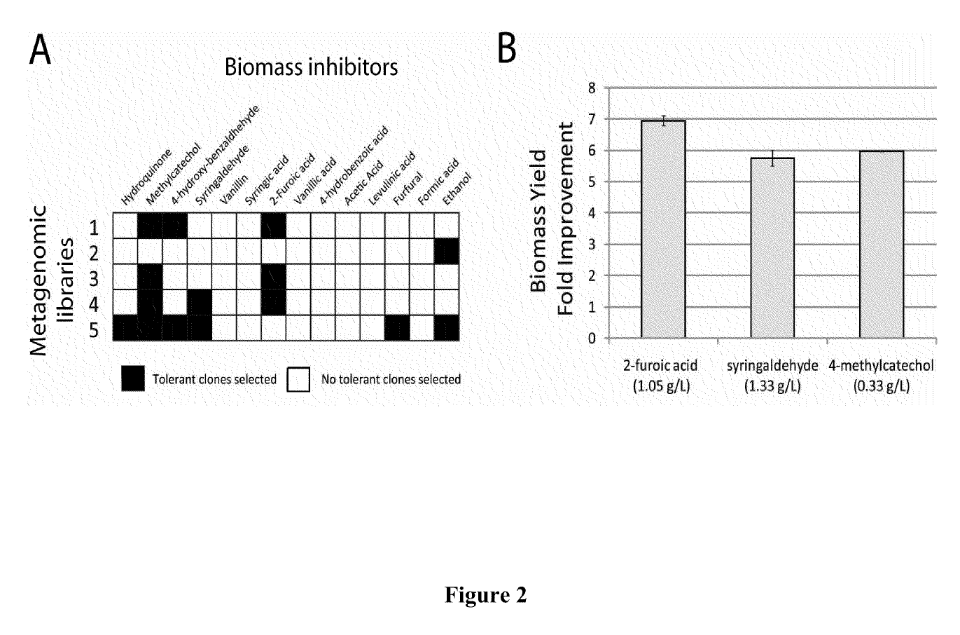

This method has been applied to select a number of functional parts from diverse soil microbiomes that confer resistance to different classes of biomass inhibitors. Large insert (40-50 kilobases) metagenomic libraries were created from 4 different soil microbiomes and transferred them into Escherichia coli, a biofuel relevant organism (B. S. Dien, M. A. Cotta, T. W. Jeffries, Appl Microbiol Biotechnol 63, 258 (December, 2003)). The transformed metagenomic libraries were subjected to growth selections under inhibitory concentrations of 14 biomass chemicals, and successfully identified clones with improved tolerance to 7 inhibitors (hydroquinone, 4-methylcatechol, 4-hydroxybenzaldehyde, syringaldehyde, 2-furoic acid, furfural, and ethanol) (FIG. 2A). Clones with improved tolerance towards the three important biomass inhibitors syringaldehyde, 4-methylcatechol and 2-furoic acid, covering the three major lignocellulosic inhibitor classes (i.e., aldehydes, alcohols and acids), were further analyzed. Metagenomic inserts encoding resistance to each inhibitor were extracted and retransformed into wild type E. coli to verify that the improved phenotype was due to the presence of the metagenomic insert (See Example II). The phenotypic improvements due to the selected metagenomic inserts were 6.9-fold, 5.7-fold and 6.0-fold for 2-furoic acid, syringaldehyde and 4-methylcatechol, respectively, expressed as fold improvements in biomass yield at an inhibitor concentration which results in a 90% reduction of wild type E. coli biomass yield (FIG. 2B).

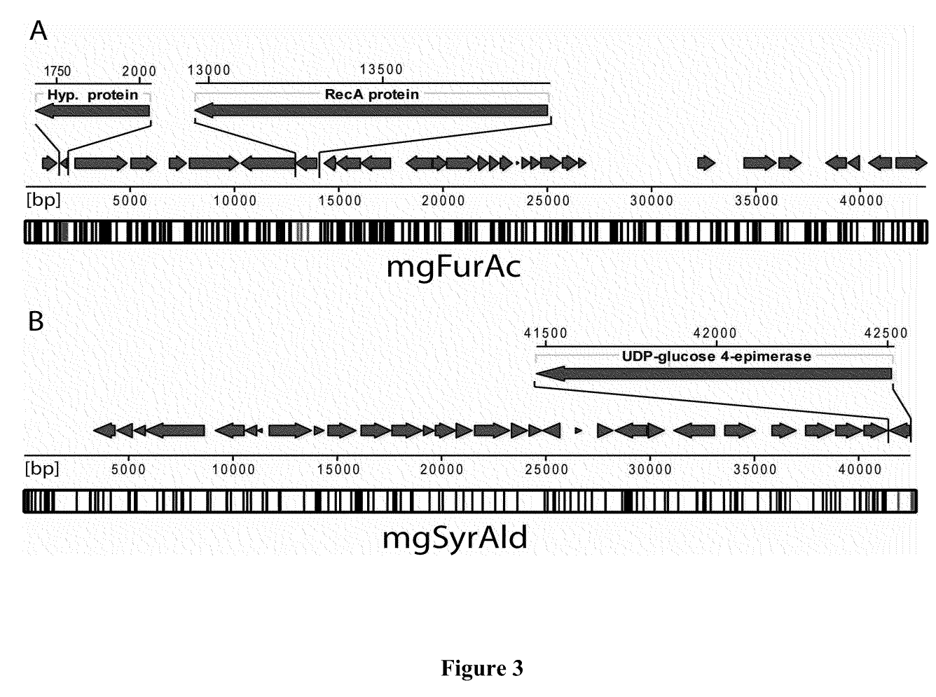

One metagenomic insert each for syringaldehyde (mgSyrAld), 4-methylcatechol (mgMetCat) and 2-furoic acid (mgFurAc) was sequenced and annotated (FIG. 3) (See Example II). The nucleotide sequences of the three metagenomic inserts were found to have very weak homology to known sequences in the NCBI non-redundant nucleotide database (Example II). Based solely on the sequence and annotation of the inserts, it is difficult to predict which genes are responsible for the improved tolerance especially when the mechanism of toxicity is poorly characterized for these compounds. A loss of function study with mgSyrAld and mgFurAc using transposon mutagenesis was therefor performed to identify the functional genetic parts contributing to the selected phenotypes (FIG. 3) (Example II).

Three separate transposition events in mgSyrAld resulted in knock-down of the tolerance phenotype, all targeting either the promoter or the coding region of a 348 amino acid gene product annotated to be a UDP-glucose 4-epimerase (FIG. 3). The E. coli UDP-glucose 4-epimerase, galE, is a key metabolic enzyme required for the interconversion of UDP-glucose and UDP-galactose. While the exact mode of toxicity of syringaldehyde is unknown, a number of substituted phenolic compounds have been found to inhibit UDP-glucose 4-epimerases (J. B. Thoden, P. A. Frey, H. M. Holden, Protein Sci 5, 2149 (November, 1996); M. D. Urbaniak et al., Bioorg Med Chem Lett 16, 5744 (Nov. 15, 2006)) (18, 19). Deficiency of this enzyme leads to compromised cell wall biosynthesis in the absence of galactose (H. Nikaido, Biochim Biophys Acta 48, 460 (Apr. 15, 1961)), or to cell death in the presence of galactose (M. B. Yarmolinsky, H. Wiesmeyer, H. M. Kalckar, E. Jordan, Proc Natl Acad Sci USA 45, 1786 (December, 1959)). Galactose is a major constituent of the biomass polymer hemicellulose (J. Zaldivar, J. Nielsen, L. Olsson, Appl Microbiol Biotechnol 56, 17 (July, 2001)). Without intending to be bound by scientific theory, the mode of toxicity of syringaldehyde in E. coli may involve inhibition of galE, which would compromise cellular integrity or convert a biomass substrate into a toxin. Without intending to be bound by scientific theory, the improved phenotype conferred by the selected metagenomic insert may, therefore, function through rescue of a compromised E. coli UDP-glucose 4-epimerase.

Seven separate transposition events in mgFurAc resulted in knock down of the tolerance phenotype. Three hits targeted the coding region of a 342 amino acid gene product annotated to be a RecA protein. This family of proteins function in recombinational DNA repair in bacteria and is required for the initiation and regulation of the SOS DNA damage response (M. M. Cox, Crit Rev Biochem Mol Biol 42, 41 (January-February, 2007)). RecA has recently been shown to remediate hydroxyl radical damage resulting from the action of bactericidal antibiotics targeting different and unrelated cellular pathways (M. A. Kohanski, D. J. Dwyer, B. Hayete, C. A. Lawrence, J. J. Collins, Cell 130, 797 (Sep. 7, 2007)). 2-furoic acid and its derivatives have previously been shown to have mutagenic and antimicrobial activities (E. Grunberg, E. H. Titsworth, Annu Rev Microbiol 27, 317 (1973); C. Y. Wang, K. Muraoka, G. T. Bryan, Cancer Res 35, 3611 (December, 1975)). Hence, the metagenomically selected RecA protein may function to remediate DNA damage resulting from 2-furoic acid. Four transposition hits in mgFurAc target a 111 amino acid gene product of unknown function. Only four proteins in the NCBI non-redundant protein sequence database had significant homology to this gene, all of which are characterized as hypothetical proteins. Attempts to model the three-dimensional structure of the polypeptide sequence using numerous automated structure prediction servers did not return high confidence models (Example II). However, high confidence topology predictions were obtained from the Phobius server (L. Kall, A. Krogh, E. L. Sonnhammer, J Mol Biol 338, 1027 (May 14, 2004)), indicating that the protein contains two transmembrane helices (Example II). Interestingly, a transposon insertion at residue 82 in a region predicted to be cytoplasmic did not affect the phenotype. It has previously been hypothesized that 2-furoic acid affects membrane integrity (J. Zaldivar, L. O. Ingram, Biotechnol Bioeng 66, 203 (1999)), and these data suggest that the membrane traversing regions of the metagenomically selected hypothetical protein contribute to the improved tolerance to 2-furoic acid.

The total genetic diversity contained in even one gram of soil is many orders of magnitude higher than library sizes attainable using current techniques (R. Daniel, Nat Rev Microbiol 3, 470 (June, 2005)), which may select against the discovery of rare functional parts. An attempt to enrich the metagenomic source material for lignocellulosic inhibitor tolerance machinery was made by culturing soil microbiomes in minimal media that contained the inhibitors as the carbon source at 1 g/L (Example II). Mixed cultures capable of utilizing 15 of 17 lignocellulosic inhibitors were successfully obtained, and metagenomic libraries were created from four enriched cultures utilizing vanillin, vanillic acid, syringic acid and guaiacol. Functional parts conferring tolerance to these inhibitors were not selected from the enriched metagenomic libraries. Id. Without intending to be bound by scientific theory, this could be a consequence of the biased reduction of genomic diversity due to culturing, which may not favor genetic compatibility of the resultant enriched metagenomic DNA with the desired host biocatalyst. In comparison, metagenomic libraries created from DNA directly extracted from an environmental source approach yielded an unbiased representation of the genetic diversity represented in the associated microbiome, which was determined to be highly compatible with transfer of functional parts to a biofuel relevant biocatalyst.

The screening of metagenomic clone libraries from diverse environmental sources have previously yielded numerous biomolecules including novel proteases, amylases, cellulases, and antibiotics (M. R. Rondon et al., Appl Environ Microbiol 66, 2541 (June, 2000); R. Daniel, Nat Rev Microbiol 3, 470 (June, 2005); S. F. Brady, J. Clardy, Journal of the American Chemical Society 122, 12903 (December, 2000); F. Warnecke et al., Nature 450, 560 (Nov. 22, 2007)), and the yields of these methods appear primarily limited by the number of clones that can feasibly be screened (R. Daniel, Nat Rev Microbiol 3, 470 (June, 2005)). In comparison, a library-wide selection scheme as described herein allows for exhaustive interrogation of the enzymatic reservoir encoded within metagenomic libraries that can be made using current techniques (≦10¹² bp) (R. Daniel, Nat Rev Microbiol 3, 470 (June, 2005); C. S. Riesenfeld, R. M. Goodman, J. Handelsman, Environ Microbiol 6, 981 (September, 2004)). One or more functional selections relevant to biofuel generation can be designed to select for three general features: Chemical utilization, chemical tolerance and/or chemical production. Chemical utilization can be selected, for example, by providing the specific substrate as the sole source of a required nutrient (e.g. carbon, nitrogen) to the biocatalyst metagenomic clone library, allowing clones containing functional part(s) that enable substrate utilization to grow selectively. One or more functional parts encoding chemical tolerance can be selected, for example, by subjecting the library to inhibitory concentrations of the chemical, as demonstrated herein. A functional selection for chemical production, for example, can be achieved using a biocatalyst metagenomic clone library that contains a biochemical circuit that links the presence of the desired product to a selectable resistance or utilization phenotype. For instance, a circuit can be designed where a transcription factor responsive to the stoichiometric presence or absence of the product controls the expression of an antibiotic resistance gene.

A distinguishing feature of synthetic biology is the emphasis on integrating functional parts to generate robust and predictable biocatalysts to solve multiple biological, chemical and engineering problems including fuel generation, environmental remediation and pharmaceutical production (D. Endy, Nature 438, 449 (Nov. 24, 2005); J. D. Keasling, ACS Chem Biol 3, 64 (Jan. 18, 2008)). The methods and compositions described herein illustrate that functional metagenomic selections enable the direct discovery of novel functional parts from nature's enzymatic catalogue, providing a straightforward route for expanding the synthetic biology tool box. When used to discover functional parts conferring inhibitor tolerance, the methods and compositions described herein are useful for generating hypotheses regarding their mode of action (e.g., as illustrated for syringaldehyde and 2-furoic acid).

### REFERENCE

1. R. K. Aziz et al., BMC Genomics 9, 75 (2008).

### Example II

### Materials and Methods for Example I

Soil Collection

Soil samples (200-500 g) were collected from urban parks (MA), farm land (MA), and bogs (NH) (Table 1).

TABLE 1
Soil metagenomic libraries with and without
single carbon-source utilization enrichment.

| | | Culturing enrichment for | |
|---|---|---|---|
| Library | | utilization of single ligno- | Library Size |
| # | Source | cellulosic carbon source | (Megabases) |
| 1 | pH 4.5 bog soil | NO | 200 |
| 2 | pH 4.5 bog soil | NO | 200 |
| 3 | pH 5.5 bog soil | NO | 2500 |
| 4 | Urban park soil | NO | 1000 |
| 5 | Mixture of 4 farm | NO | 1000 |
| | soils | | |
| 6 | Farm soil I | furfuryl alcohol | 76 |
| 7 | Farm soil II | guaiacol | 164 |
| 8 | Farm soil IV | syringic acid | 32 |
| 9 | pH 4.5 bog soil | vanillin | 360 |

Environmental Metagenomic DNA (mgDNA) Extraction

mgDNA was extracted from 10 g of soil using the PowerMax Soil DNA Isolation Kit (catalog #12988-10, Mobio Laboratories Inc.). The suggested protocol (Worldwide Website: mobio.com/files/protocol/12988.pdf) was followed with the following modifications. All vortexing steps were eliminated to prevent shearing of high-molecular weight DNA. Cell lysis was achieved by shaking at 250 rpm in a 65° C. water bath for 1 hour, with mixing by gentle inversion every 15 minutes. Inhibitor precipitation solutions C2 and C3 volumes were doubled (10 mL used instead of 5 mL). High salt DNA-silica binding solution C4 volume was doubled (60 mL used instead of 30 mL). mgDNA was eluted from the purification column using 7.5 mL of 10 mM TRIS pH 8.0.

Eluted mgDNA (7.5 mL in 50 mL falcon tube) was subsequently ethanol precipitated:
a. Added 750 μL (0.1× volume) 3M ammonium acetate pH 5.2, 2 μL pellet paint (catalog #69049, Novagen) and 15 mL (2× volume) ice-cold 100% ethanol
b. Inverted 3-5 times to mix
c. Incubated at room temp for 2 minutes
d. Centrifuged at 5000 rcf (in swinging bucket table-top centrifuge) at 4° C. for 45 minutes
e. Discarded supernatant
f. Air-dried at 65° C. for 15 minutes
g. Added 500 μL 10 mM Tris pH 8.0 and swirled to mix
h. Dissolved by incubation at 65° C. for 1 hour

Estimated DNA concentration on Nanodrop 1000 (Thermo Scientific)

Gel Purification/Size Selection

High molecular weight (40-50 KB) mgDNA was size selected and purified using a pulse-field gel apparatus (CHEF MAPPER, Biorad). mgDNA was loaded at approximately 1 μg per cm width of gel (total of approximately 5-10 μg of mgDNA per library), with High Molecular Weight DNA Markers (catalog #15618-010, Invitrogen) and 1 KB DNA Extension Ladder (catalog #10511-012, Invitrogen) as molecular weight standards. Gel conditions were:
% Agarose: 1% Low Melting Temperature Agarose
Buffer: 1× TBE
Temperature: 14° C.
Voltage: 4.5 V/cm
Pulse: initial 1.0-final 7.0 sec
Run Time: 13 hrs
Angle: 120°

After running, gel was stained with 1× SYBR-Gold Gel Stain (Molecular Probes) for 30 minutes, imaged on dark transilluminator, and bands corresponding to 40-50 KB were excised. mgDNA was extracted from the gel slices using the GELase Agarose Gel-Digesting Preparation (catalog #G09200, Epicentre Biotechnologies), using the following modified GELase protocol:
1. Transferred 0.5-2 g of gel slice to a 15 mL falcon tube
2. Added 2 mL of 1× GELase digestion buffer per 0.5 g of gel
3. Shook gently on platform shaker for approximately 30 minutes
4. Discarded GELase digestion buffer
5. Repeated steps 2-4
6. Divided gel slices into 1.8 g of gel slice per 2 mL microcentrifuge tube
7. Melted gel slices at 70° C. (approximately 10 minutes)
8. Cooled to 45° C. (approximately 20 minutes)
9. Added GELase enzyme at 1 unit for every 200 μL (mg) of gel
10. Incubated at 45° C. overnight
11. Spun down tubes in microcentrifuge for 20 minutes at maximum speed
12. Transferred top 90% of supernatant to new microcentrifuge tubes, 500 uL per tube
13. Ethanol precipitated DNA:
   a. To each tube (with 500 μL), added 1 μL pellet paint, 50 μL 3M sodium acetate pH 5.2, 1000 μL 100% ice-cold ethanol
   b. Centrifuged at maximum speed for 5 minutes
   c. Discarded supernatant
   d. Washed with 70% ethanol, centrifuged, discarded supernatant
   e. Air-dried 10 minutes with open cap
   f. Added 5 μL 10 mM Tris pH 8.0 to each DNA pellet
   g. Incubated at 55° C. for 15 minutes
   h. Resuspended pellet and pooled any fractions corresponding to the same mgDNA source
14. Estimated DNA concentration on Nanodrop 1000 (Thermo Scientific)

End-Repair of mgDNA

Size-selected gel-purified mgDNA was blunt-end repaired using the End-It DNA End-Repair Kit (catalog #ER0720, Epicentre Biotechnologies). Approximately 0.5-5 μg of mgDNA was end repaired in a standard 50 μL reaction:
1. 10 μL mgDNA (0.5-5 μg of pulse-field gel-purified DNA)
2. 5 μL 10× End-It Buffer
3. 5 μL 2.5 mM dNTP (End-It)
4. 5 μL 10 mM ATP (End-It)
5. 24 μL sterile H₂O (up to 50 μL)
6. 1 μL End-It Enzyme Mix
7. Incubated at room temperature for 45 minutes
8. Incubated at 70° C. for 10 minutes

Phenol/Chloroform Extraction and Ethanol Precipitation of End-Repaired mgDNA

End-repaired mgDNA was phenol/chloroform extracted in two steps and concentrated by ethanol precipitation:

Phenol-Chloroform-Isoamyl alcohol (PCI) Extraction
a. 50 μL: end-repaired-mgDNA
b. 350 μL: H₂O
c. 400 μL: PCI
d. Inverted to mix, approximately 3-5 minutes
e. Centrifuged at maximum speed for 10 minutes
f. Saved supernatant (PCI extracted end-repaired-mgDNA)

Chloroform-Isoamyl alcohol (CI) Extraction
a. 400 μL: PCI extracted end-repaired-mgDNA
b. 400 μL: CI
c. Inverted to mix, approximately 3-5 minutes
d. Centrifuged at maximum speed for 10 minutes
e. Saved supernatant (CI extracted end-repaired-mgDNA)

Ethanol precipitation
a. 400 μL: CI extracted End-Rep-BPD24
b. 40 μL: 3M ammonium acetate pH 5.2
c. 800 μL: ice-cold EtOH
d. Inverted to mix
e. Room temperature for approximately 2 minutes
f. Centrifuged at maximum speed for 5 minutes
g. Removed supernatant, save pellet
h. 1000 μL 70% EtOH
i. Inverted to wash, approximately 3-5 minutes
j. Centrifuged at maximum speed for 5 minutes
k. Removed supernatant, saved pellet
l. Air-dry approximately 15 minutes
m. Dissolved pellet in 10 uL 10 mM Tris pH 8

Estimated mgDNA concentration on Nanodrop 1000 (Thermo Scientific)

mgDNA Library Construction

Libraries of purified end-repaired 40-50 KB mgDNA in E. coli were created using the CopyControl Fosmid Library Production Kit (catalog #CCFOS110, Epicentre Biotechnologies) using the suggested protocol (Worldwide Website epibio.com/pdftechlit/171p1107.pdf). For each library, approximately 250 ng of mgDNA was ligated to 0.5 μg of the linearized fosmid pCC1FOS vector, packaged using replication-deficient phage extract, infected into E. coli strain EPI-300, and library size determined by dilution titering on LB-agar plates containing 12.5 μg/mL chloramphenicol (Table 1). E. coli infected mgDNA libraries were grown to mid-log phase in 10 mL LB-12.5 μg/mL-chloramphenicol, and frozen down at −80° C. in 1 mL aliquots in 15% glycerol. Each frozen stock was subsequently confirmed to have approximately 1-5×10⁸ colony forming units per mL. Based on the determined library sizes (Table 1), each library aliquot saved contained over 100 cell copies per individual 40-50 KB mgDNA fosmid library clone.

Selection of Functional Parts from Metagenomic Libraries

The inhibitory concentrations of 14 lignocellulosic compounds in LB-agar (Table 2) were determined for two versions of the E. coli strain used to create the mgDNA libraries—a strain with a control pCC1FOS fosmid insert containing E. coli genomic DNA, and an untransformed strain. In all cases, the lignocellulosic compound inhibitory effects, growth rates and biomass yields were found to be identical between these two strains. Accordingly, to control for the effect of the fosmid vector backbone, the E. coli strain with the control fosmid was used for all subsequent control comparisons against the mgDNA fosmid library clones. A range of concentrations for each lignocellulosic compound were tested, based on inhibitory concentrations for E. coli previously reported (1-3). Approximately 10⁶ E. coli cells were spread on each LB-agar plate containing each inhibitor at a specific concentration (and 12.5 μg/mL chloramphenicol for the strain containing the control fosmid insert), and growth of colonies was assayed after 48 hours of growth at 37° C. The lowest concentration of each compound tested which prevented colony formation at this time was denoted the selective inhibitory concentration (Table 2).

TABLE 2
Concentrations of 14 lignocellulosic compounds which inhibit the growth
of E. coli in LB-agar after 48 hours of growth at 37° C.

| | Inhibitory |
|---|---|
| Lignocellulosic compound | Concentration (g/L) |
| Hydroquinone | 1.85 |
| Methylcatechol | 0.20 |
| 4-hydroxy-benzaldhehyde | 1.25 |
| Syringaldehyde | 1.55 |
| Vanillin | 1.50 |
| Syringic acid | 9.55 |
| 2-Furoic acid | 0.80 |
| Vanillic acid | 8.08 |
| 4-hydrobenzoic acid | 7.90 |
| Acetic Acid | 5.00 |
| Levulinic acid | 3.00 |
| Furfural | 2.95 |
| Formic acid | 1.15 |
| Ethanol | 55.00 |

Growth selections at the determined inhibitory concentrations of the 14 lignocellulosic inhibitors (Table 8) were performed on 5 mgDNA libraries (libraries 1-5 in Table 6) and the control E. coli strain. Based on the determined library sizes and titers of the frozen library stocks, inocula were prepared to yield approximately 100 cell copies of each mgDNA library clone per selection (e.g., 2×10⁵ cells were plated out from a mgDNA library originally assayed to contain 2×10³ clones). Cells were spread on LB-agar plates containing 12.5 μg/mL-chloramphenicol and one of the 14 inhibitors at the selective inhibitory concentration (Table 2), and growth of colonies was assayed after 48 hours of growth at 37° C. Conditions yielding colonies from plated mgDNA libraries where the E. coli control was reconfirmed to be inhibited were denoted as successfully selected functional parts for tolerance to those inhibitors (black squares, FIG. 2A).

20 mg DNA library clones conferring tolerance to each of three inhibitors were chosen for further analysis of encoded functional parts from the selected inhibitor plates. For 4-methycatechol, 5 tolerant clones each were chosen from selected mgDNA libraries 1, 3, 4, and 5 (FIG. 2A). For 2-furoic acid, 6-7 tolerant clones each were chosen from selected mgDNA libraries 1, 3 and 4 (FIG. 2A). For syringaldehyde, 10 tolerant clones each were chosen from selected mgDNA libraries 4 and 5 (FIG. 2A). Each colony was grown to saturation (16-18 hours) at 37° C. with shaking in liquid LB medium containing 12.5 μg/mL-chloramphenicol (hereon referred to as LB-chlor). Saturated cultures were diluted 1:40 in fresh LB-chlor and grown to mid-log phase (1-2 hours) at 37° C. with shaking. Log-phase cultures were inoculated (1:40) into LB-chlor containing one of three concentrations of the relevant inhibitor (4-methylcatechol: 0.2, 0.6 and 1 g/L; 2-furoic acid: 0.8, 7.9, 15 g/L; syringaldehyde: 1.55, 1.775 and 2 g/L), with concentrations chosen to sparsely span the range of previously reported inhibitory concentrations of these compounds (J. Zaldivar, L. O. Ingram, Biotechnol Bioeng 66, 203 (1999); J. Zaldivar, A. Martinez, L. O. Ingram, Biotechnol Bioeng 65, 24 (Oct. 5, 1999); J. Zaldivar, A. Martinez, L. O. Ingram, Biotechnol Bioeng 68, 524 (Jun. 5, 2000)). Biomass yield after 24 hours of growth at 37° C. with shaking was determined by end-point turbidity measurements at 600 nm using a Versamax microplate reader (Molecular Devices).

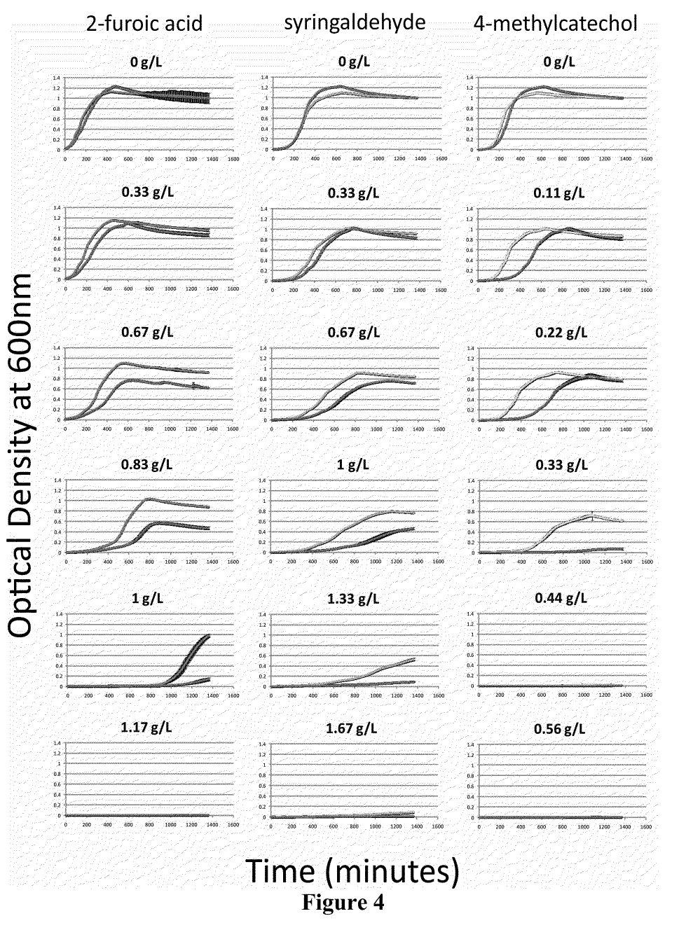

Three mgDNA clones per inhibitor with the highest biomass differential when compared to the E. coli control were chosen for kinetic growth analysis. Growth kinetics were measured at 11 concentrations per inhibitor, evenly spanning the following concentration ranges: 0-1 g/L 4-methylcatechol, 0-1.5 g/L 2-furoic acid, and 0-3 g/L syringaldehyde. Kinetic measurements were done in triplicate for each mgDNA clone and E. coli control by 600 nm measurements every 5 minutes over 24 hours at 37° C. with shaking in a Versamax microplate reader. In all cases, significant improvements in biomass yield were observed for the mgDNA clones in comparison to the control, with similar trends to those shown in FIG. 4.

To determine whether the observed tolerance in the selected clones was a result of functional parts encoded by mgDNA, fosmids from the 3 kinetically characterized mgDNA clones per inhibitor were extracted using the FosmidMAX DNA Purification Kit (catalog #FMAX046, Epicentre Biotechnologies). Purified fosmids were then retransformed into an electro-competent version of the same control E. coli strain using a standard electroporation protocol. 3 transformant colonies for each of the 3 kinetically characterized mgDNA clones per inhibitor were chosen for a repeat of the inhibitor tolerance kinetic growth analysis (see above). All of the retransformed fosmids for 4-methylcatechol and 2-furoic acid and 2 of the 3 retransformed fosmids for syringaldehyde recapitulated the improved inhibitor tolerance compared to the E. coli control seen for the original mgDNA selected clones. Inhibitor concentrations resulting in 90% reductions in growth yield after 24 hours of growth at 37° C. were determined for the control E. coli as 1.05 g/L, 1.33 g/L and 0.33 g/L for 2-furoic acid, syringaldehyde and methylcatechol, respectively. Kinetic growth plots for the mgDNA clone with the best improvements in biomass yield at these concentrations per inhibitor are shown in FIG. 4, over a range of inhibitor concentrations. These selected clones were from mgDNA library 3 for 2-furoic acid (mgFurAc), library 4 for syringaldehyde (mgSyrAld), and library 3 for 4-methylcatechol (mgMetCat).

Sequencing of Metagenomic Inserts

The mgDNA inserts from mgFurAc, mgSyrAld, and mgMetCat were chosen for DNA sequencing and analysis. Sequencing clone libraries were created by in vitro insertion of a transposon carrying unique sequencing primer sites and a kanamycin resistance cassette into random positions in the purified mgDNA fosmids, followed by transformation into the control E. coli strain, using the EZ-Tn5 <KAN-2> Insertion Kit (catalog #EZI982K, Epicentre Biotechnologies). 192 single transposon-inserted clones per fosmid were sequenced bi-directionally to yield approximately 3× sequence coverage of the approximately 40 KB inserts. Sequences were assembled into contigs using Phred/Phrap (P. Green. (1996)). Each assembly yielded 2-5 contigs. Primers were designed to close gaps between contigs and sequences resulting from this additional round of primer walking yielded sufficient sequence information for complete assembly of single full-length contigs for all 3 mgDNA inserts.

The assembled mgMetCat, mgFurAc and mgSyrAld contig sequences were compared to the NCBI non-redundant nucleotide database using BLAST (S. F. Altschul, W. Gish, W. Miller, E. W. Myers, D. J. Lipman, J Mol Biol 215, 403 (Oct. 5, 1990)). Regions of the inserts with the highest detectable homology were: 51% of mgMetCat was 79% identical to regions of the Thiobacillus denitrificans ATCC 25259 genome, 7% of mgFurAc was 79% identical to regions of the Pelobacter propionicus DSM 2379 genome and 1% of mgSyrAld was 73% identical to regions of the Burkholderia ambifaria AMMD chromosome 2. The Rapid Annotation using Subsystem Technology Server version 2.0 (R. K. Aziz et al., BMC Genomics 9, 75 (2008)) was used to annotate the three full-length contigs, and annotation information for mgMetCat, mgFurAc and mgSyrAld are tabulated in Tables 3, 4 and 5, respectively.

TABLE 3
Annotated features in metagenomic insert mgMetCat

| | | | | Length | | |
|---|---|---|---|---|---|---|
| Contig | Feature # | Start | Stop | (bp) | Function | Subsystem |
| mgMetCat | 1 | 3500 | 3150 | 351 | hypothetical protein | none |
| mgMetCat | 2 | 4235 | 3507 | 729 | Hydroxyacylglutathione | Cobalt-zinc- |
| | | | | | hydrolase (EC 3.1.2.6) | cadmium |
| | | | | | | resistance |
| mgMetCat | 3 | 4927 | 4265 | 663 | Transcriptional regulator, | none |
| | | | | | ArsR family | |
| mgMetCat | 4 | 5102 | 6352 | 1251 | Enoyl-[acyl-carrier-protein] | none |
| | | | | | reductase [FMN] (EC 1.3.1.9) | |
| mgMetCat | 5 | 6466 | 6657 | 192 | Cytochrome d ubiquinol | none |
| | | | | | oxidase subunit II (EC | |
| | | | | | 1.10.3.—) | |
| mgMetCat | 6 | 7219 | 8379 | 1161 | NADH dehydrogenase (EC | Respiratory |
| | | | | | 1.6.99.3) | dehydrogenases 1 |
| mgMetCat | 7 | 8665 | 9087 | 423 | Hemoglobin-like protein HbO | Bacterial |
| | | | | | | hemoglobins |
| mgMetCat | 8 | 9289 | 10023 | 735 | Hydroxyacylglutathione | Cobalt-zinc- |
| | | | | | hydrolase (EC 3.1.2.6) | cadmium |
| | | | | | | resistance |
| mgMetCat | 9 | 10024 | 10431 | 408 | Hydroxyacylglutathione | none |
| | | | | | hydrolase (EC 3.1.2.6) | |
| mgMetCat | 10 | 11662 | 10799 | 864 | Basic proline-rich protein | none |
| mgMetCat | 11 | 12280 | 11828 | 453 | Putative lipid carrier protein | none |
| mgMetCat | 12 | 12753 | 12313 | 441 | Queuosine biosynthesis | Experimental- |
| | | | | | QueD, PTPS-I | PTPS |
| mgMetCat | 13 | 13665 | 12772 | 894 | Putative protease | none |
| mgMetCat | 14 | 14674 | 13673 | 1002 | Putative protease | none |
| mgMetCat | 15 | 15614 | 14664 | 951 | hypothetical protein | none |
| mgMetCat | 16 | 16795 | 15611 | 1185 | 2-nitropropane dioxygenase | none |
| | | | | | (EC 1.13.11.32) | |
| mgMetCat | 17 | 16957 | 17562 | 606 | Riboflavin synthase alpha | none |
| | | | | | chain (EC 2.5.1.9) | |
| mgMetCat | 18 | 17562 | 18647 | 1086 | 3,4-dihydroxy-2-butanone 4- | none |
| | | | | | phosphate synthase/GTP | |
| | | | | | cyclohydrolase II (EC | |
| | | | | | 3.5.4.25) | |
| mgMetCat | 19 | 18659 | 19126 | 468 | 6,7-dimethyl-8- | none |
| | | | | | ribityllumazine synthase (EC | |
| | | | | | 2.5.1.9) | |
| mgMetCat | 20 | 19128 | 19580 | 453 | Transcription termination | none |
| | | | | | protein NusB | |
| mgMetCat | 21 | 19612 | 20343 | 732 | Thiamine-monophosphate | none |
| | | | | | kinase (EC 2.7.4.16) | |
| mgMetCat | 22 | 20336 | 20566 | 231 | Thiamine-monophosphate | none |
| | | | | | kinase (EC 2.7.4.16) | |
| mgMetCat | 23 | 20547 | 21035 | 489 | Phosphatidylglycerophosphatase | none |
| | | | | | A (EC 3.1.3.27) | |
| mgMetCat | 24 | 21023 | 21529 | 507 | Similar to C-terminal domain | none |
| | | | | | of competence/damage- | |
| | | | | | inducible protein CinA | |
| mgMetCat | 25 | 22476 | 21535 | 942 | COGs COG2378 | none |
| mgMetCat | 26 | 22621 | 23661 | 1041 | RecA protein | none |
| mgMetCat | 27 | 23654 | 24124 | 471 | Regulatory protein recX | none |
| mgMetCat | 28 | 24238 | 24903 | 666 | Putative TEGT family | none |
| | | | | | carrier/transport protein | |
| mgMetCat | 29 | 24910 | 25710 | 801 | Putative deoxyribonuclease | YcfH |
| | | | | | YjjV | |
| mgMetCat | 30 | 26071 | 25718 | 354 | hypothetical protein | none |
| mgMetCat | 31 | 26691 | 26158 | 534 | hypothetical protein | none |
| mgMetCat | 32 | 27206 | 26730 | 477 | Putative protein-S- | none |
| | | | | | isoprenylcysteine | |
| | | | | | methyltransferase | |
| mgMetCat | 33 | 27843 | 27223 | 621 | Transcriptional regulator | none |
| mgMetCat | 34 | 28446 | 27889 | 558 | hypothetical protein | none |
| mgMetCat | 35 | 29105 | 28461 | 645 | GTP cyclohydrolase I (EC | YHI9 |
| | | | | | 3.5.4.16) type 1 | |
| mgMetCat | 36 | 29892 | 29098 | 795 | Dienelactone hydrolase | none |
| mgMetCat | 37 | 29868 | 30716 | 849 | tRNA pseudouridine synthase | none |
| | | | | | A (EC 4.2.1.70) | |
| mgMetCat | 38 | 31571 | 30738 | 834 | LSU ribosomal protein L17p | none |
| mgMetCat | 39 | 32620 | 31619 | 1002 | probable | none |
| | | | | | deoxyribodipyrimidine | |
| | | | | | photolyase | |
| mgMetCat | 40 | 34458 | 33169 | 1290 | Permease of the major | none |
| | | | | | facilitator superfamily | |
| mgMetCat | 41 | 34718 | 35275 | 558 | Error-prone repair protein | none |
| | | | | | UmuD (EC 3.4.21.—) | |
| mgMetCat | 42 | 35250 | 36569 | 1320 | Error-prone repair protein | none |
| | | | | | UmuC | |
| mgMetCat | 43 | 36624 | 37076 | 453 | hypothetical protein | none |
| mgMetCat | 44 | 37155 | 38339 | 1185 | Alkaline phosphodiesterase I | none |
| | | | | | (EC 3.1.4.1)/Nucleotide | |
| | | | | | pyrophosphatase (EC 3.6.1.9) | |
| mgMetCat | 45 | 38495 | 39391 | 897 | hypothetical protein | none |
| mgMetCat | 46 | 39429 | 41840 | 2412 | Lead, cadmium, zinc and | none |
| | | | | | mercury transporting ATPase | |
| | | | | | (EC 3.6.3.3) (EC 3.6.3.5); | |
| | | | | | Copper-translocating P-type | |
| | | | | | ATPase (EC 3.6.3.4) | |

TABLE 4
Annotated features in metagenomic insert mgFurAc

| | | | | Length | | |
|---|---|---|---|---|---|---|
| Contig | Feature # | Start | Stop | (bp) | Function | Subsystem |
| mgFurAc | 1 | 35 | 760 | 726 | alternate gene name: yzbB | none |
| mgFurAc | 2 | 854 | 1555 | 702 | Ribonuclease HI (EC | none |
| | | | | | 3.1.26.4) | |
| mgFurAc | 3 | 2031 | 1699 | 333 | hypothetical protein | none |
| mgFurAc | 4 | 2396 | 4915 | 2520 | Glycerol-3-phosphate | none |
| | | | | | acyltransferase (EC 2.3.1.15) | |
| mgFurAc | 5 | 4809 | 5060 | 252 | hypothetical protein | none |
| mgFurAc | 6 | 5073 | 6320 | 1248 | Mannose-1-phosphate | none |
| | | | | | guanylyltransferase (EC | |
| | | | | | 2.7.7.13) | |
| mgFurAc | 7 | 6106 | 6816 | 711 | COG3178: Predicted | none |
| | | | | | phosphotransferase related to | |
| | | | | | Ser/Thr protein kinases | |
| mgFurAc | 8 | 6913 | 7743 | 831 | Dihydrodipicolinate reductase | none |
| | | | | | (EC 1.3.1.26) | |
| mgFurAc | 9 | 7872 | 10268 | 2397 | hypothetical protein | none |
| mgFurAc | 10 | 12957 | 10330 | 2628 | Alanyl-tRNA synthetase (EC | none |
| | | | | | 6.1.1.7) | |
| mgFurAc | 11 | 13986 | 12961 | 1026 | RecA protein | none |
| mgFurAc | 12 | 14888 | 14313 | 576 | 2′-5′ RNA ligase | none |
| mgFurAc | 13 | 16072 | 14903 | 1170 | Ferredoxin oxidoreductase | none |
| mgFurAc | 14 | 17512 | 16079 | 1434 | Membrane proteins related to | none |
| | | | | | metalloendopeptidases | |
| mgFurAc | 15 | 17668 | 17567 | 102 | hypothetical protein | none |
| mgFurAc | 16 | 19506 | 18238 | 1269 | hypothetical protein | none |
| mgFurAc | 17 | 19500 | 20222 | 723 | Multidrug resistance ABC | Multidrug |
| | | | | | transporter ATP-binding and | Resistance |
| | | | | | permease protein | Efflux Pumps |
| mgFurAc | 18 | 20176 | 21663 | 1488 | RNA polymerase sigma-54 | none |
| | | | | | factor rpoN | |
| mgFurAc | 19 | 21674 | 22201 | 528 | Ribosomal subunit interface | none |
| | | | | | protein | |
| mgFurAc | 20 | 22216 | 22713 | 498 | PTS system, fructose-specific | none |
| | | | | | IIA component (EC 2.7.1.69)/ | |
| | | | | | PTS system, fructose- | |
| | | | | | specific IIB component (EC | |
| | | | | | 2.7.1.69)/PTS system, | |
| | | | | | fructose-specific IIC | |
| | | | | | component (EC 2.7.1.69) | |
| mgFurAc | 21 | 22739 | 23347 | 609 | UPF0042 protein | none |
| | | | | | SYNAS_12170 | |
| mgFurAc | 22 | 23779 | 23910 | 132 | hypothetical protein | none |
| mgFurAc | 23 | 24038 | 24457 | 420 | PTS system, mannose- | none |
| | | | | | specific IIA component (EC | |
| | | | | | 2.7.1.69) | |
| mgFurAc | 24 | 24454 | 24927 | 474 | Ribosomal-protein-S18p- | none |
| | | | | | alanine acetyltransferase (EC | |
| | | | | | 2.3.1.—) | |
| mgFurAc | 25 | 24924 | 25928 | 1005 | NAD-dependent | Glutaredoxins |
| | | | | | glyceraldehyde-3-phosphate | |
| | | | | | dehydrogenase (EC 1.2.1.12) | |
| mgFurAc | 26 | 25956 | 26711 | 756 | Triosephosphate isomerase | none |
| | | | | | (EC 5.3.1.1) | |
| mgFurAc | 27 | 26731 | 27096 | 366 | Preprotein translocase subunit | none |
| | | | | | SecG (TC 3.A.5.1.1) | |
| mgFurAc | 28 | 27692 | 28336 | 645 | Acyl carrier protein | none |
| | | | | | phosphodiesterase (EC | |
| | | | | | 3.1.4.14) | |
| mgFurAc | 29 | 28553 | 28350 | 204 | hypothetical protein | none |
| mgFurAc | 30 | 34587 | 36143 | 1557 | Serine phosphatase RsbU, | none |
| | | | | | regulator of sigma subunit | |
| mgFurAc | 31 | 36250 | 37329 | 1080 | hypothetical protein | none |
| mgFurAc | 32 | 39479 | 38472 | 1008 | hypothetical protein | none |
| mgFurAc | 33 | 40098 | 39517 | 582 | pXO1-120 homology; | none |
| | | | | | transposase for IS660 | |
| mgFurAc | 34 | 41616 | 40507 | 1110 | Rhs family protein | none |
| mgFurAc | 35 | 41809 | 43314 | 1506 | Transposase, IS4 | none |
| mgFurAc | 36 | 27121 | 27206 | 86 | tRNA-Leu-GAG | none |

TABLE 5
Open-reading frames annotated in metagenomic insert mgSyrAld

| | | | | Length | | |
|---|---|---|---|---|---|---|
| Contig | Feature # | Start | Stop | (bp) | Function | Subsystem |
| mgSyrAld | 1 | 45 | 3284 | 3240 | Glycosyl hydrolase, BNR | none |
| | | | | | repeat-containing protein | |
| | | | | | precursor | |
| mgSyrAld | 2 | 4388 | 3333 | 1056 | Ribosomal large subunit | none |
| | | | | | pseudouridine synthase D (EC | |
| | | | | | 4.2.1.70) | |
| mgSyrAld | 3 | 5231 | 4443 | 789 | Prolipoprotein diacylglyceryl | none |
| | | | | | transferase (EC 2.4.99.—) | |
| mgSyrAld | 4 | 5861 | 5262 | 600 | Lipoprotein signal peptidase | none |
| | | | | | (EC 3.4.23.36) | |
| mgSyrAld | 5 | 8779 | 5807 | 2973 | Isoleucyl-tRNA synthetase (EC | none |
| | | | | | 6.1.1.5) | |
| mgSyrAld | 6 | 10595 | 9159 | 1437 | Potassium efflux system kefA/ | none |
| | | | | | Small-conductance | |
| | | | | | mechanosensitive channel | |
| mgSyrAld | 7 | 11203 | 10592 | 612 | Thiamin-phosphate | none |
| | | | | | pyrophosphorylase (EC | |
| | | | | | 2.5.1.3) | |
| mgSyrAld | 8 | 11463 | 11200 | 264 | hypothetical protein | none |
| mgSyrAld | 9 | 13738 | 11888 | 1851 | Conserved domain protein | none |
| mgSyrAld | 10 | 13914 | 14423 | 510 | Peptide deformylase (EC | none |
| | | | | | 3.5.1.88) | |
| mgSyrAld | 11 | 14566 | 15960 | 1395 | Cysteinyl-tRNA synthetase (EC | none |
| | | | | | 6.1.1.16) | |
| mgSyrAld | 12 | 16680 | 17630 | 951 | 3-dehydroquinate dehydratase | Quinate |
| | | | | | (EC 4.2.1.10)/Shikimate 5- | degradation |
| | | | | | dehydrogenase (EC 1.1.1.25) | |
| mgSyrAld | 13 | 17627 | 19144 | 1518 | Anthranilate synthase, aminase | none |
| | | | | | component (EC 4.1.3.27) | |
| mgSyrAld | 14 | 19141 | 19716 | 576 | Anthranilate synthase, | none |
| | | | | | amidotransferase component | |
| | | | | | (EC 4.1.3.27) | |
| mgSyrAld | 15 | 19713 | 20750 | 1038 | Anthranilate | none |
| | | | | | phosphoribosyltransferase (EC | |
| | | | | | 2.4.2.18) | |
| mgSyrAld | 16 | 20711 | 21532 | 822 | Indole-3-glycerol phosphate | none |
| | | | | | synthase (EC 4.1.1.48) | |
| mgSyrAld | 17 | 21529 | 22146 | 618 | Phosphoribosylanthranilate | none |
| | | | | | isomerase (EC 5.3.1.24) | |
| mgSyrAld | 18 | 22130 | 23329 | 1200 | Tryptophan synthase beta chain | none |
| | | | | | (EC 4.2.1.20) | |
| mgSyrAld | 19 | 23326 | 24189 | 864 | Tryptophan synthase alpha | none |
| | | | | | chain (EC 4.2.1.20) | |
| mgSyrAld | 20 | 24206 | 24862 | 657 | hypothetical protein | none |
| mgSyrAld | 21 | 24820 | 25677 | 858 | Transcriptional regulator, XRE | none |
| | | | | | family | |
| mgSyrAld | 22 | 26433 | 26771 | 339 | hypothetical protein | none |
| mgSyrAld | 23 | 27499 | 28278 | 780 | Protein serine/threonine | none |
| | | | | | phosphatase PrpC, regulation | |
| | | | | | of stationary phase | |
| mgSyrAld | 24 | 29911 | 28325 | 1587 | hypothetical protein | none |
| mgSyrAld | 25 | 31149 | 30673 | 477 | ADP-ribose pyrophosphatase | Nudix proteins |
| | | | | | (EC 3.6.1.13) | (nucleoside |
| | | | | | | triphosphate |
| | | | | | | hydrolases) |
| mgSyrAld | 26 | 33566 | 31146 | 2421 | DinG family ATP-dependent | none |
| | | | | | helicase CPE1197 | |
| mgSyrAld | 27 | 33593 | 35104 | 1512 | D-alanyl-D-alanine | none |
| | | | | | carboxypeptidase (EC 3.4.16.4) | |
| mgSyrAld | 28 | 35850 | 37067 | 1218 | hypothetical protein | none |
| mgSyrAld | 29 | 37465 | 38874 | 1410 | hypothetical protein | none |
| mgSyrAld | 30 | 38910 | 40256 | 1347 | Serine phosphatase RsbU, | none |
| | | | | | regulator of sigma subunit | |
| mgSyrAld | 31 | 40263 | 41435 | 1173 | Sarcosine oxidase beta subunit | none |
| | | | | | (EC 1.5.3.1) | |
| mgSyrAld | 32 | 42517 | 41474 | 1044 | UDP-glucose 4-epimerase (EC | none |
| | | | | | 5.1.3.2) | |

Loss of Function Study by Transposon Mutagenesis

In order to identify the genes within the approximately 40 KB mgDNA inserts responsible for the improved tolerance, a loss-of-function study was performed on mgFurAc and mgSyrAld. The 192 transposon-inserted clones created for sequencing of the mgFurAc and mgSyrAld fosmids were individually subjected to growth survival assays in the presence of 0.8 g/L 2-furoic acid and 1.4 g/L syringaldehyde, respectively. Kinetic measurements were done for each transposon-inserted clone, along with triplicate measurements for the original mgDNA clone and E. coli control at these concentrations, by 600 nm measurements every 5 minutes over 24 hours at 37° C. with shaking in a Versamax microplate reader. Three separate transposition events in mgSyrAld and seven separate transposition events in mgFurAc resulted in knock down of the relevant tolerance phenotypes. The inhibitor tolerance growth kinetics of these transposon-inserted clones were retested in triplicate to confirm the knock-down phenotype. The exact sequence position for each transposition event was mapped by sequence comparison of the unique 19 base pair Mosaic-End sequence from the EZ-Tn5 <KAN-2> Transposon found in each raw sequence read to the fully assembled and annotated mgFurAc and mgSyrAld contigs, using BLAST (S. F. Altschul, W. Gish, W. Miller, E. W. Myers, D. J. Lipman, J Mol Biol 215, 403 (Oct. 5, 1990)).

Structural Characterization of Gene Products Required for Improved Phenotypes

A model of the tertiary structure of the three gene products from mgFurAc and mgSyrAld identified to be responsible for the improved tolerance was made. The 3D-Jury structure prediction meta-server (K. Ginalski, A. Elofsson, D. Fischer, L. Rychlewski, Bioinformatics 19, 1015 (May 22, 2003)) returned high-quality consensus predictions for the mgSyrAld gene annotated to be a UDP-glucose 4-epimerase and the mgFurAc gene annotated to be a RecA protein. The best scoring consensus structure prediction for the mgSyrAld UDP-glucose 4-epimerase was obtained from the FFAS03 structure prediction server (L. Jaroszewski, L. Rychlewski, Z. Li, W. Li, A. Godzik, Nucleic Acids Res 33, W284 (Jul. 1, 2005)), which computed a model with significant homology to chain A of the 2.37 Å x-ray crystal structure of the Thermus thermophilus HB8 UDP-glucose 4-epimerase (2P5U) (H. M. Berman et al., Nucleic Acids Res 28, 235 (Jan. 1, 2000)), with a 3D-Jury consensus similarity J-score of 244.86 for the 348 amino-acid query. The best scoring consensus structure prediction for the mgFurAc RecA was obtained from the SAM-T02 HMM-based structure prediction server (K. Karplus et al., Proteins 53 Suppl 6, 491 (2003)), which computed a model with significant homology to chain A of the 3.10 Å x-ray crystal structure Mycobacterium smegmatis RecA protein (2OEP) (H. M. Berman et al., Nucleic Acids Res 28, 235 (Jan. 1, 2000)), with a 3D-Jury consensus similarity J-score of 269.88 for the 342 amino-acid query.

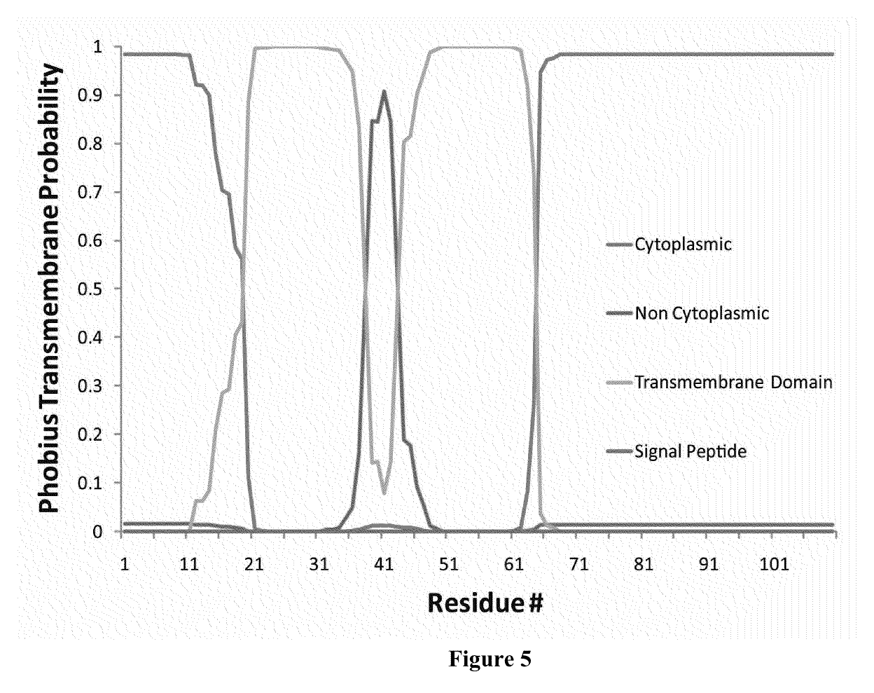

None of the protein structure prediction servers queried by the 3D-Jury structure prediction server were able to return significant models for the mgFurAc hypothetical protein. High confidence topology predictions were obtained from the Phobius server (L. Kall, A. Krogh, E. L. Sonnhammer, J Mol Biol 338, 1027 (May 14, 2004)), indicating that the protein contains two transmembrane helices (FIG. 5).

Lignin Monomer Utilization Enrichment and Library Construction

Given the staggering diversity of soil microbiomes (R. Daniel, Nat Rev Microbiol 3, 470 (June, 2005)) it was clear that even the 2×10⁹ base pair mgDNA libraries represented a miniscule fraction of the total genetic content assayed. The technical limitations preventing an exhaustive coverage of the soil metagenome prompts the idea of enriching libraries for functions of interest. An interesting property to transfer to biofuel-producing organisms is the ability to utilize lignocellulosic inhibitors as a carbon source. Accordingly, one bog soil and four farm soil microbiomes were cultured in minimal media that contained one of 17 lignocellulosic inhibitors (Table 2) as the carbon source.

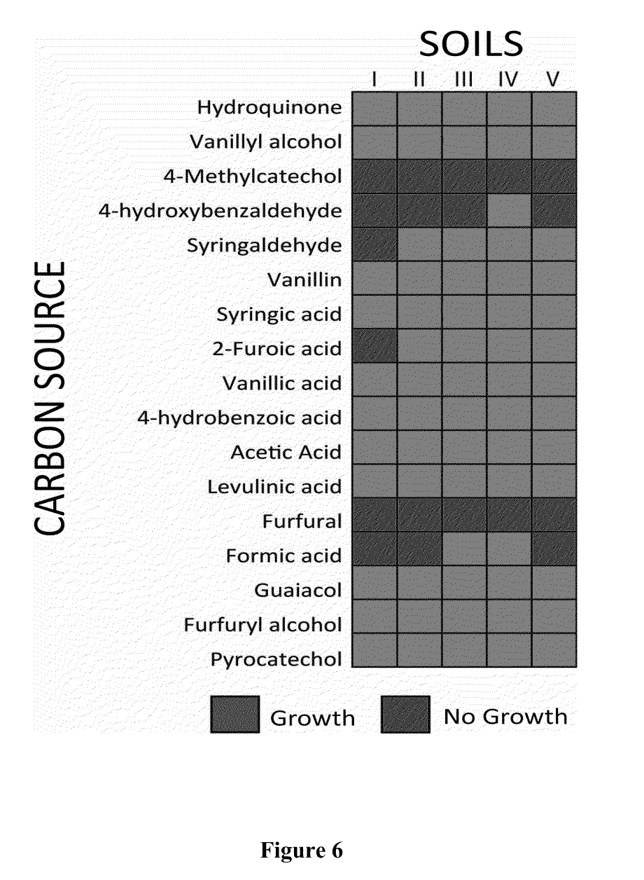

Liquid media used for isolating bacteria capable of subsisting on lignocellulosic inhibitor compounds was made by dissolving 1 g/L of the relevant lignocellulosic compounds (FIG. 6) into minimal media containing 5 g (NH₄)₂SO₄, 3 g KH₂PO₄, 0.5 g MgSO₄.7H₂O, 15 mg EDTA, 4.5 mg ZnSO₄.7H₂O, 4.5 mg CaCl₂.2H₂O, 3 mg FeSO₄.7H₂O, 1 mg MnCl₂.4H₂O, 1 mg H₃BO₃, 0.4 mg Na₂MoO₄.2H₂O, 0.3 mg CuSO₄.5H₂O, 0.3 mg CoCl₂.6H₂0 and 0.1 mg KI per liter water. The pH was adjusted to 5.5 using HCl, and the media was sterilized through a 0.22 μm filter.

Initial soil microbial inocula were prepared in the minimal medium, and inoculated into the minimal medium with one of the 17 lignocellulosic inhibitor compounds at 1 g/L (corresponding to approximately 125 mg of dissolved soil in 5 mL of media). To significantly reduce the transfer of residual alternative carbon sources present in original inocula, samples were passaged (2.5 μL) into fresh lignocellulosic compound media (5 mL) two additional times after 7 days of growth, resulting in a 5×10⁴ dilution at each passage (resulting in a final carryover of approximately 30 ng of soil in 5 mL of media at the third passage). Final culture growth was recorded after incubation without shaking at 22° C. and cultures with at least 10⁸ cells/mL were assayed as positive growth (FIG. 6).

Metagenomic DNA was extracted from four cultures utilizing vanillin, vanillic acid, syringic acid, and guaiacol. With these cultures, the final 2.5 μL culturing passage was done into 50 mL of fresh lignocellulosic compound media, and the cultures were allowed to grow without shaking at 22° C. for 21 days. DNA from the 50 mL cultures was extracted and purified using the Genomic-tip 500/G kit (catalog #10262, Qiagen). Fosmid libraries were created from these enriched-culture DNA preparations exactly as the un-enriched soil mgDNA libraries (Table 1).

A selection for functional parts encoding resistance to vanillin, vanillic acid, syringic acid, and guaiacol was performed from the mgDNA libraries created from the corresponding enriched cultures utilizing those compounds. The selection scheme was identical to that used for the un-enriched mgDNA libraries. However, clones with improved tolerance compared to the E. coli control were not obtained for any cases.

### Example III

### Bacteria Subsisting on Antibiotics

Bacterial infections are a leading cause of death, against which antibiotics provide a crucial line of defense. Nevertheless, several antibiotics are natural products of microorganisms that have as yet poorly appreciated ecological roles in the wider environment. Hundreds of soil bacteria with the capacity to grow on antibiotics as a sole carbon source were isolated. Of 18 antibiotics tested, representing 8 major classes of natural and synthetic origin, 13-17 antibiotics supported growth of clonal bacteria from each of 11 diverse soils. Bacteria subsisting on antibiotics are surprisingly phylogenetically diverse and many are closely related to human pathogens. Furthermore, each antibiotic consuming isolate is resistant to multiple antibiotics at clinically relevant concentrations. Without intending to be bound by scientific theory, this phenomenon indicates this unappreciated reservoir of antibiotic resistance determinants can contribute to the increasing levels of multiple antibiotic resistance in pathogenic bacteria.

The seemingly unchecked spread of multiple antibiotic resistance in clinically relevant pathogenic microbes is alarming. Furthermore, a significant environmental reservoir of antibiotic resistance determinants, termed the antibiotic resistome, has been discovered (C. S. Riesenfeld, R. M. Goodman, J. Handelsman, Environmental Microbiology 6, 981 (September, 2004); V. M. D'Costa, K. M. McGrann, D. W. Hughes, G. D. Wright, Science 311, 374 (January, 2006)). The primary microbial antibiotic resistance mechanisms include efflux pumps, target gene-product modifications, and enzymatic inactivation of the antibiotic compound (C. Walsh, Nature 406, 775 (August, 2000); M. N. Alekshun, S. B. Levy, Cell 128, 1037 (March, 2007)). Many of the mechanisms are common to several species of pathogens and spread by lateral gene transfer (J. Davies, Science 264, 375 (April, 1994)). While enzymatic inactivation is often sufficient to annul the antimicrobial activity of these chemicals, the biochemical processing of these compounds is unlikely to end here and it was hypothesized that the soil microbiome must include a significant reservoir of bacteria capable of subsisting on antibiotics. While many bacteria growing in extreme environments (J. K. Fredrickson, H. M. Kostandarithes, S. W. Li, A. E. Plymale, M. J. Daly, Applied and Environmental Microbiology 66, 2006 (May, 2000)) and capable of degrading toxic substrates (K. A. McAllister, H. Lee, J. T. Trevors, Biodegradation 7, 1 (February, 1996)) have been previously reported, only a few organisms have been shown to subsist on a limited number of antibiotic substrates (Y. Kameda, E. Toyoura, Y. Kimura, T. Omori, Nature 191, 1122 (1961); J. Johnsen, Archives of Microbiology 115, 271 (1977); Abdelm. Y, A. Hazem, M. Monib, Nature 189, 775 (1961)).

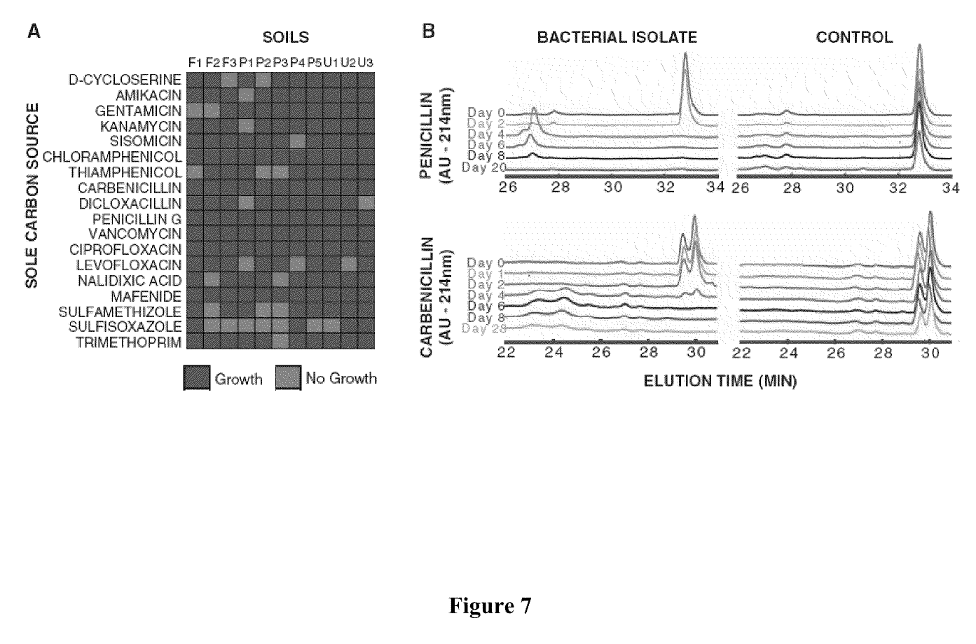

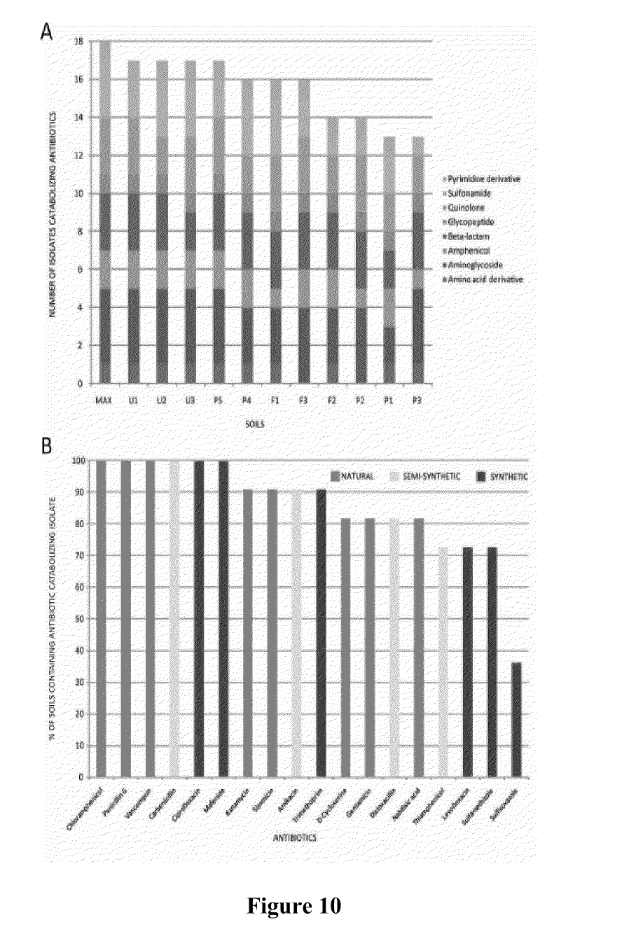

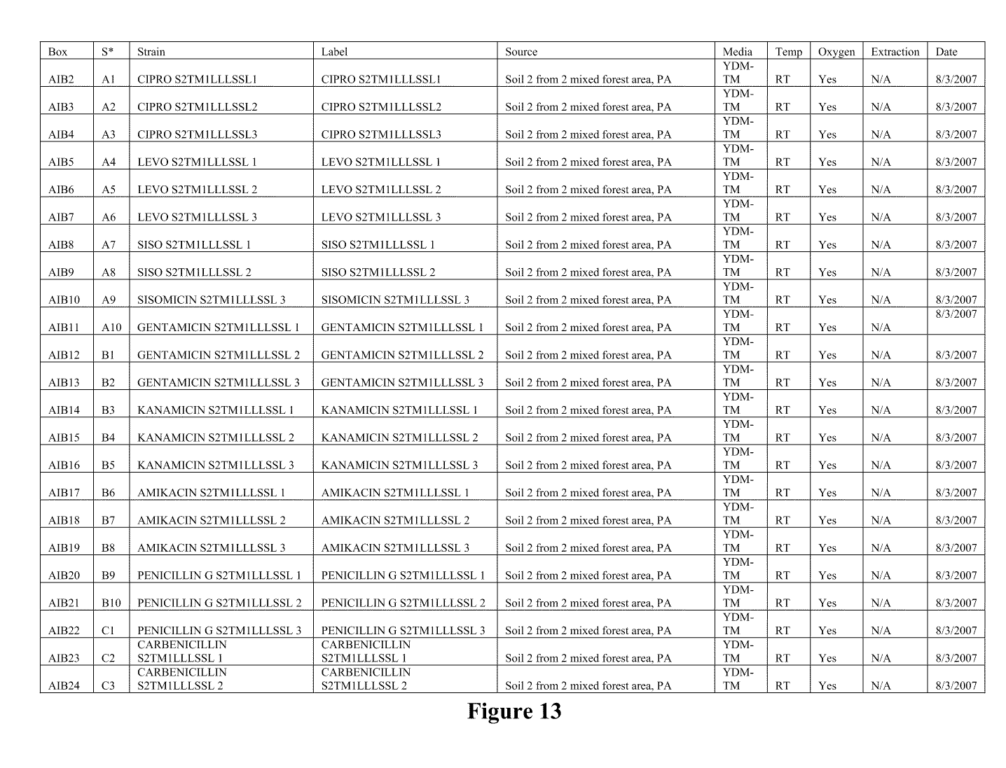

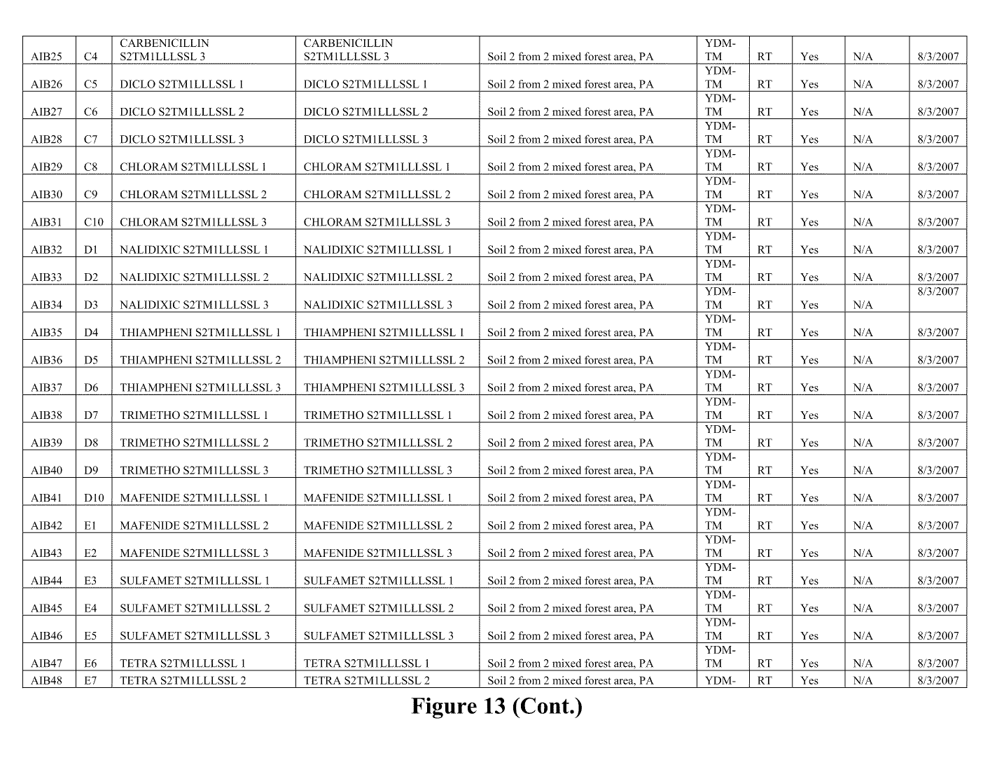

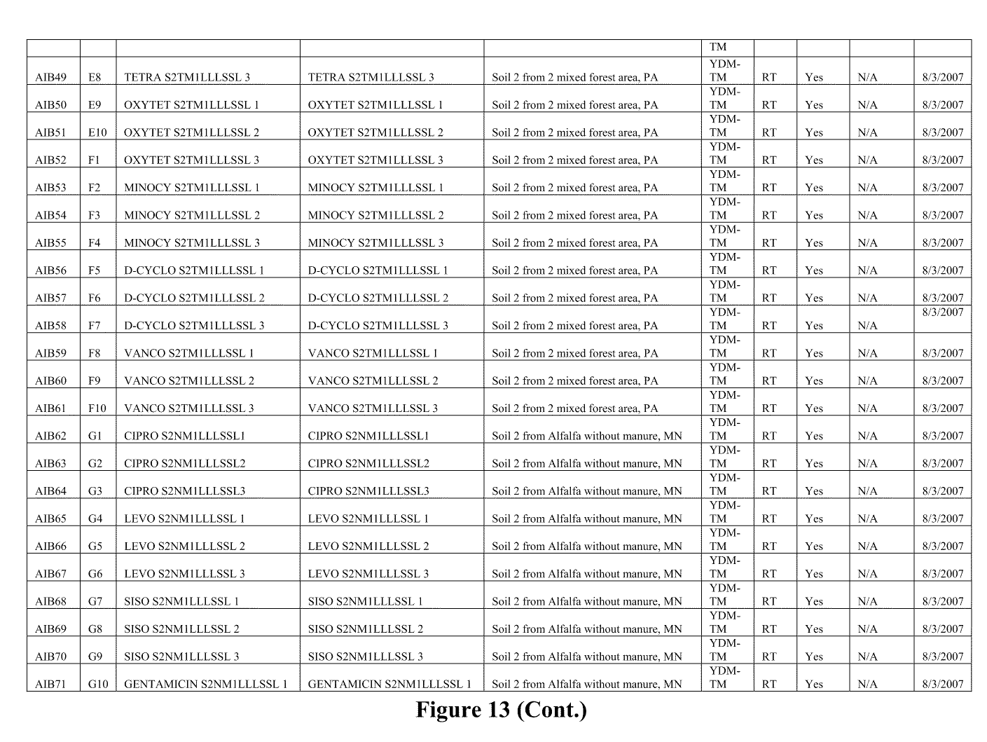

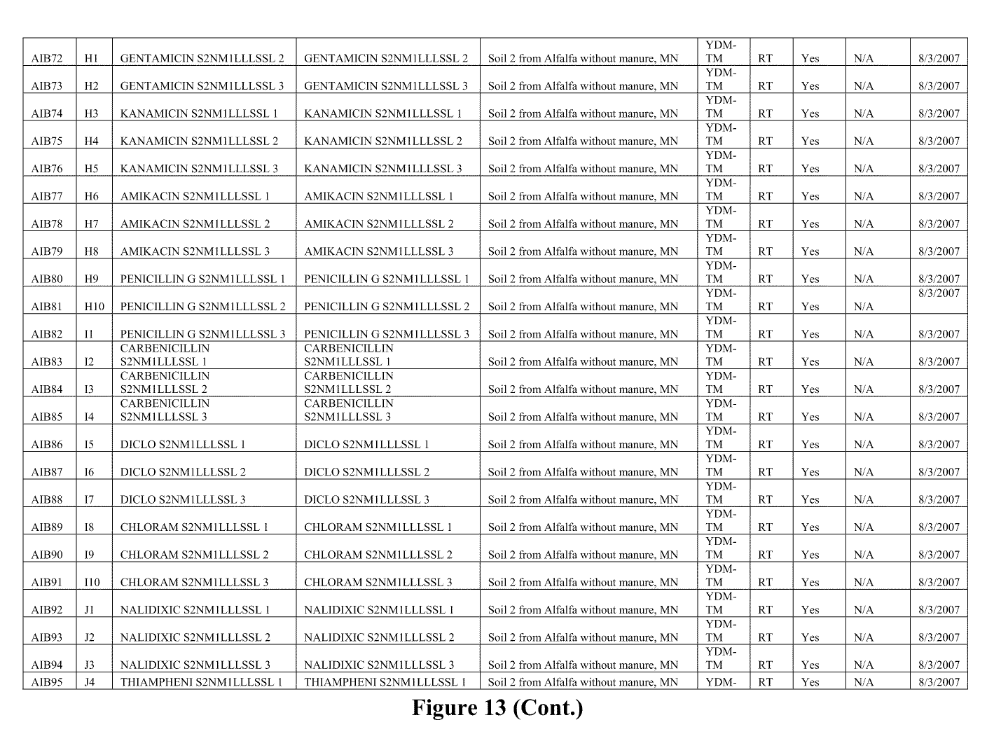

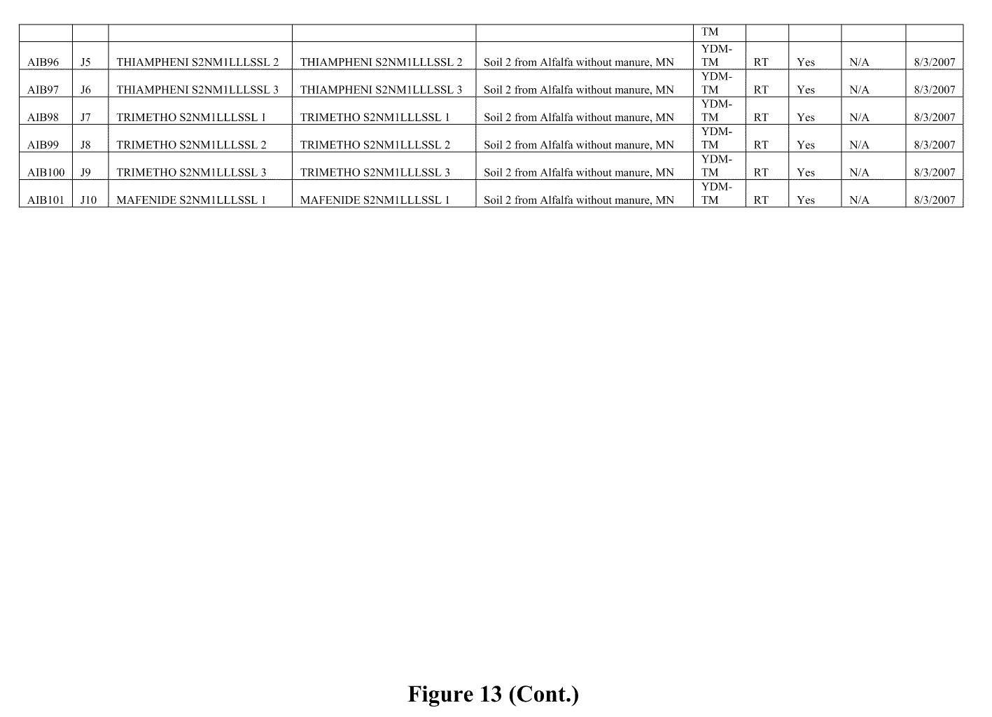

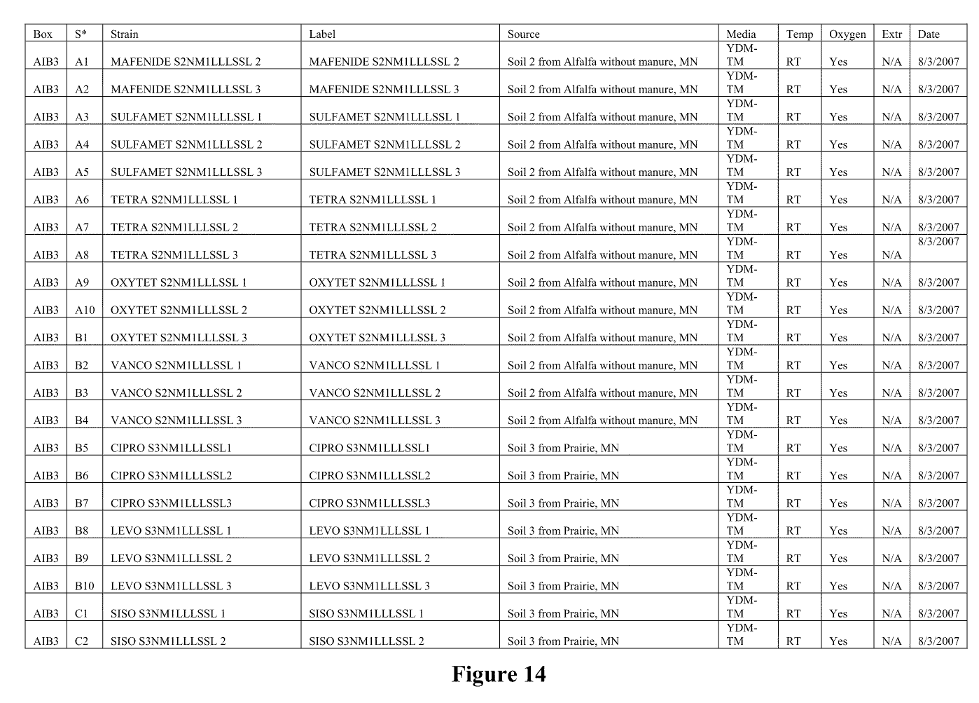

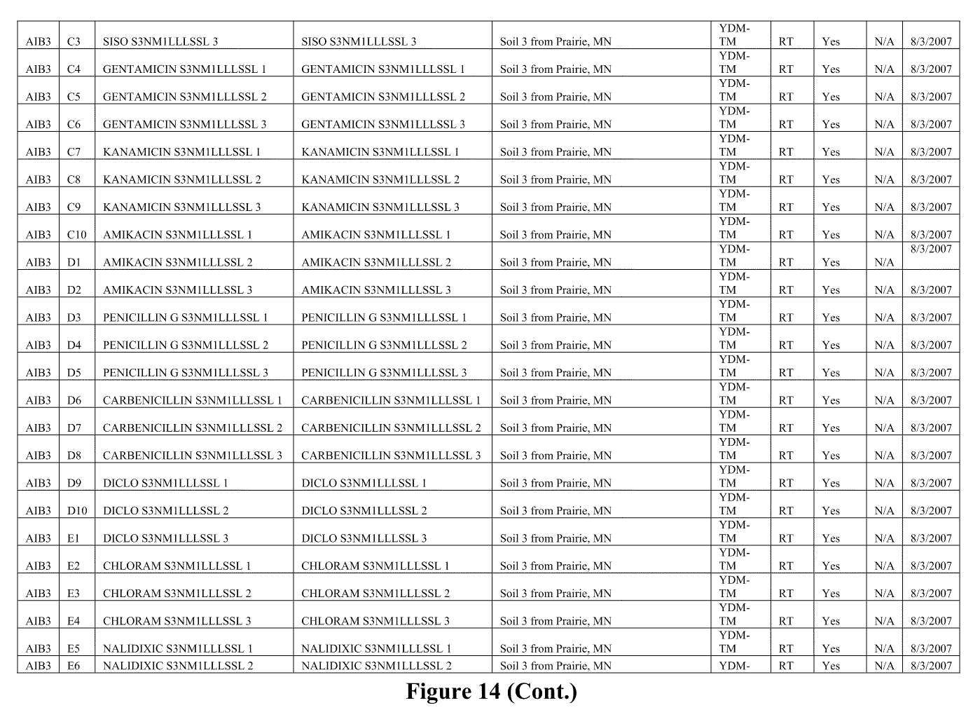

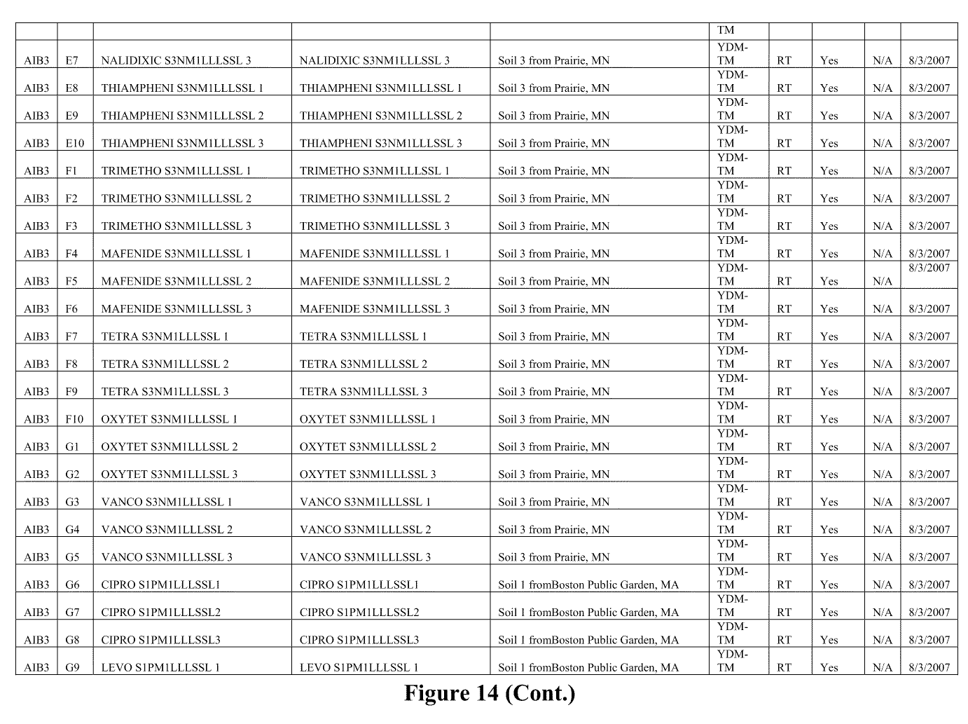

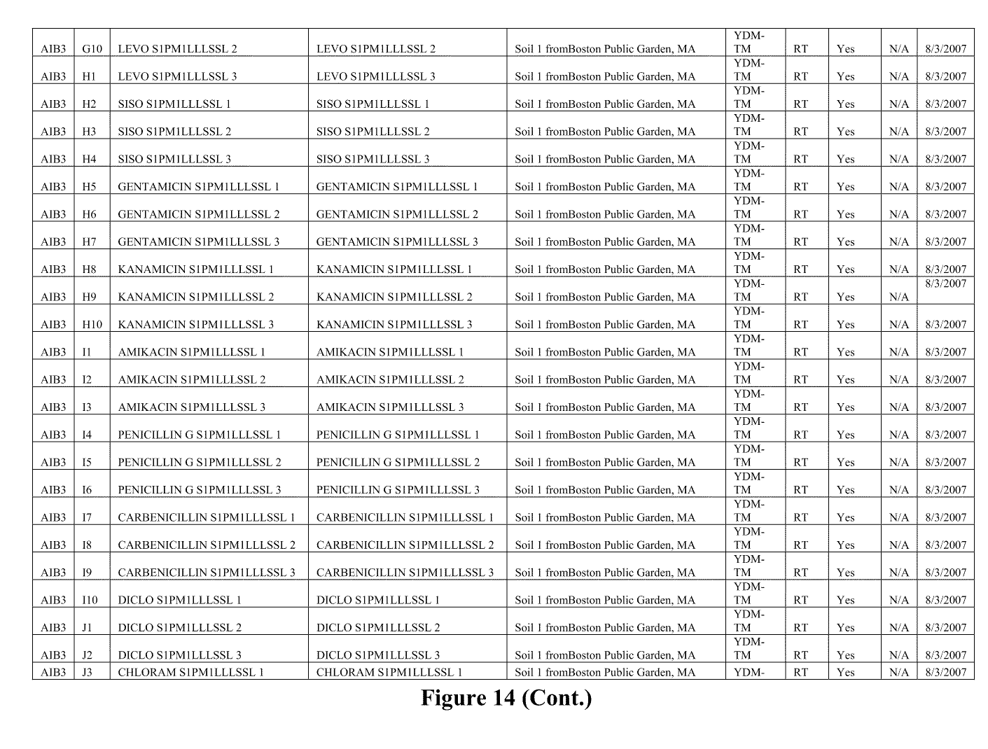

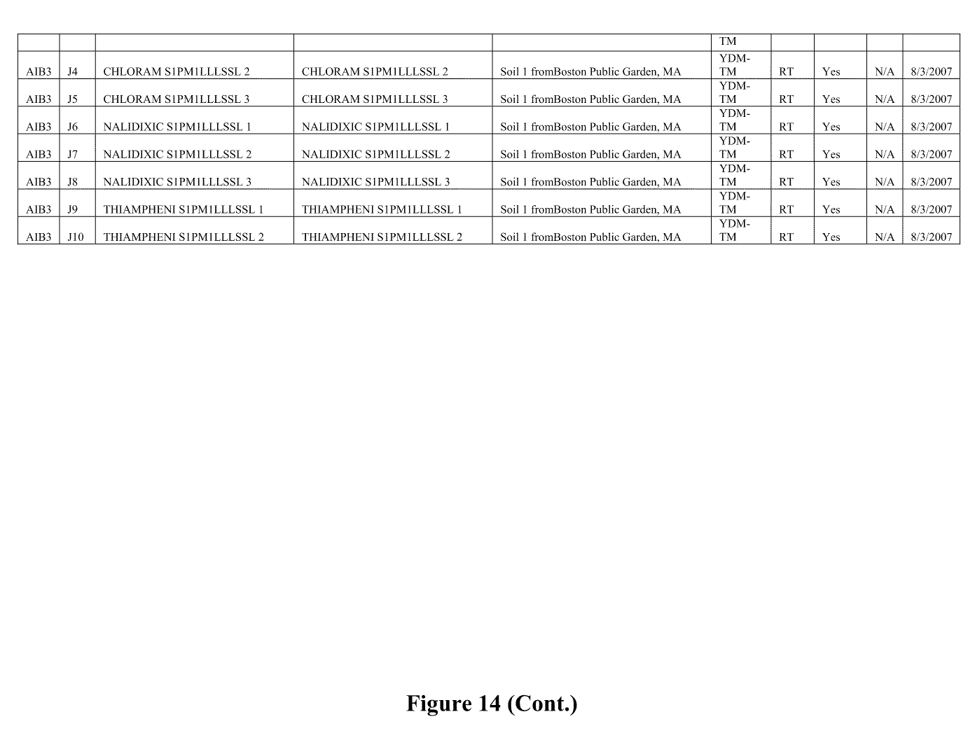

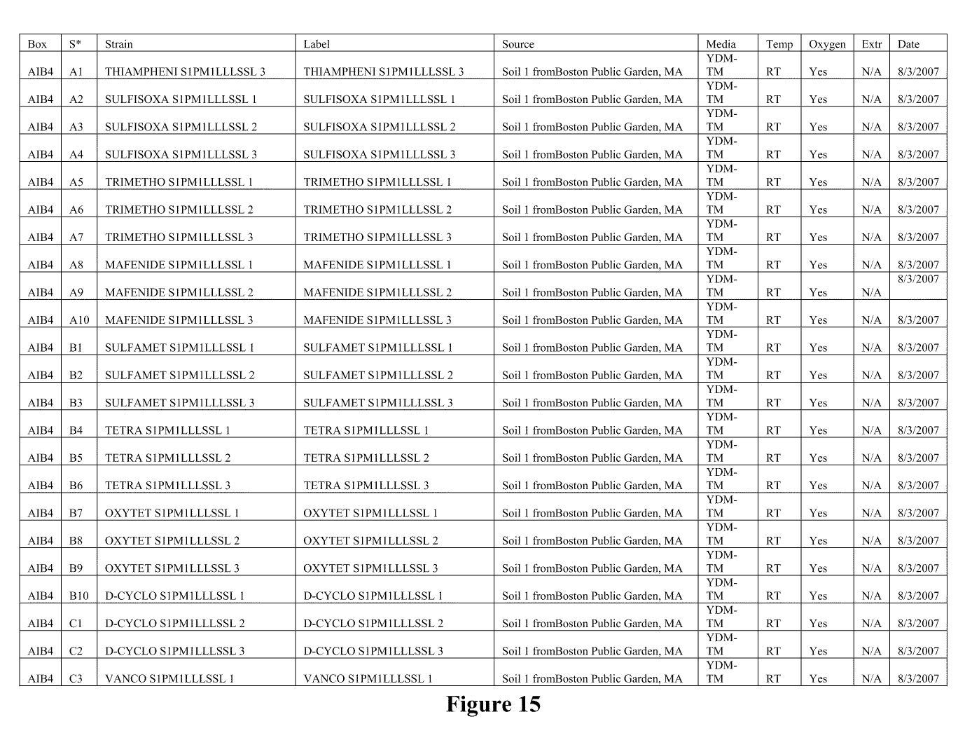

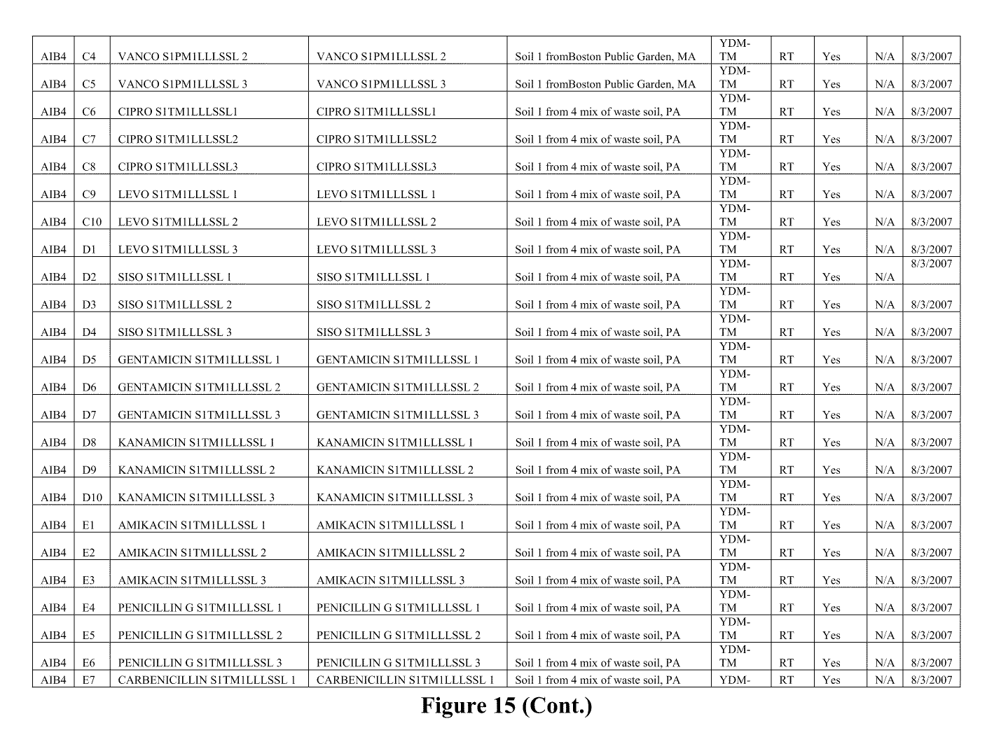

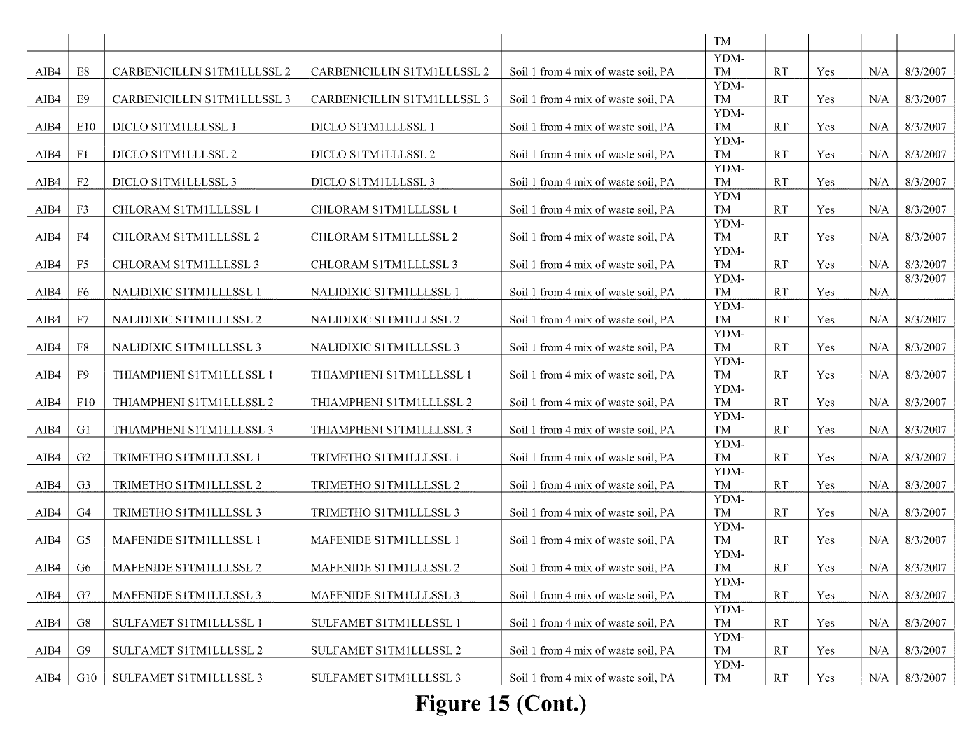

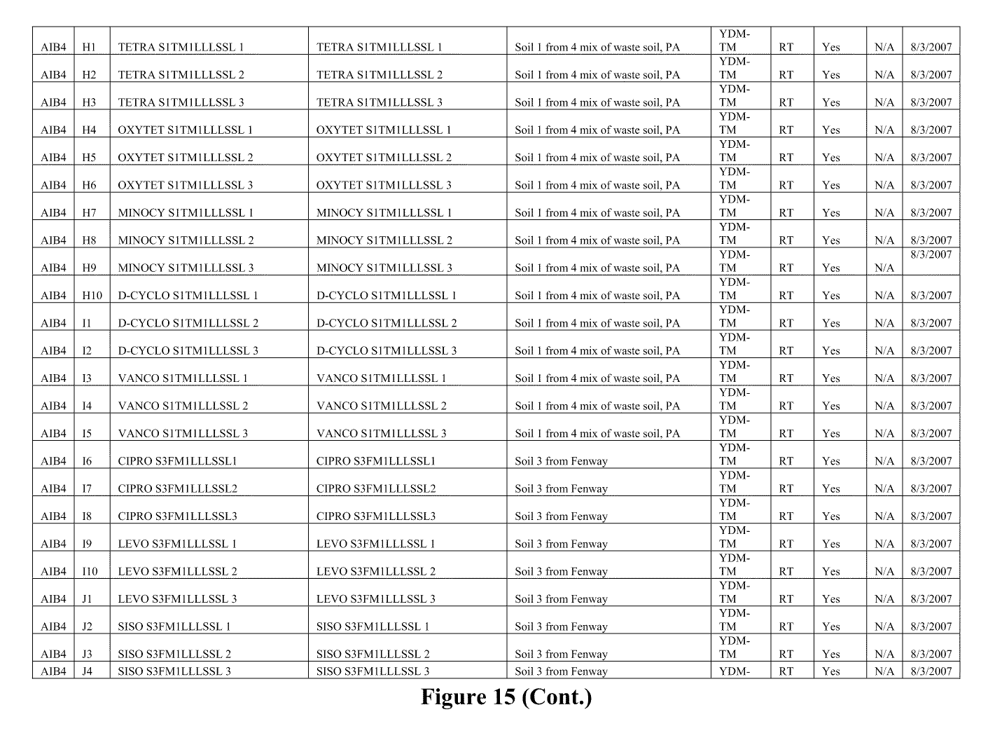

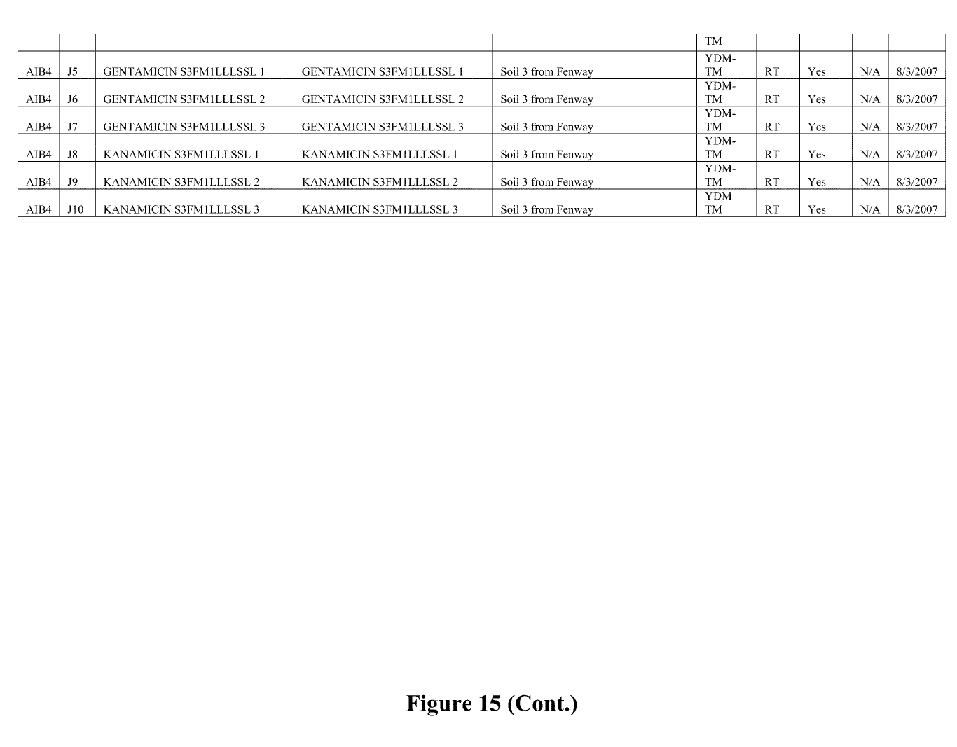

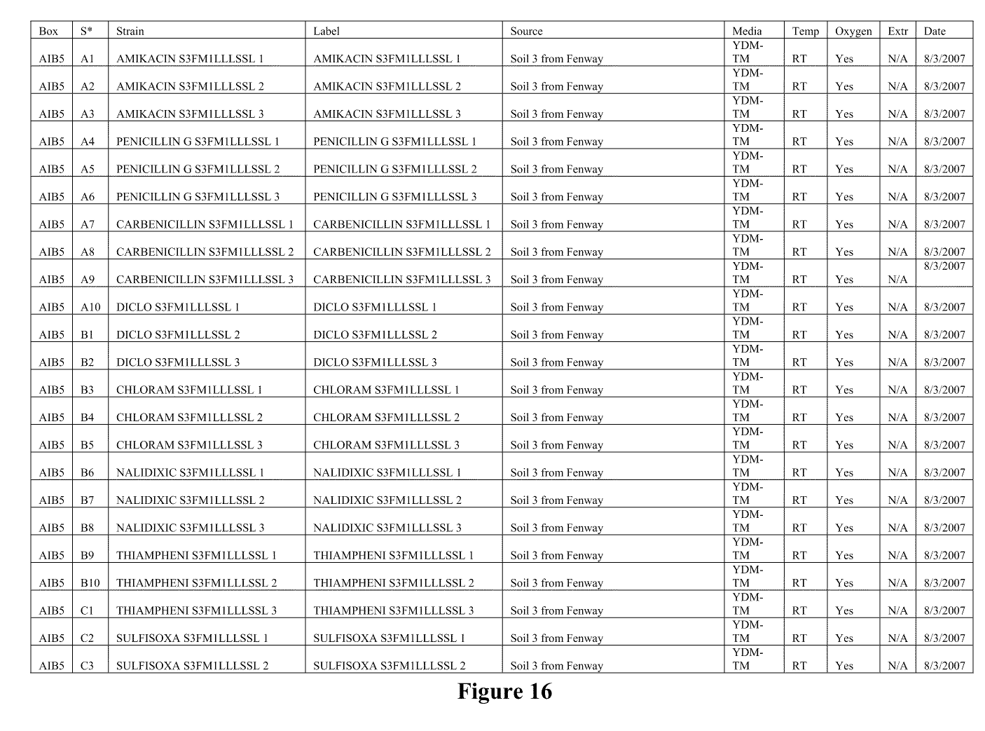

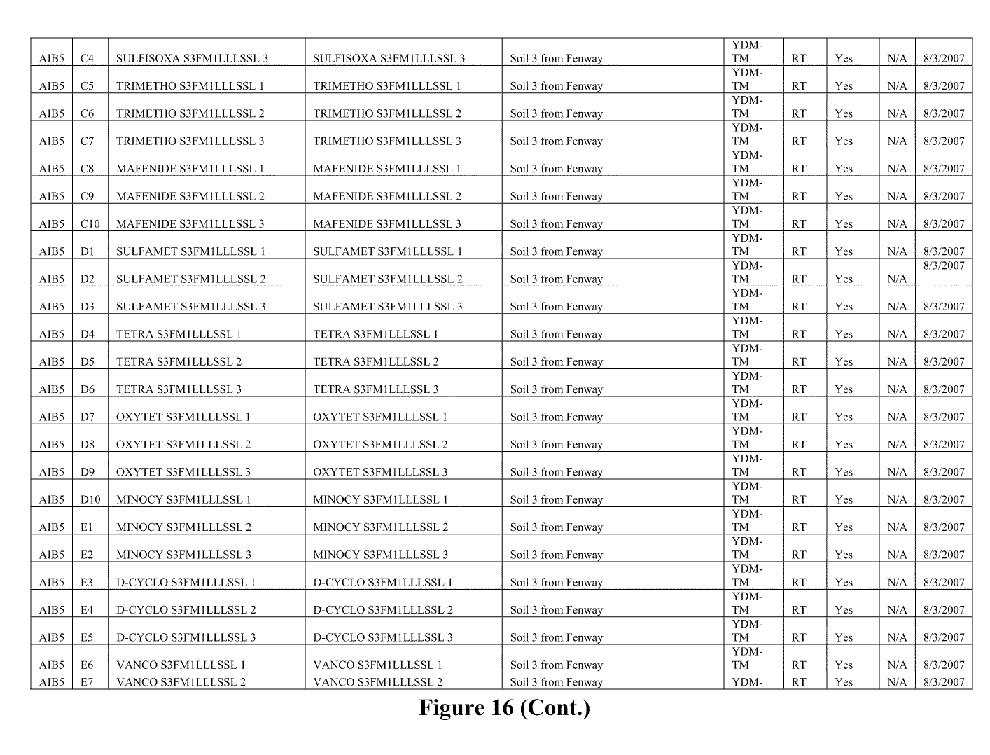

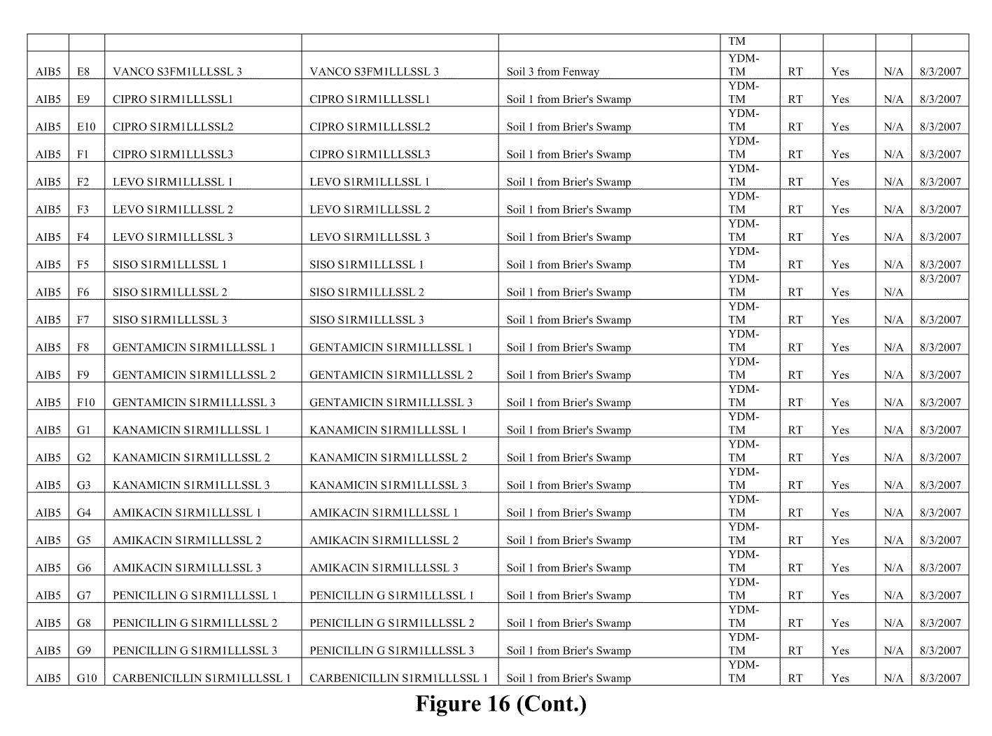

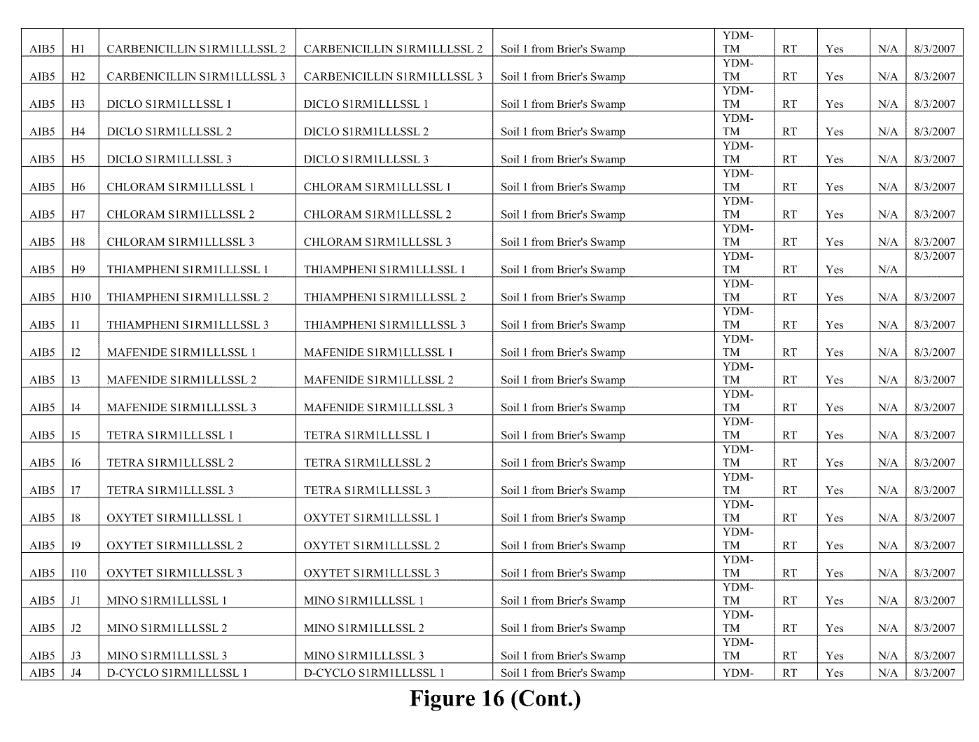

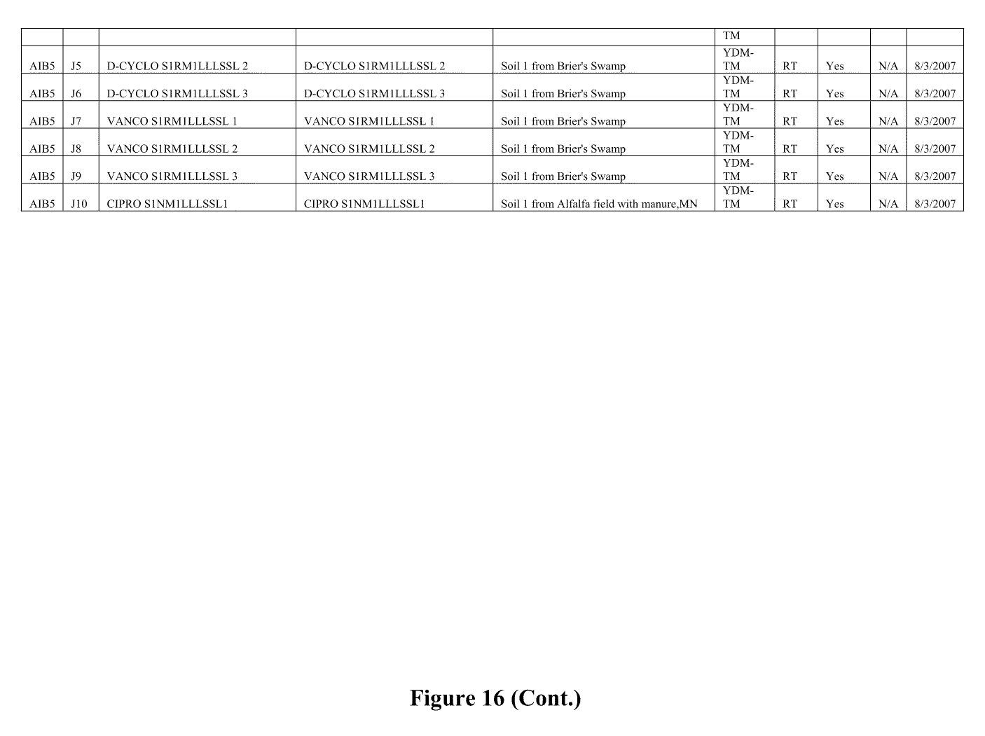

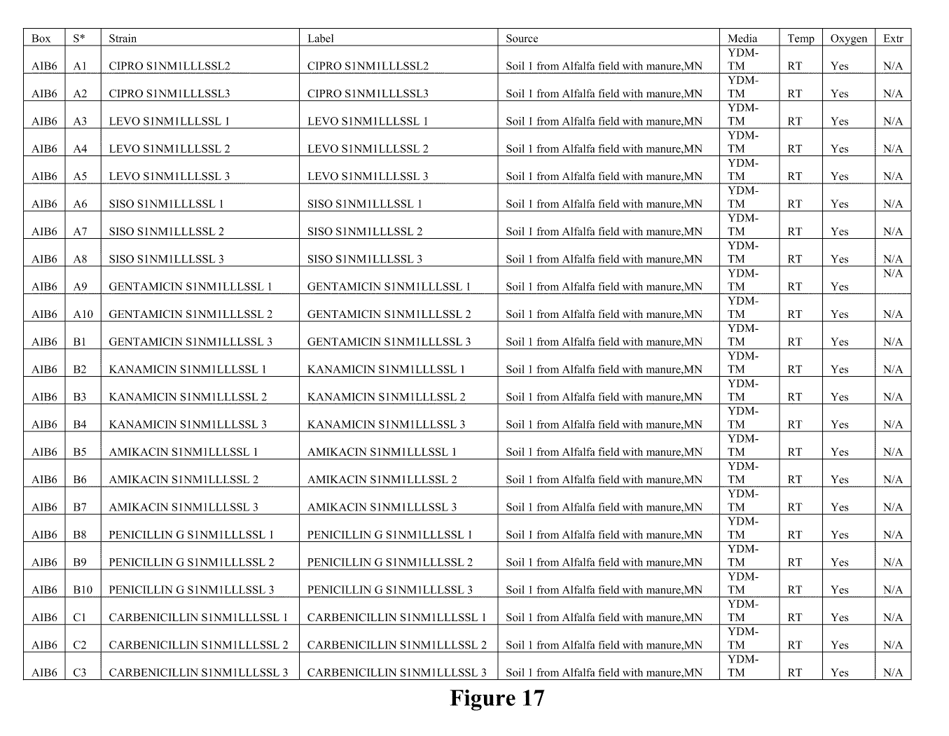

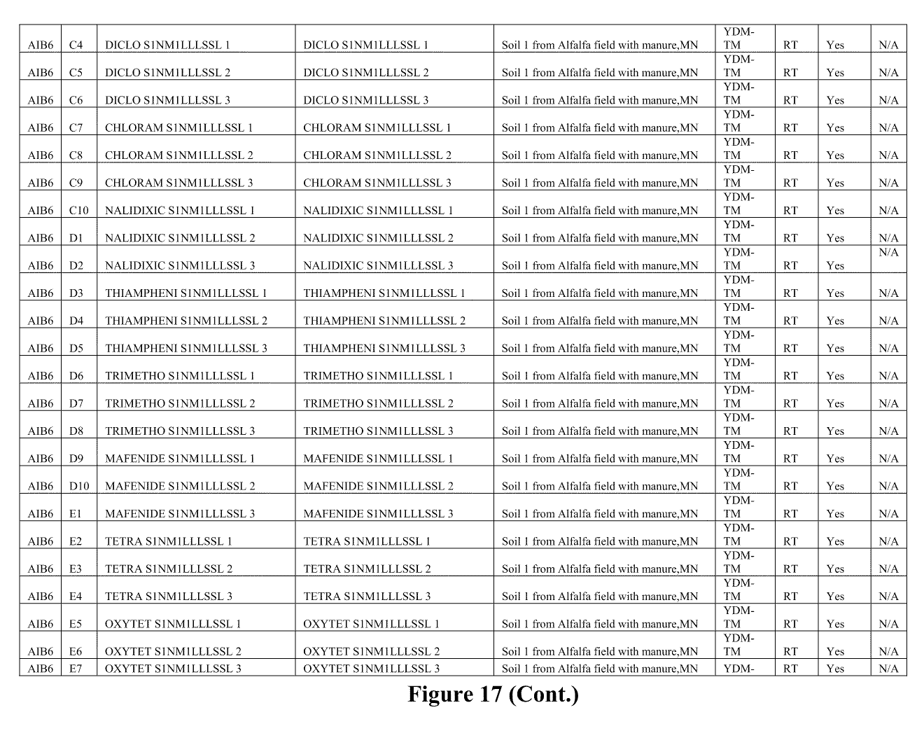

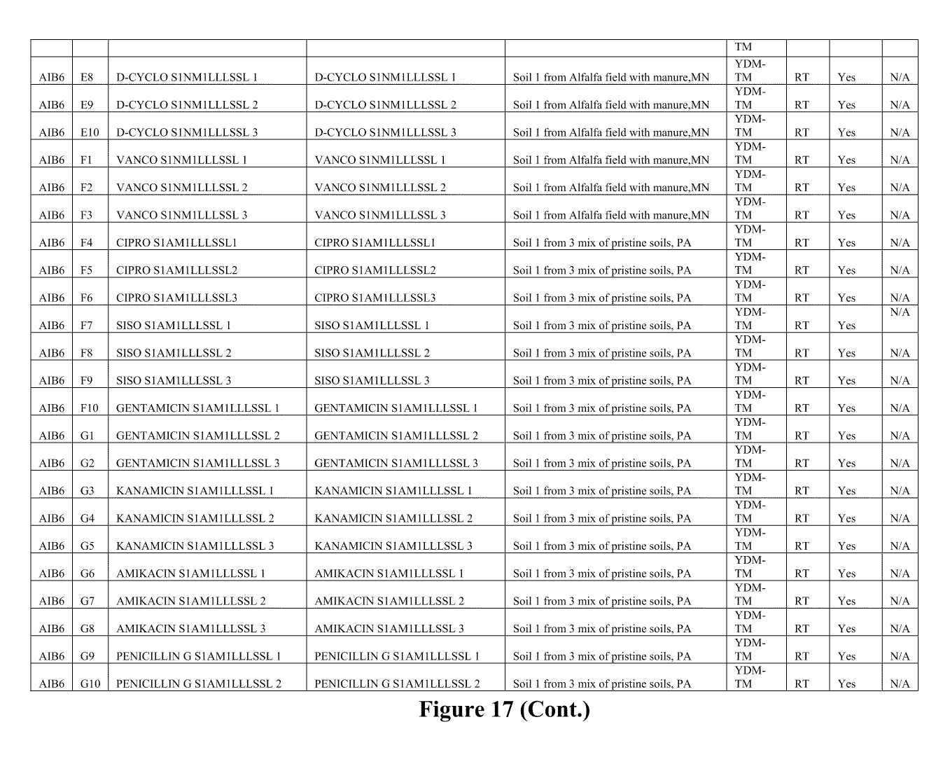

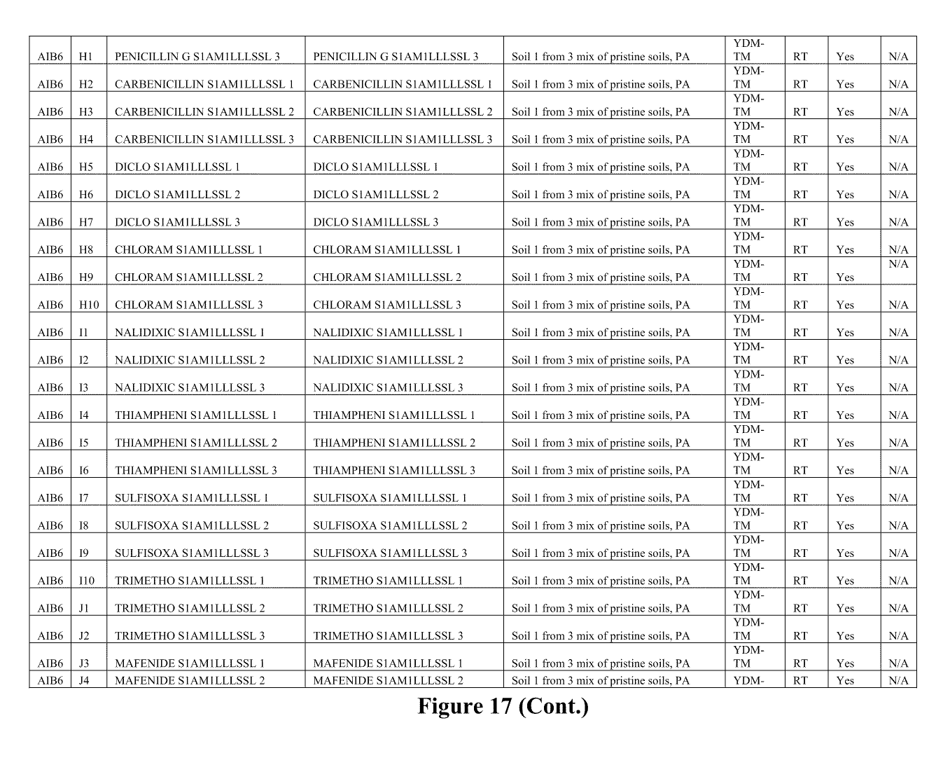

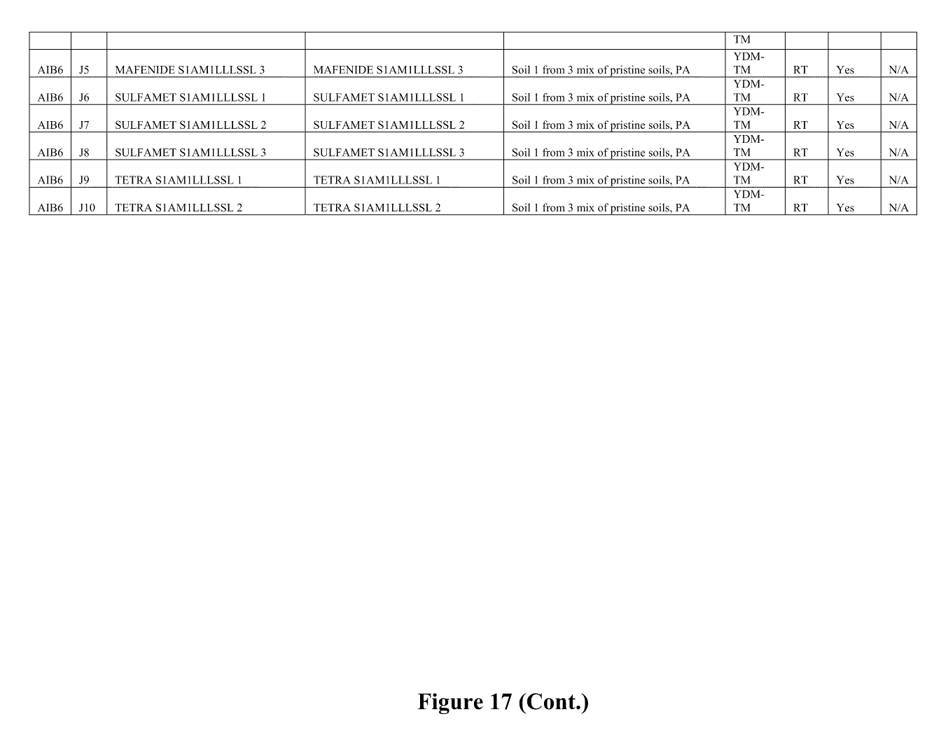

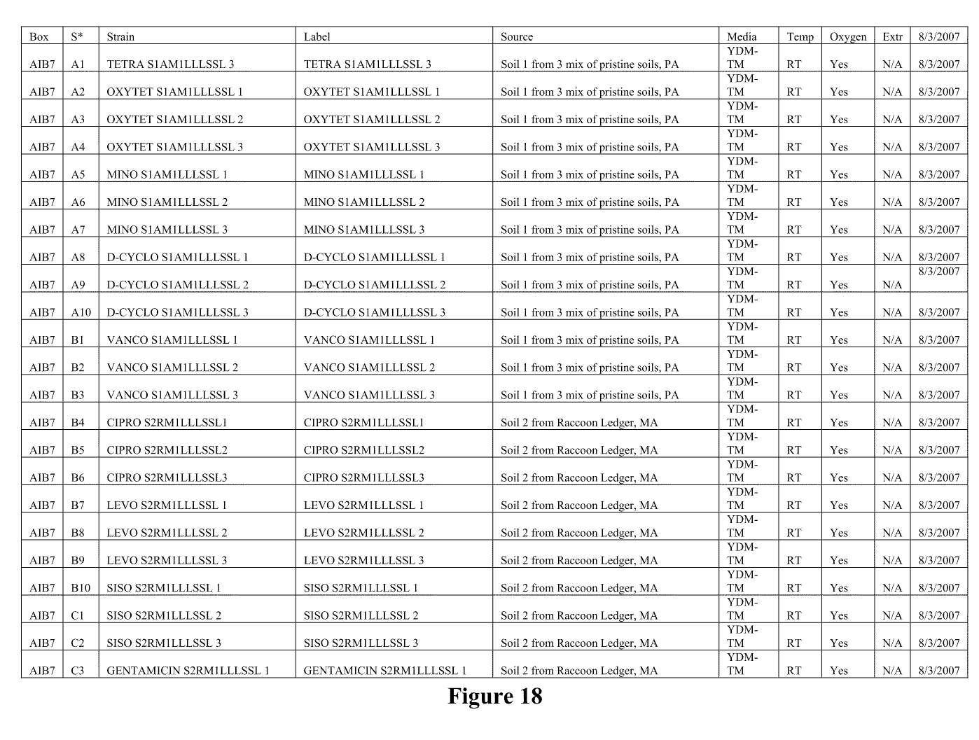

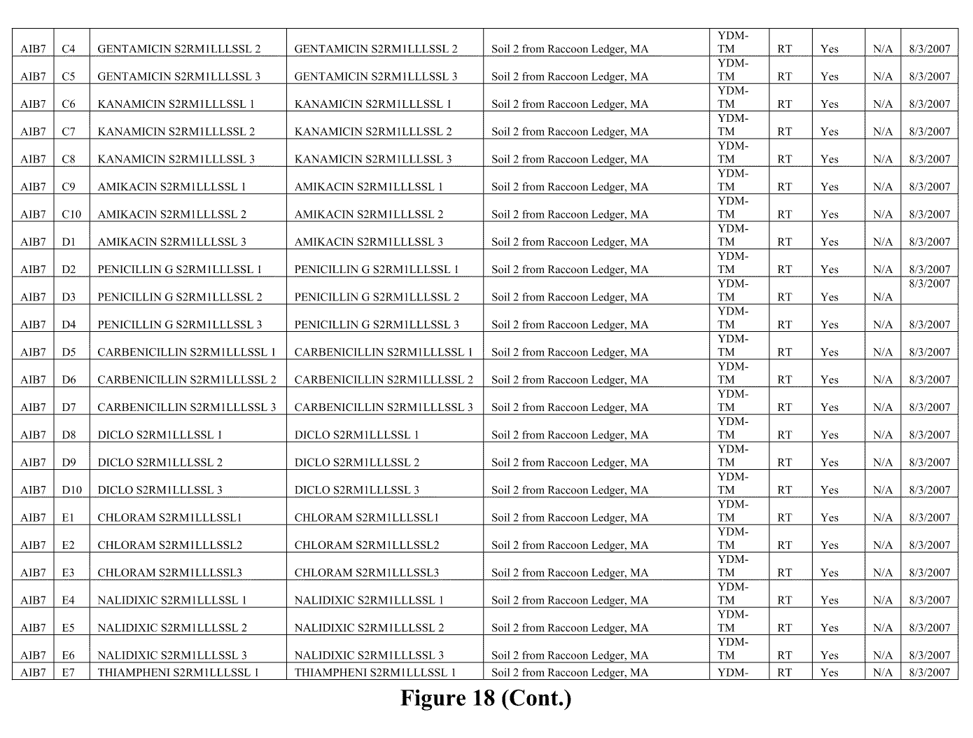

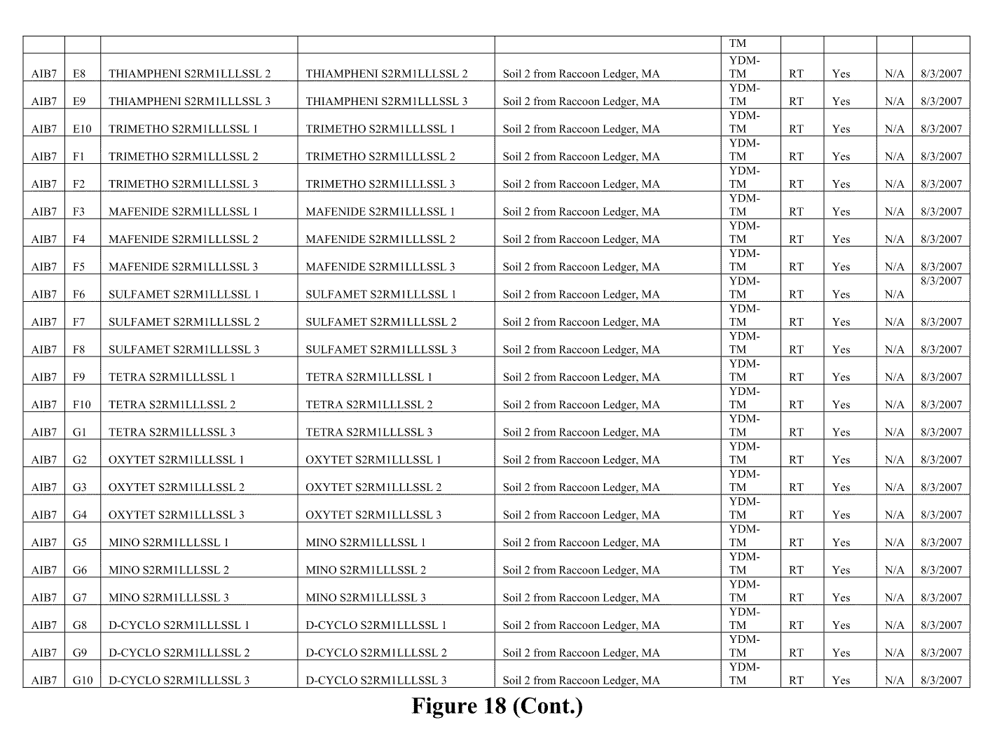

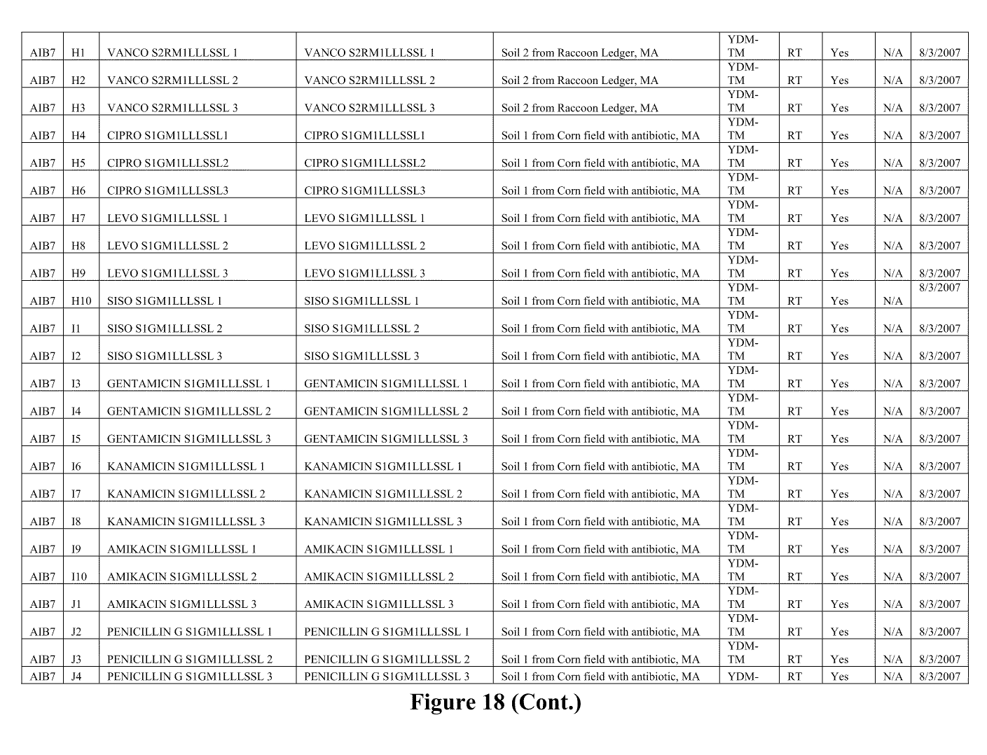

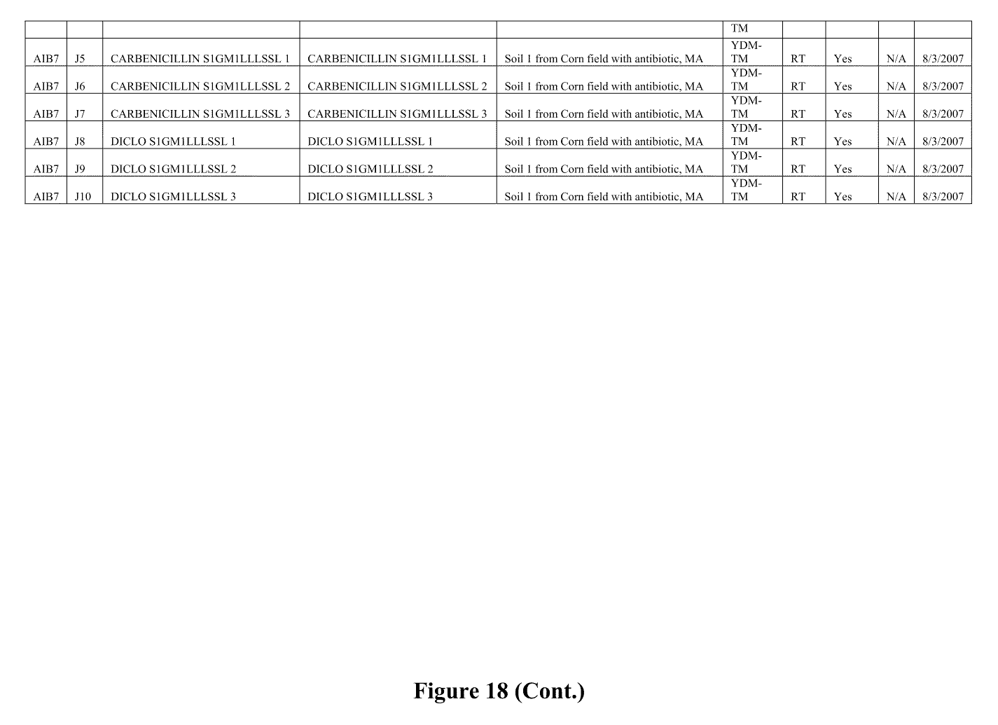

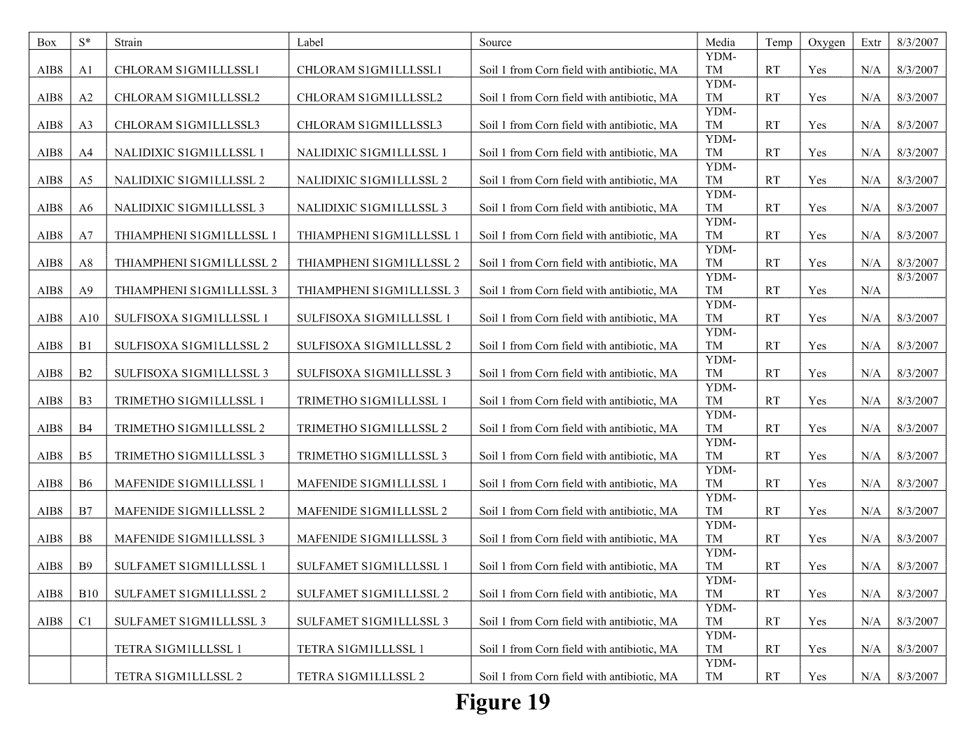

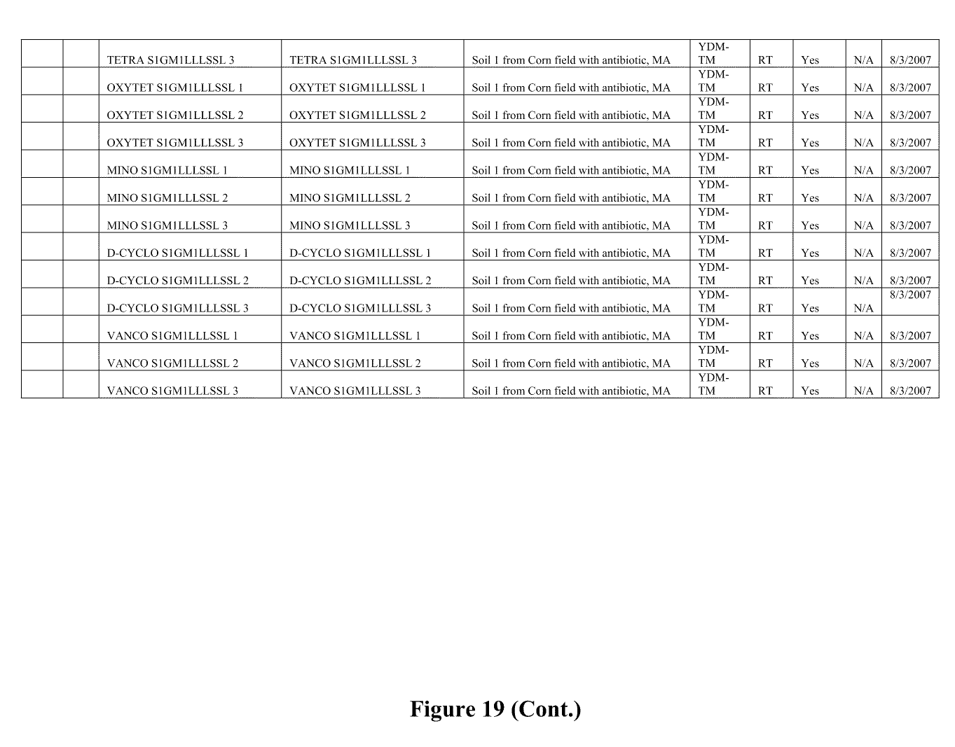

Clonal bacterial isolates were cultured from 11 diverse soils (Table 6, FIGS. 13-19) which were capable of utilizing one of 18 different antibiotics as the sole carbon source. The 18 antibiotics comprised of natural, semi-synthetic and synthetic compounds of different ages and included all major bacterial target classes. Every antibiotic tested was able to support bacterial growth (FIG. 7A and FIG. 10). Notably, 6 out of 18 antibiotics supported growth in all 11 soils, covering 5 of the 8 classes of antibiotics tested. Appropriate controls were performed to ensure that carbon source contamination of the source media or carbon fixation from the air were insignificant to this experiment.

TABLE 6
Lot purities of antibiotics used, as reported on Certificates
of Analysis from Sigma-Aldrich (NR = Not Reported).

| Antibiotics | Lot Purity % |
|---|---|
| Ciprofloxacin | 98.5 |
| Levofloxacin | 100.0 |
| Sisomicin | 99 |
| Gentamicin | NR |
| Kanamycin | NR |
| Amikacin | 100 |
| Penicillin G | 99.7 |
| Carbenicillin | 92.9 |
| Dicloxacillin | 99.8 |
| Chloramphenicol | >99 |
| Nalidixic acid | 100 |
| Thiamphenicol | >99 |
| Sulfisoxazole | 99.7 |
| Trimethoprim | 100 |
| Mafenide | 100 |
| Sulfamethizole | 99.9 |
| D-Cycloserine | 98 |
| Vancomycin | NR |

TABLE 8
Soil information for the 11 different soils from which bacteria
capable of subsisting on antibiotics were isolated.

| FIG. 7A | | Soil | |
|---|---|---|---|
| identifiers | Soil type | name | Soil collection location |
| F1 | Farmland | S1G | Corn Field with Antibiotic Treated |
| | | | Manure, Great Brook Farm, Carlisle, MA |
| F2 | Farmland | S1N | Alfalfa Field with Manure Treatment, |
| | | | Northcroft Farm, Pelican Rapids, MN |
| F3 | Farmland | S2N | Alfalfa Field without Manure Treatment, |
| | | | Northcroft Farm, Pelican Rapids, MN |
| P1 | Pristine | S2R | Raccoon Ledger, Rockport, MA |
| P2 | Pristine | S3N | Prairie next to Northcroft Farm, |
| | | | Pelican Rapids, MN |
| P3 | Pristine | S1R | Brier's Swamp, Rockport, MA |
| P4 | Pristine | S1A | Pristine Forest Soil, |
| | | | Alan Seeger Natural Area, PA |
| P5 | Pristine | S2T | Untreated Forested Area, |
| | | | Toftrees State Gameland Area, PA |
| U1 | Urban | S1T | Waste Water Treated Area, |
| | | | Toftrees State Gameland Area, PA |
| U2 | Urban | S3F | Boston Fens, MA |
| U3 | Urban | S1P | Boston Public Garden, MA |

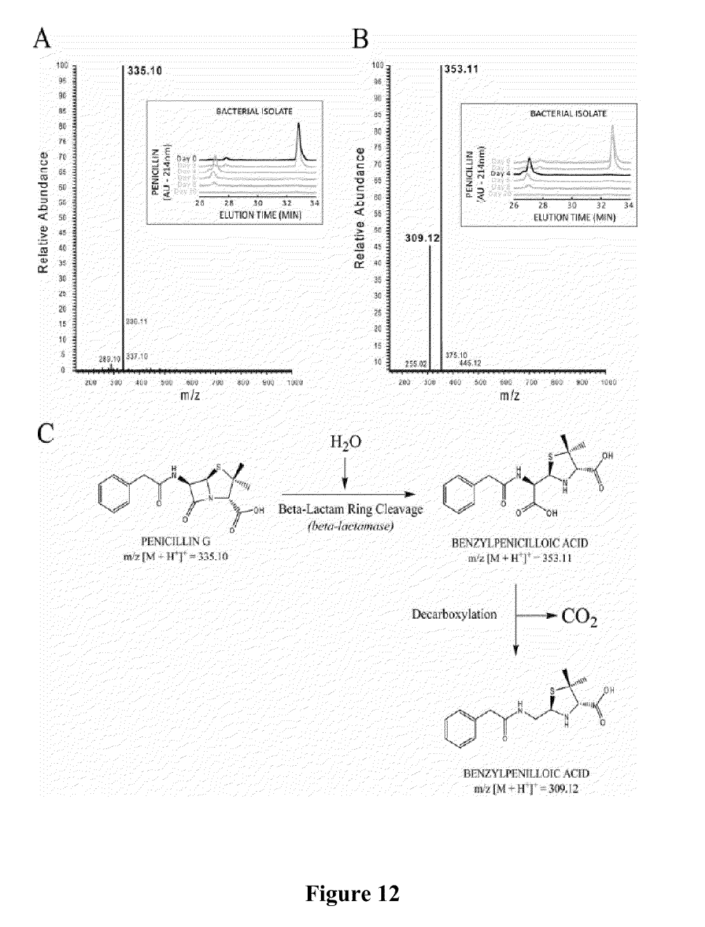

Clonal isolates capable of subsisting on penicillin and carbenicillin were obtained from all the soils tested, and isolates from 9 out of 11 soils that could subsist on dicloxacillin. Representative isolates capable of growth on penicillin and carbenicillin were selected for subsequent analysis by high performance liquid chromatography (HPLC). Removal of the antibiotics from the media was observed within 4 and 6 days, respectively (FIG. 7B). Mass spectrometry analysis of penicillin cultures is consistent with a penicillin catabolic pathway (J. Johnsen, Archives of Microbiology 115, 271 (1977)) initiated by hydrolytic cleavage of the beta lactam ring, which is the dominant mode of clinical resistance to penicillin and related beta lactam antibiotics, followed by a decarboxylation step (FIG. 12).

Bacteria were isolated from all the soils tested that grew on ciprofloxacin (FIG. 7A), a synthetic fluoroquinolone and one of the most widely prescribed antibiotics. Clonal isolates capable of catabolizing the other two synthetic quinolones tested, levofloxacin and nalidixic acid, were also isolated from a majority of the soils (FIG. 7A). Previous studies have highlighted the strong parallels between antibiotic resistance determinants harbored by soil dwelling microbes and human pathogens (J. Davies, Science 264, 375 (April, 1994); C. G. Marshall, I. A. D. Lessard, I. S. Park, G. D. Wright, Antimicrobial Agents and Chemotherapy 42, 2215 (September, 1998); V. M. D'Costa, E. Griffiths, G. D. Wright, Curr Opin Microbiol 10, 481 (October, 2007)). The lateral transfer of genes encoding the enzymatic machinery responsible for subsistence on quinolone antibiotics to human pathogens could introduce a novel resistance mechanism so far not observed in the clinic.

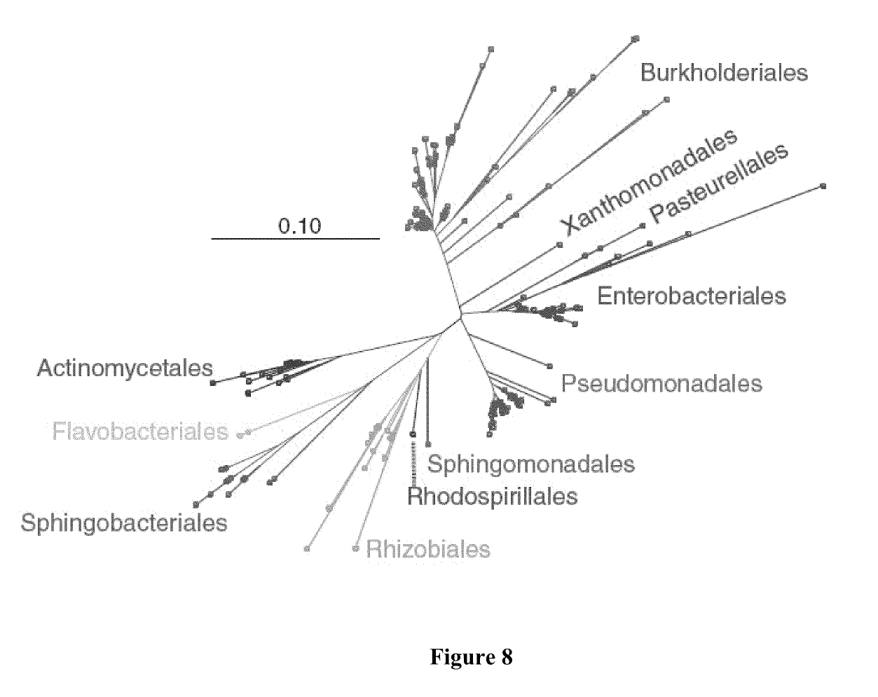

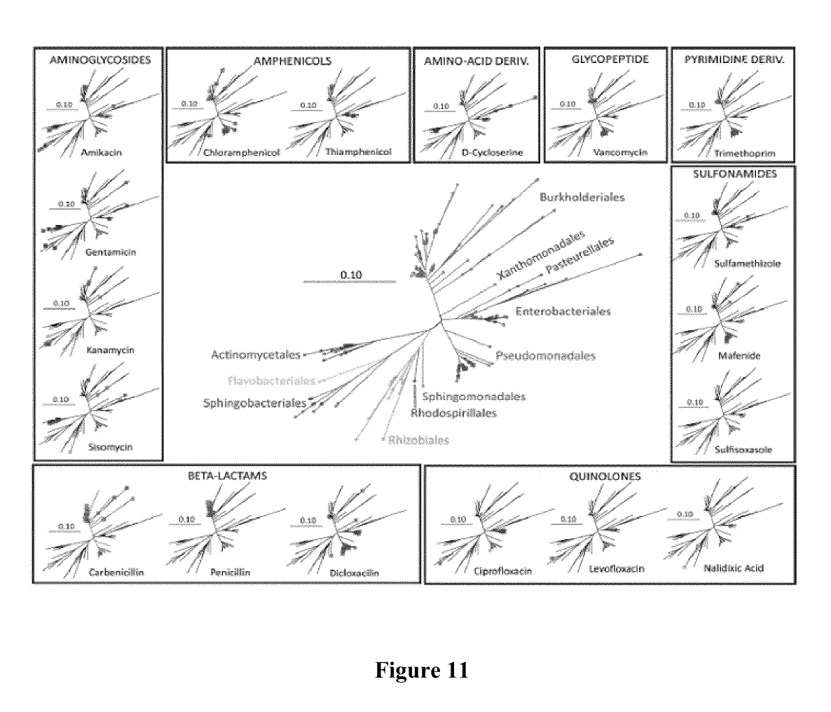

Phylogenetic profiling of the clonal isolates revealed a diverse set of species in Proteobacteria (87%), Actinobacteria (7%) and Bacteroidetes (6%) (FIG. 8 and FIG. 11). These phyla all include many clinically relevant pathogens. Of the eleven orders represented, Burkholderiales constitute 41% of the species isolated. The other major orders (>5%) are: Pseudomonadales (24%), Enterobacteriales (13%), Actinomycetales (7%), Rhizobiales (7%), and Sphingobacteriales (6%).

Without intending to be bound by scientific theory, one explanation for the widespread catabolism of both natural and synthetic antibiotics may relate to their organic sub-structures which are found in nature. Metabolic mechanisms exist for processing those sub-structures and may allow for the utilization of the parent synthetic antibiotic molecule. It is noteworthy that more than half of the bacterial isolates described in this example belong to the orders Burkholderiales and Pseudomonadales as organisms in these orders typically have large genomes of approximately 6-10 megabases (S. J. Projan, Antimicrobial Agents and Chemotherapy 51, 1133 (April, 2007)). These organisms can be thought of as scavengers, capable of utilizing a large variety of single carbon sources as food (J. L. Parke, D. Gurian-Sherman, Annual Review of Phytopathology 39, 225 (2001)).

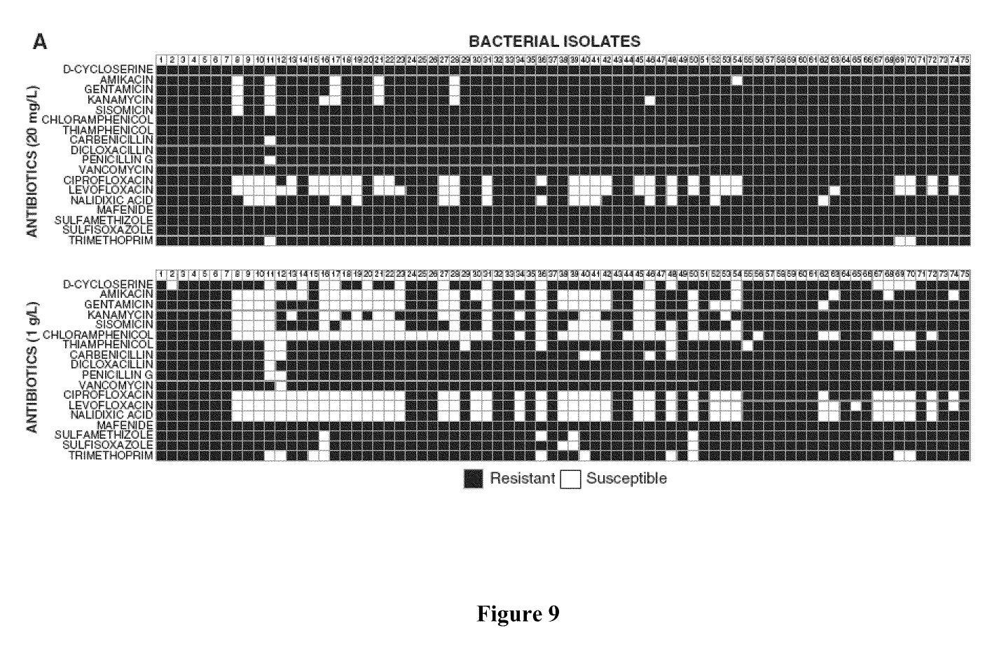

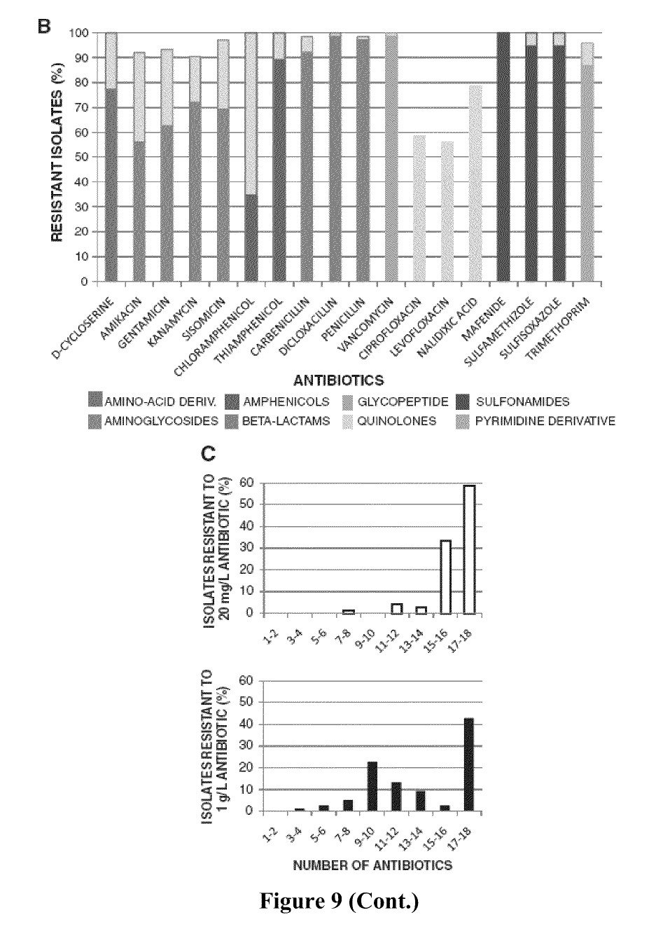

The magnitude of antibiotic resistance was determined for a representative subset of 75 clonal isolates (Table 7). Each clonal isolate was tested for resistance towards all 18 antibiotics used in the subsistence experiments at 20 mg/L and 1 g/L in rich media. The clonal isolates tested on average were resistant to 17 out of 18 antibiotics at 20 mg/L, and 14 out of 18 antibiotics at 1 g/L (FIG. 9). Furthermore, for 74 of the 75 isolates, it was determined that if a bacterial isolate was able to subsist on an antibiotic, it was also resistant to all antibiotics in that class at 20 mg/L.

TABLE 7
Strain information for the 75 clonal
isolates used for resistance profiles.

| FIG. 9A | | | |
|---|---|---|---|
| identifier | Strain name | Subsisting on | From soil |
| 1 | Levo-S2T-M1LLLSSL-2 | Levofloxacin | S2T |
| 2 | Kana-S2T-M1LLLSSL-3 | Kanamycin | S2T |
| 3 | Amik-S2T-M1LLLSSL-1 | Amikacin | S2T |
| 4 | Carb-S2T-M1LLLSSL-2 | Carbenicillin | S2T |
| 5 | Chlo-S2T-M1LLLSSL-2 | Chloramphenicol | S2T |
| 6 | Nali-S2T-M1LLLSSL-1 | Nalidixic acid | S2T |
| 7 | Thia-S2T-M1LLLSSL-2 | Thiamphenicol | S2T |
| 8 | Trim-S2T-M1LLLSSL-1 | Trimethoprim | S2T |
| 9 | Mafe-S2T-M1LLLSSL-3 | Mafenide | S2T |
| 10 | Cycl-S2T-M1LLLSSL-3 | D-Cycloserine | S2T |
| 11 | Vanc-S2T-M1LLLSSL-3 | Vancomycin | S2T |
| 12 | Siso-S2N-M1LLLSSL-1 | Sisomycin | S2N |
| 13 | Gent-S2N-M1LLLSSL-2 | Gentamycin | S2N |
| 14 | Kana-S2N-M1LLLSSL-2 | Kanamycin | S2N |
| 15 | Peni-S2N-M1LLLSSL-2 | Penicillin G | S2N |
| 16 | Dicl-S2N-M1LLLSSL-1 | Dicloxacillin | S2N |
| 17 | Trim-S2N-M1LLLSSL-1 | Trimethoprim | S2N |
| 18 | Vanc-S2N-M1LLLSSL-1 | Vancomycin | S2N |
| 19 | Dicl-S3N-M1LLLSSL-2 | Dicloxacillin | S3N |
| 20 | Thia-S3N-M1LLLSSL-3 | Thiamphenicol | S3N |
| 21 | Trim-S3N-M1LLLSSL-2 | Trimethoprim | S3N |
| 22 | Mafe-S3N-M1LLLSSL-2 | Mafenide | S3N |
| 23 | Vanc-S3N-M1LLLSSL-2 | Vancomycin | S3N |
| 24 | Cipr-S1P-M1LLLSSL-3 | Ciprofloxacin | S1P |
| 25 | Peni-S1P-M1LLLSSL-2 | Penicillin G | S1P |
| 26 | Chlo-S1P-M1LLLSSL-1 | Chloramphenicol | S1P |
| 27 | Thia-S1P-M1LLLSSL-1 | Thiamphenicol | S1P |
| 28 | Trim-S1P-M1LLLSSL-3 | Trimethoprim | S1P |
| 29 | Slfm-S1P-M1LLLSSL-2 | Sulfamethizole | S1P |
| 30 | Cycl-S1P-M1LLLSSL-1 | D-Cycloserine | S1P |
| 31 | Vanc-S1P-M1LLLSSL-3 | Vancomycin | S1P |
| 32 | Cipr-S1T-M1LLLSSL-2 | Ciprofloxacin | S1T |
| 33 | Levo-S1T-M1LLLSSL-1 | Levofloxacin | S1T |
| 34 | Siso-S1T-M1LLLSSL-1 | Sisomycin | S1T |
| 35 | Carb-S1T-M1LLLSSL-1 | Carbenicillin | S1T |
| 36 | Dicl-S1T-M1LLLSSL-1 | Dicloxacillin | S1T |
| 37 | Chlo-S1T-M1LLLSSL-1 | Chloramphenicol | S1T |
| 38 | Thia-S1T-M1LLLSSL-3 | Thiamphenicol | S1T |
| 39 | Trim-S1T-M1LLLSSL-2 | Trimethoprim | S1T |
| 40 | Mafe-S1T-M1LLLSSL-1 | Mafenide | S1T |
| 41 | Cycl-S1T-M1LLLSSL-2 | D-Cycloserine | S1T |
| 42 | Vanc-S1T-M1LLLSSL-1 | Vancomycin | S1T |
| 43 | Levo-S3F-M1LLLSSL-3 | Levofloxacin | S3F |
| 44 | Slfs-S3F-M1LLLSSL-3 | Sulfisoxazole | S3F |
| 45 | Trim-S3F-M1LLLSSL-l | Trimethoprim | S3F |
| 46 | Mafe-S3F-M1LLLSSL-3 | Mafenide | S3F |
| 47 | Slfm-S3F-M1LLLSSL-3 | Sulfamethizole | S3F |
| 48 | Vanc-S3F-M1LLLSSL-2 | Vancomycin | S3F |
| 49 | Amik-S1R-M1LLLSSL-3 | Amikacin | S1R |
| 50 | Peni-S1R-M1LLLSSL-2 | Penicillin G | S1R |
| 51 | Mafe-S1R-M1LLLSSL-2 | Mafenide | S1R |
| 52 | Vanc-S1R-M1LLLSSL-2 | Vancomycin | S1R |
| 53 | Trim-S1N-M1LLLSSL-1 | Trimethoprim | S1N |
| 54 | Vanc-S1N-M1LLLSSL-1 | Vancomycin | S1N |
| 55 | Kana-S1A-M1LLLSSL-2 | Kanamycin | S1A |
| 56 | Carb-S1A-M1LLLSSL-2 | Carbenicillin | S1A |
| 57 | Slfs-S1A-M1LLLSSL-1 | Sulfisoxazole | S1A |
| 58 | Vanc-S1A-M1LLLSSL-2 | Vancomycin | S1A |
| 59 | Kana-S2R-M1LLLSSL-2 | Kanamycin | S2R |
| 60 | Amik-S2R-M1LLLSSL-3 | Amikacin | S2R |
| 61 | Peni-S2R-M1LLLSSL-2 | Penicillin G | S2R |
| 62 | Dicl-S2R-M1LLLSSL-1 | Dicloxacillin | S2R |
| 63 | Mafe-S2R-M1LLLSSL-2 | Mafenide | S2R |
| 64 | Slfm-S2R-M1LLLSSL-1 | Sulfamethizole | S2R |
| 65 | Cipr-S1G-M1LLLSSL-1 | Ciprofloxacin | S1G |
| 66 | Levo-S1G-M1LLLSSL-1 | Levofloxacin | S1G |
| 67 | Gent-S1G-M1LLLSSL-3 | Gentamycin | S1G |
| 68 | Kana-S1G-M1LLLSSL-1 | Kanamycin | S1G |
| 69 | Peni-S1G-M1LLLSSL-1 | Penicillin G | S1G |
| 70 | Carb-S1G-M1LLLSSL-3 | Carbenicillin | S1G |
| 71 | Chlo-S1G-M1LLLSSL-3 | Chloramphenicol | S1G |
| 72 | Nali-S1G-M1LLLSSL-2 | Nalidixic acid | S1G |
| 73 | Thia-S1G-M1LLLSSL-1 | Thiamphenicol | S1G |
| 74 | Slfs-S1G-M1LLLSSL-3 | Sulfisoxazole | S1G |
| 75 | Mafe-S1G-M1LLLSSL-2 | Mafenide | S1G |

The data presented herein describing bacteria subsisting on antibiotics is a substantial addition to the antibiotic resistome in terms of both phylogenetic diversity and prevalence of resistance. The isolated bacteria described herein are ‘super resistant,’ since they tolerate concentrations of antibiotics >1 g/L, which are 50-fold higher than the antibiotic concentrations used to define the antibiotic resistome (V. M. D'Costa, K. M. McGrann, D. W. Hughes, G. D. Wright, Science 311, 374 (January, 2006)).

Greengenes (T. Z. DeSantis et al., Applied and Environmental Microbiology 72, 5069 (July, 2006)) identified isolates among the bacteria subsisting on antibiotics that are closely related to known pathogens e.g., members of the Burkholderia cepacia complex, and Serratia marcescens. In principle, relatedness allows for easier transfer of genetic material, since codon usage, promoter binding sites and other transcriptional and translational motifs are likely to be similar. Without intending to be bound by scientific theory, it is therefore possible that pathogenic microbes can more readily use resistance genes originating from bacteria subsisting on antibiotics compared to the resistance genes from more distantly related antibiotic producer organisms.

To date, there have been no reports describing antibiotic catabolism in pathogenic strains. However, since most sites of serious infection in the human body are not carbon source limited it is unlikely that pathogenic microbes would have a strong selective advantage by catabolizing antibiotics compared to just resisting them, without intending to be bound by scientific theory, it is likely that only the resistance conferring part of the catabolic machinery would be selected for in pathogenic strains.

In addition to the finding that bacteria subsisting on natural and synthetic antibiotics are widely distributed in the environment, these results highlight an unrecognized reservoir of multiple antibiotic resistance machinery. Bacteria subsisting on antibiotics are phylogenetically diverse, and include many organisms closely related to clinically relevant pathogens. Accordingly, pathogens could obtain antibiotic resistance genes from environmentally distributed ‘super resistant’ microbes subsisting on antibiotics.

### Example IV

### Materials and Methods for Example III

Growth Media

All liquid media used for isolating bacteria capable of subsisting on antibiotics was made by dissolving 1 g/L of the relevant antibiotics (Table 6) into Single Carbon Source (SCS) media containing 5 g (NH₄)₂SO₄, 3 g KH₂PO₄, 0.5 g MgSO₄.7H₂O, 15 mg EDTA, 4.5 mg ZnSO₄.7H₂O, 4.5 mg CaCl₂.2H₂O, 3 mg FeSO₄.7H₂O, 1 mg MnCl₂.4H₂O, 1 mg H₃BO₃, 0.4 mg Na₂MoO₄.2H₂O, 0.3 mg CuSO₄.5H₂O, 0.3 mg CoCl₂.6H₂0 and 0.1 mg KI per liter water. The pH was adjusted to 5.5 using HCl, and the media was sterilized through a 0.22 μm filter. Solid medium was prepared by adding 15 g agar per liter of liquid SCS media followed by autoclaving before adding antibiotics.

All liquid media used for resistance profiling was made by dissolving 20 mg/L or 1 g/L of the relevant antibiotics into autoclaved Luria Broth containing 5 g Yeast Extract, 10 g NaCl and 10 g of Tryptone in 1 Liter of water. The pH was adjusted to 5.5 using HCl, and the media was sterilized through a 0.22 μm filter.

Culturing of Environmental Bacteria Capable of Subsisting on Antibiotics

Initial soil microbial inocula (soil description in Table 8) were prepared in minimal medium containing no carbon, and inoculated into SCS-antibiotic media (corresponding to approximately 125 mg of dissolved soil in 5 mL of media). To significantly reduce the transfer of residual alternative carbon sources present in original inocula, samples were passaged (2.5 uL) into fresh SCS-antibiotic media (5 mL) two additional times after 7 days of growth, resulting in a 5×10⁴ dilution at each passage (resulting in a final carryover of approximately 30 ng of soil in 5 mL of media at the third passage). Clonal isolates from the liquid cultures were obtained by plating cultures out on SCS-antibiotic agar medium and resulting single colonies were picked and re-streaked on corresponding plates. Three colonies each were then inoculated into fresh SCS-antibiotic liquid media (5 mL) to confirm clonal phenotype. Final culture growth was recorded after 1 month incubation without shaking at 22° C. and cultures with at least 10⁸ cells/mL were assayed as positive growth.

Since inoculation in media lacking a carbon source (no carbon control) did not show growth in any cases, carbon source contamination of the source media or carbon fixation from the air were considered insignificant to this experiment. The only other alternative carbon substrate for growth could be impurities in the antibiotic stocks. All antibiotics used were purchased from Sigma-Aldrich at the highest purities available—lot purities of each compound used are listed in Table 6. Without intending to be bound by scientific theory, based on an average carbon mass of 0.15×10⁻¹² g per bacterial cell, it is estimated that at least 15 μg of carbon must be incorporated into bacterial biomass to reach sufficient culture densities in 1 mL of culture to be rated as successful growth. Assuming 50% carbon content of impurities, and under the most stringent assumptions of (1) 100% incorporation of carbon impurities into biomass, and (2) no loss of carbon as metabolic byproducts (such as CO₂), antibiotics with greater than 97% purity would have insufficient impurities to support sole carbon source growth. Of the antibiotic lots used in this experiment (Table 6), twelve compound stocks are at least 99% pure, two compounds (ciprofloxacin and D-cycloserine) have between 98 and 98.5% purity, one compound (carbenicillin) is 92.9% pure, and no purity information is available for three compounds (kanamycin, gentamicin, and vancomycin).

Phylogenetic Profiling

The 16S ribosomal DNA (rDNA) of each of the clonal isolates identified in this study was amplified using universal bacterial 16S primers:

| | |
|---|---|
| >Bact_63f_62C | |
| 5′-CAG GCC TAA CAC ATG CAA GTC-3′ | (SEQ ID NO: 1) |
| >Bact_1389r_63C | |
| 5′-ACG GGC GGT GTG TAC AAG-3′ | (SEQ ID NO: 2) |

Successful 16S rDNA amplicons were sequenced for phylogenetic profiling. High-quality, non-chimeric sequences were classified using Greengenes (DeSantis et al. (2006) Nucleic Acids Res. 34:W394; DeSantis et al. (2006) Applied and Environmental Microbiology 72:5069), with consensus annotations from RDP (Cole et al. (2007) Nucleic Acids Res. 35:D169) and NCBI taxonomies (Wheeler et al. (2000) Nucleic Acids Res. 28:10). Phylogenetic trees were constructed using the neighbor-joining algorithm in ARB (Ludwig et al. (2004) Nucleic Acids Res. 32:1363) using the Greengenes aligned 16S rDNA database. Placement in the tree was confirmed by comparing automated Greengenes taxonomy to the annotated taxonomies of nearest neighbors of each sequence in the aligned database.

Resistance Profiling of 75 Representative Isolates Capable of Subsisting on Antibiotics

75 clonal isolates (Table 7) were selected to include multiple isolates capable of subsisting on each of the 18 antibiotics and originating from each of the 11 soils (Table 8). Bacterial cultures were inoculated into Luria Broth from frozen glycerol stocks and were incubated at 22° C. for 3 days. 500 nL of this culture was used to inoculate each of the clonal isolates into 200 μL of Luria Broth containing one of the eighteen different antibiotics (See Table 6) at 20 mg/L and 1 g/L. Cultures were incubated without shaking at 22° C. for 4 days. Resistance of an isolate was determined by turbidity at 600 nm using a Versamax microplate reader from Molecular Devices.

Analysis of Antibiotic Removal of Penicillin and Carbenicillin Subsisting Bacteria

Representative isolates capable of growth on penicillin and carbenicillin as sole carbon source were selected for analysis of antibiotic removal from the growth media by high performance liquid chromatography (HPLC). 2 μL of these cultures were re-inoculated into fresh SCS-antibiotic medium (5 mL) and allowed to grow for 28 days. Samples of the cultures and un-inoculated media controls were taken at regular intervals throughout the 28 day period and the catabolism of penicillin and carbenicillin was monitored at 214 nm by HPLC of filtered media from samples using a Hewlett Packard 1090 Liquid Chromatograph and a Vydac C-18 column. HPLC was performed at a flow rate of 0.3 mL/min with an acetonitrile gradient going from 5% to 65% in 30 minutes in the presence of 0.1% trifluoroacetic acid.

The HPLC chromatogram of the penicillin catabolizing culture medium (FIG. 7B) started out with a single peak corresponding to the penicillin peak of the un-inoculated control. This peak disappeared at day 4 with the appearance of multiple smaller peaks at lower elution times; by day 20 these peaks had also disappeared in agreement with the complete catabolism of penicillin by the culture in 20 days. In comparison, the single penicillin peak in the un-inoculated control remained the dominant peak over the same time course. The HPLC chromatogram of the medium from the carbenicillin catabolizing culture (FIG. 7B) started out with a bimodal peak corresponding to the un-inoculated carbenicillin control, which remained stable for 2 days. At day 4, corresponding to the appearance of visible turbidity in the inoculated culture, the bimodal peak had almost disappeared and secondary peaks at lower elution times were observed. These secondary peaks almost completely disappeared by the 28^{th} day, suggesting that carbenicillin was almost completely catabolized within 28 days. The bimodal carbenicillin peak remained relatively unchanged in the un-inoculated control over the same time course.

Samples from the penicillin subsisting culture from day 0 and day 4 were prepared for LC/MS using a Waters Sep-Pak Cartridge prior to mass spectrometry analysis using a LTQ-FT from Thermo Electron. Mass spectra were analyzed using XCalibur 2.0.5 and the empirically determined m/z values of all major peaks were compared to predicted m/z values of putative penicillin degradation products calculated using ChemDraw Ultra 9.0 (FIG. 12).

### Example V

### The Human-Associated Microbiome is a Mobilizable Reservoir of Antibiotic Resistance

The increasing levels of multi-drug resistance in human pathogenic bacteria are compromising humankind's ability to treat infectious disease (Walsh, C. Molecular mechanisms that confer antibacterial drug resistance. Nature 406 (6797), 775-781 (2000); Alekshun, M. N. & Levy, S. B. Molecular mechanisms of antibacterial multidrug resistance. Cell 128 (6), 1037-1050 (2007)). Since antibiotic resistance determinants, often encoded on mobilizable elements, can be readily transferred between bacteria (Courvalin, P. Transfer of antibiotic resistance genes between gram-positive and gram-negative bacteria. Antimicrob Agents Chemother 38 (7), 1447-1451 (1994)), there is an increasing interest in elucidating reservoirs of antibiotic resistance that may be accessible to clinically relevant pathogens (D'Costa, V. M., McGrann, K. M., Hughes, D. W., & Wright, G. D. Sampling the antibiotic resistome. Science 311 (5759), 374-377 (2006); Dantas, G., Sommer, M. O. A., Oluwasegun, R. D., & Church, G. M. Bacteria Subsisting on Antibiotics. Science 320 (5872), 100-103 (2008)). Perhaps the reservoir of microbial genes most relevant to human pathogens is that harbored within the human-associated microbiome (Gill, S. R. et al. Metagenomic analysis of the human distal gut microbiome. Science 312 (5778), 1355-1359 (2006); Dethlefsen, L., McFall-Ngai, M., & Relman, D. A. An ecological and evolutionary perspective on human-microbe mutualism and disease. Nature 449 (7164), 811-818 (2007); Ley, R. E., Peterson, D. A., & Gordon, J. I. Ecological and evolutionary forces shaping microbial diversity in the human intestine. Cell 124 (4), 837-848 (2006)). This microbial community is believed to significantly impact human health, including beneficial roles in dietary processing and prevention of pathogen intrusion (Eckburg, P. B. et al. Diversity of the human intestinal microbial flora. Science 308 (5728), 1635-1638 (2005); Jia, W., Li, H., Zhao, L., & Nicholson, J. K. Gut microbiota: a potential new territory for drug targeting. Nat Rev Drug Discov 7 (2), 123-129 (2008)). Given the widespread use of antibiotics in human medicine and agriculture, the human microbiome has likely undergone substantial responsive changes to this exposure. This examples shows that cultured isolates from oral and gut human-associated microbiomes from healthy individuals are resistant on average to 11 out of 18 antibiotics tested. The microbiomic resistance reservoirs are relatively stable over a period of 4 months, but have the capacity to undergo substantial change in absence of antibiotic therapy. Furthermore, exchange of antibiotic resistance determinants was demonstrated in and out of the human-associated microbiome. These results show that the human-associated microbiome of healthy individuals constitutes a dynamic and mobilizable reservoir of antibiotic resistance determinants, highlighting the accessibility of this reservoir to otherwise susceptible bacteria including human pathogens.

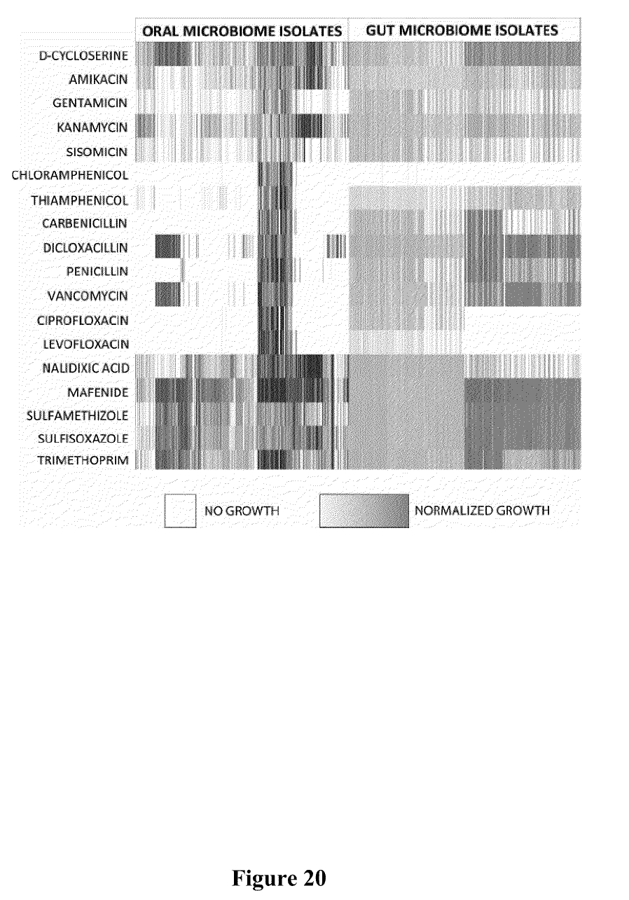

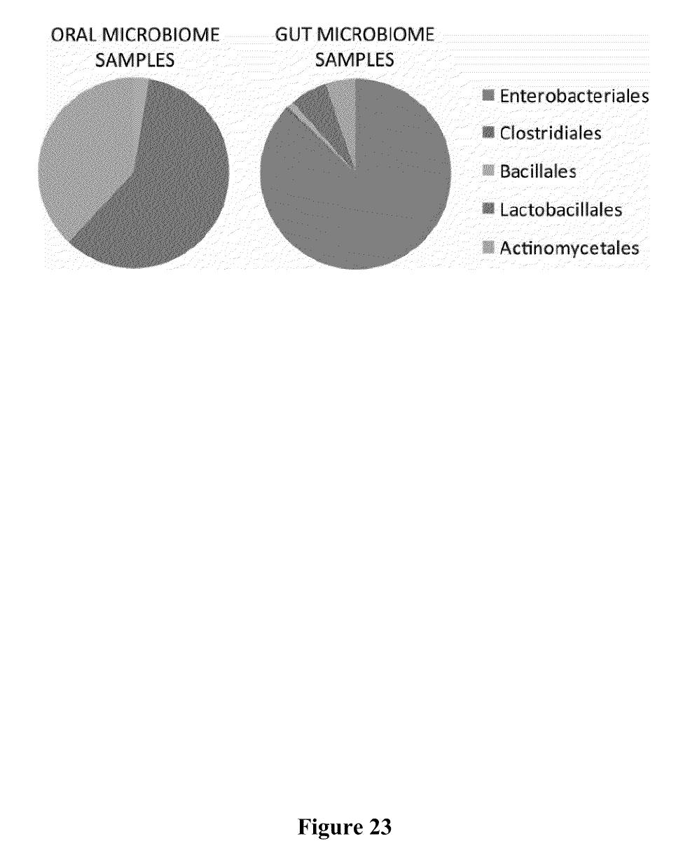

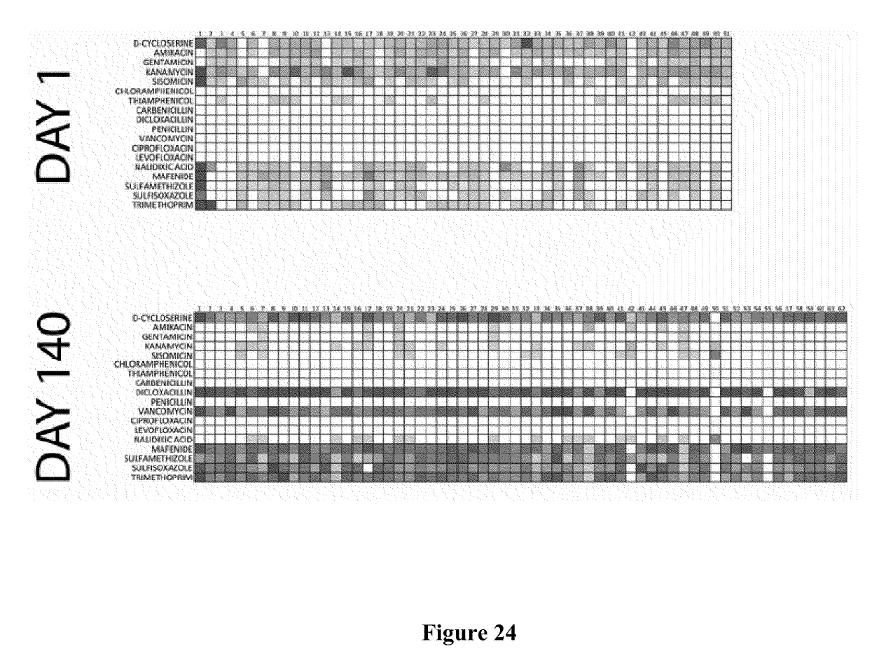

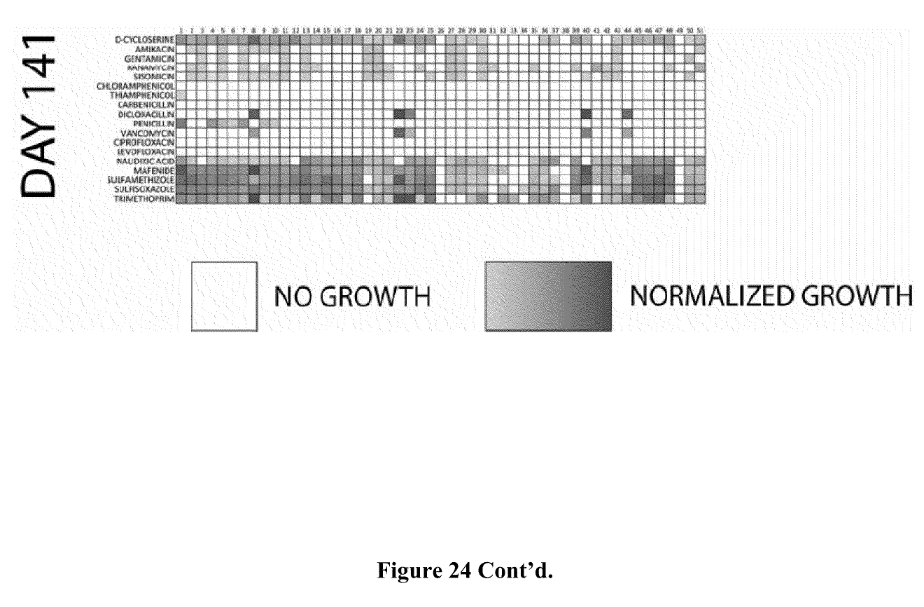

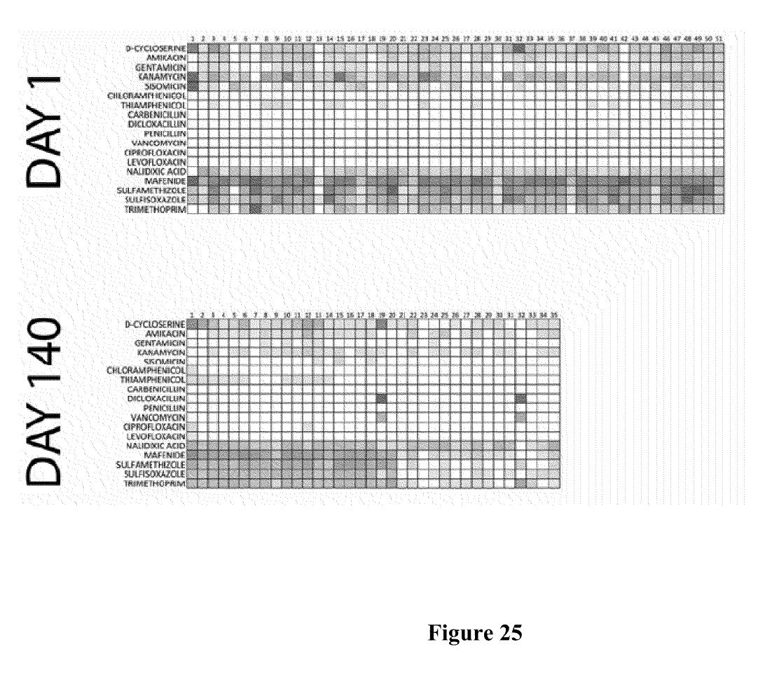

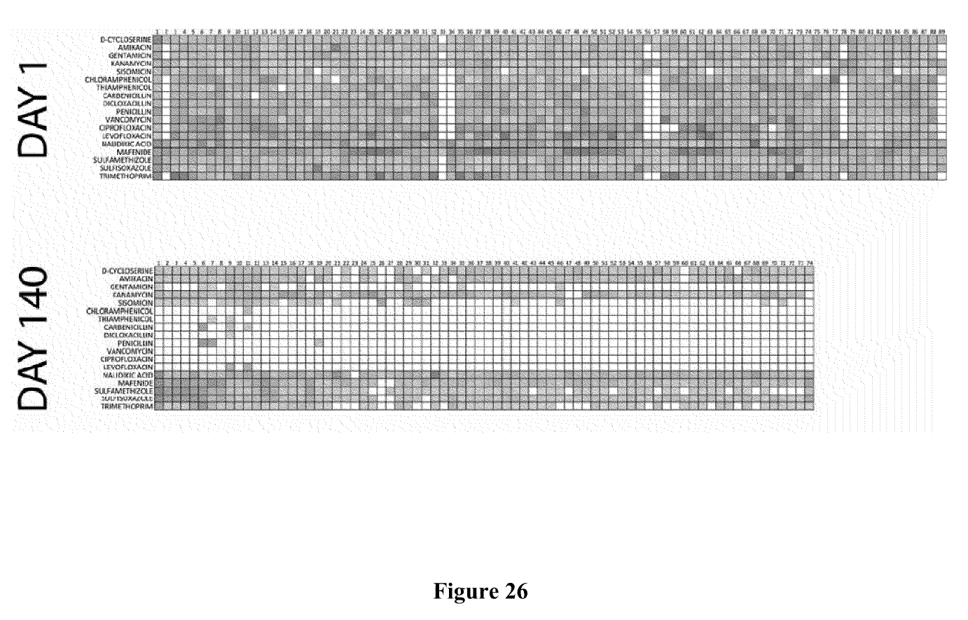

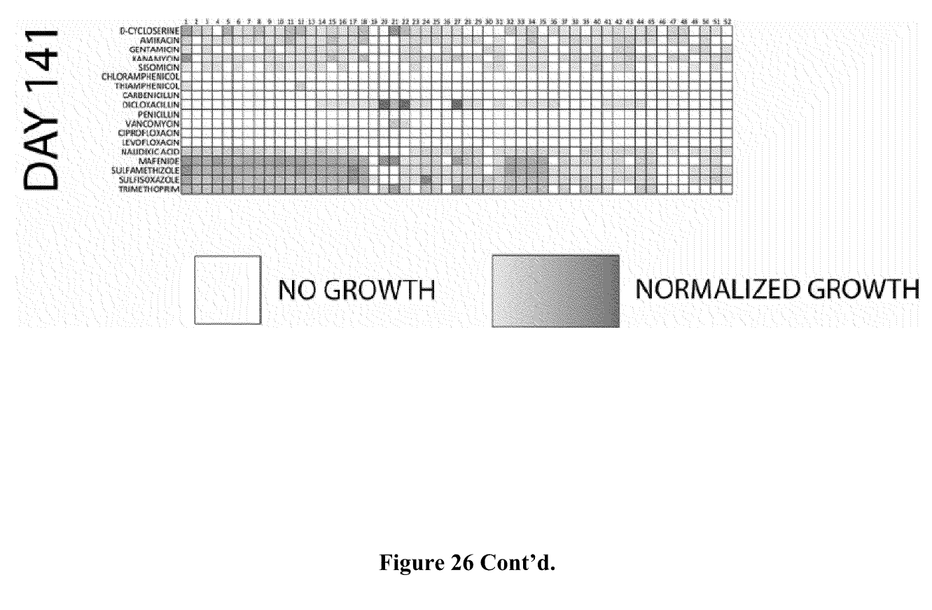

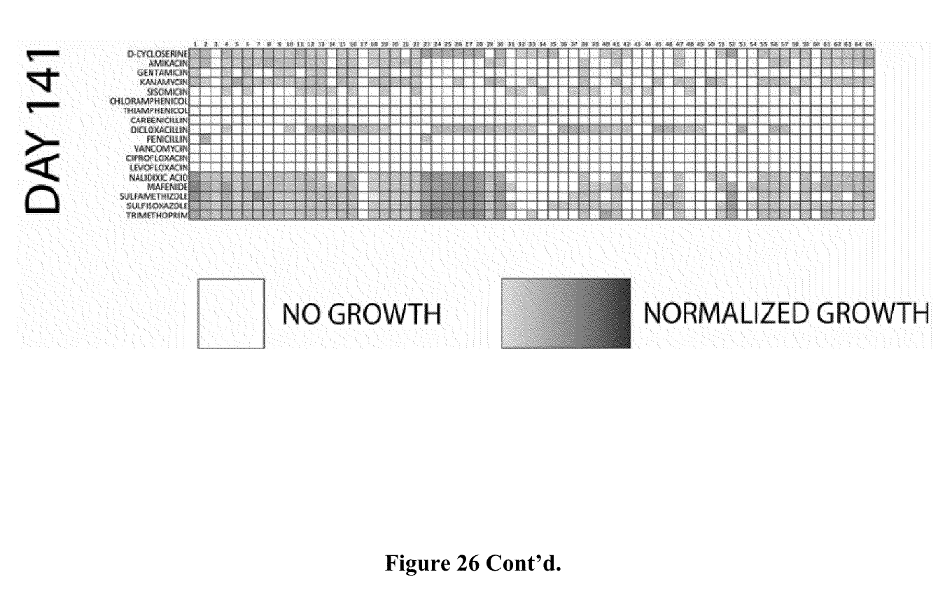

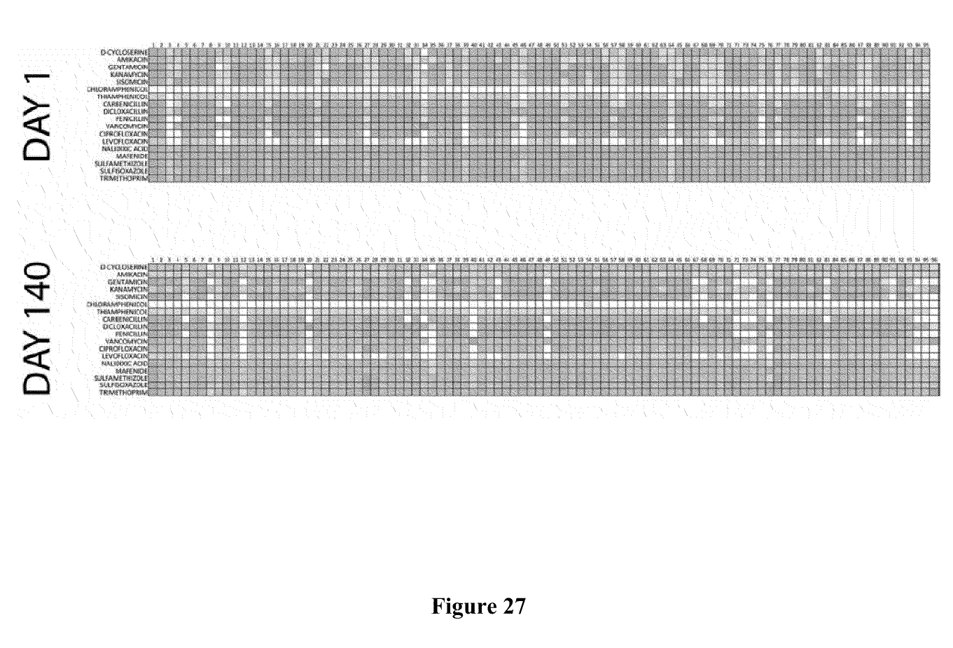

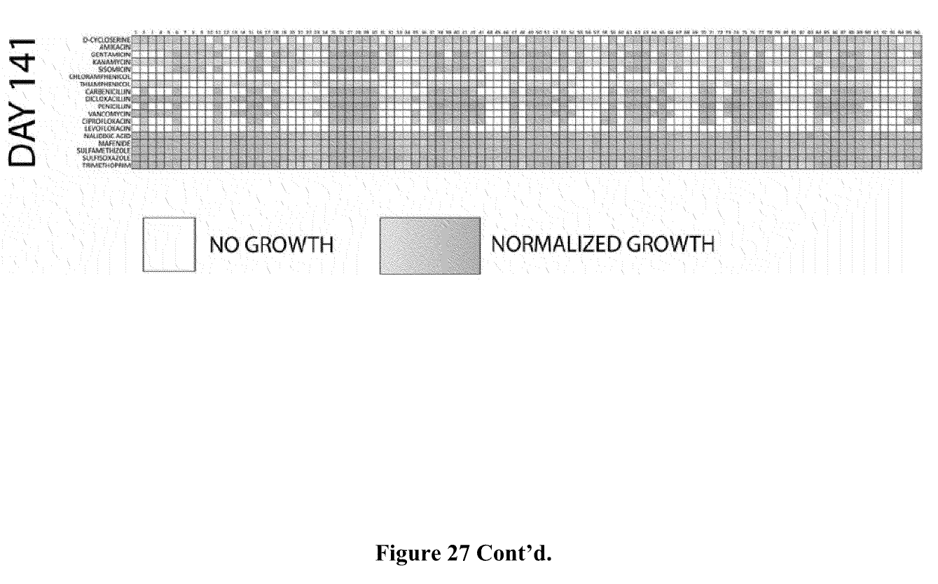

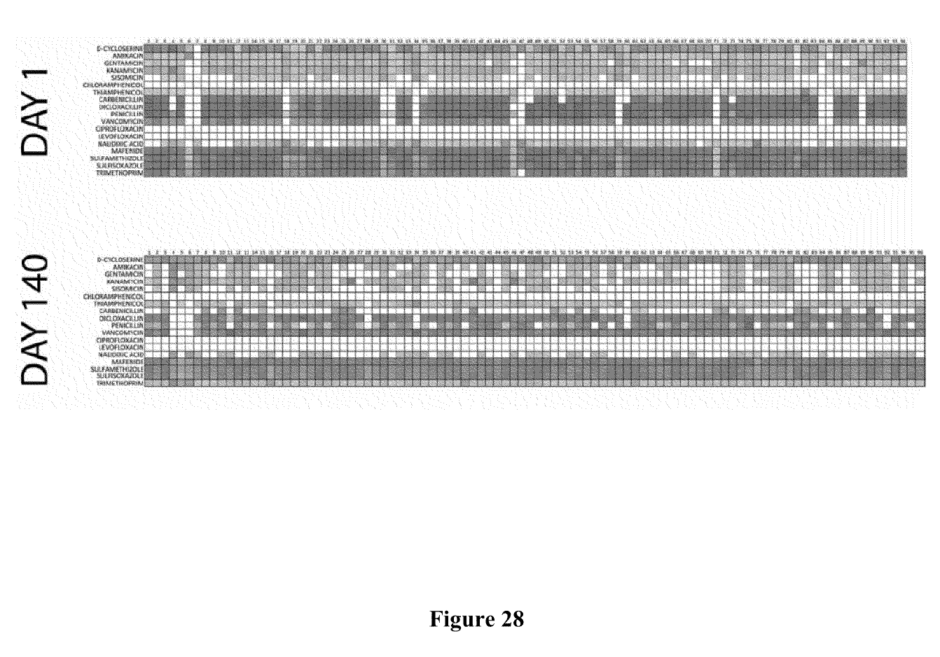

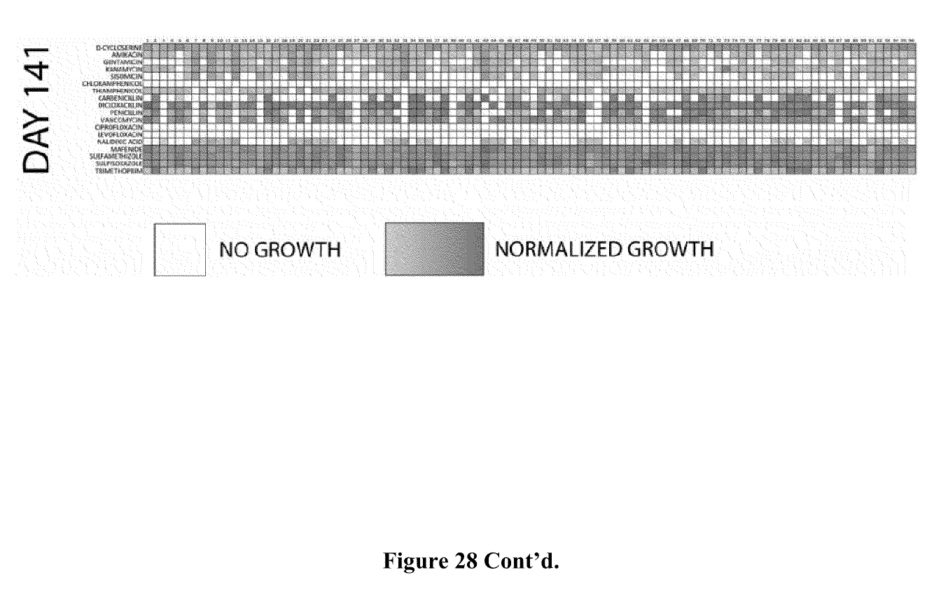

1102 bacterial strains were isolated from 5 human-associated microbiomes originating from 3 unrelated healthy individuals who had been antibiotic therapy free for at least 1 year. Oral microbiomes O1, O2 and O3 originated from individuals 1, 2 and 3, respectively, and gut microbiomes G1 and G2 originated from individuals 1 and 2, respectively. Three samples for each microbiome were collected at days 1, 140 and 141, from which the bacterial strains were isolated. Phylogenetic profiling of day 1 samples revealed that the oral microbiome isolates belonged to Firmicutes and Actinobacteria, whereas the gut microbiome isolates belonged primarily to Proteobacteria, with a few Firmicutes and Actinobacteria (FIG. 23), which is representative of the culturable fraction of the human-associated microbiome. The resistance of the 1102 bacterial isolates to 18 antibiotics comprising natural, semi-synthetic and synthetic compounds of different ages and from all major bacterial target classes were profiled (FIGS. 20 and 21, and FIGS. 24-28). These included some of the most clinically important antibiotics such as ciprofloxacin, levofloxacin and vancomycin (von Nussbaum, F. et al. Antibacterial natural products in medicinal chemistry—exodus or revival? Angew Chem Int Ed Engl 45 (31), 50725129 (2006)). Remarkably high levels of multiple antibiotic resistance were found in these human-associated microbiomes, with interesting variation in resistance profiles between the different personal microbiomes as well as within individual microbiomes over time.

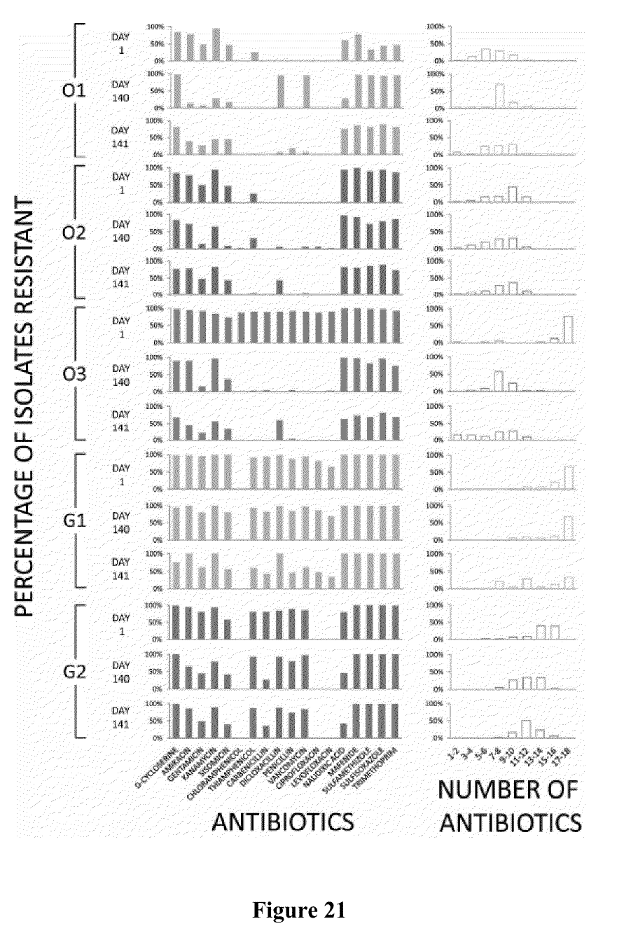

On average each bacterial isolate was resistant to 11 of the 18 antibiotics at concentrations of 20 mg/L (FIG. 21, right panels). The lowest levels of resistance were observed for the antibiotics chloramphenicol (7% resistant), levofloxacin (22% resistant), ciprofloxacin (26% resistant) and carbenicillin (39% resistant). Over 48% of isolates on average were resistant to each of the other antibiotics (FIG. 20). More than 70% of the oral microbiome isolates were susceptible to the amphenicols, fluoroquinolones, carbenicillin, penicillin, and vancomycin (FIG. 20). In comparison, only chloramphenicol and levofloxacin were able to prevent growth of more than 70% of the gut microbiome isolates (FIG. 20).

The microbiomic antibiotic resistance profiles appeared generally stable over time, when assayed either 1 day or 4 months apart (FIG. 2). Antibiotic resistance was maintained in all microbiomes at all sampling times to the sulphonamides, trimethoprim, aminoglycosides, D-cycloserine, and nalidixic acid. In addition the gut microbiome samples maintained resistance at all sampling times to the beta-lactams, thiamphenicol and vancomycin (FIGS. 20 and 21). Although the gut microbiome isolates from all sampling times harbored near complete multi-drug resistance, they were almost completely susceptible to chloramphenicol, and additionally G2 isolates are completely susceptible to the fluoroquinolones while over 50% of the G1 isolates remained resistant to these antibiotics (FIG. 21). This highlights the temporal stability of the sampled gut microbiome resistance profiles, as well as clear differences between individual human subjects. A striking example of temporal dynamics of microbiomic resistance profiles is seen in O3, where a majority of the isolates at day 1 are resistant to all antibiotics. In contrast, O3 isolates from day 140 and 141 are on average resistant to only 6-8 of the 18 antibiotics (FIG. 21), which closely resembles the distribution of multiple antibiotic resistance of O1 and O2 isolates at all three sampling times (FIG. 21, right panel). Even including the O3 day 1 isolates, oral microbiome isolates on average harbored significantly lower antibiotic resistance (8 of 18 antibiotics) compared to gut microbiome isolates (14 of 18 antibiotics).

These results demonstrate that the microbiomes of healthy humans constitute a reservoir of multiple antibiotic resistance determinants. Without intending to be bound by scientific theory, since no acquired resistance genes have been observed in human derived bacterial isolates from the ‘pre-antibiotic’ era (Hughes, V. M. & Datta, N. Conjugative plasmids in bacteria of the ‘pre-antibiotic’ era. Nature 302 (5910), 725-726 (1983)), it can be hypothesized that the high levels of antibiotic resistance observed in the microbiomes profiled in this work is a consequence of antibiotic exposure. The microbiome of an individual is established early in life and multiple factors such as human genotype, environmental exposures and diet are likely to impact the microbial community structure (Dethlefsen, L., McFall-Ngai, M., & Relman, D. A. An ecological and evolutionary perspective on human-microbe mutualism and disease. Nature 449 (7164), 811-818 (2007); Ley, R. E., Peterson, D. A., & Gordon, J. I. Ecological and evolutionary forces shaping microbial diversity in the human intestine. Cell 124 (4), 837-848 (2006)). While studies have suggested that the gross microbiome community structure may re-establish after the completion of antimicrobial therapy (Dethlefsen, L., McFall-Ngai, M., & Relman, D. A. An ecological and evolutionary perspective on human-microbe mutualism and disease. Nature 449 (7164), 811-818 (2007)), it is likely that the community becomes enriched in antibiotic resistance determinants, which may persist as an accessible reservoir for pathogens long after the original antimicrobial insult (Sjolund, M. et al. Persistence of resistant Staphylococcus epidermidis after single course of clarithromycin. Emerg Infect Dis 11 (9), 1389-1393 (2005)). The stable differences in resistance profiles observed between isolates from G1 and G2 are consistent with antibiotic exposure history playing an important role in establishing a personal antibiotic resistance reservoir (Sullivan, A., Edlund, C., & Nord, C. E. Effect of antimicrobial agents on the ecological balance of human microflora. Lancet Infect Dis 1 (2), 101114 (2001)). However, the massive temporal change in the antibiotic resistance profile of O3 highlights the importance of considering other factors which may influence the abundance and distribution of microbiomic antibiotic resistance determinants, since the human subjects sampled in this study were free of antibiotic therapy before and during the sampling.

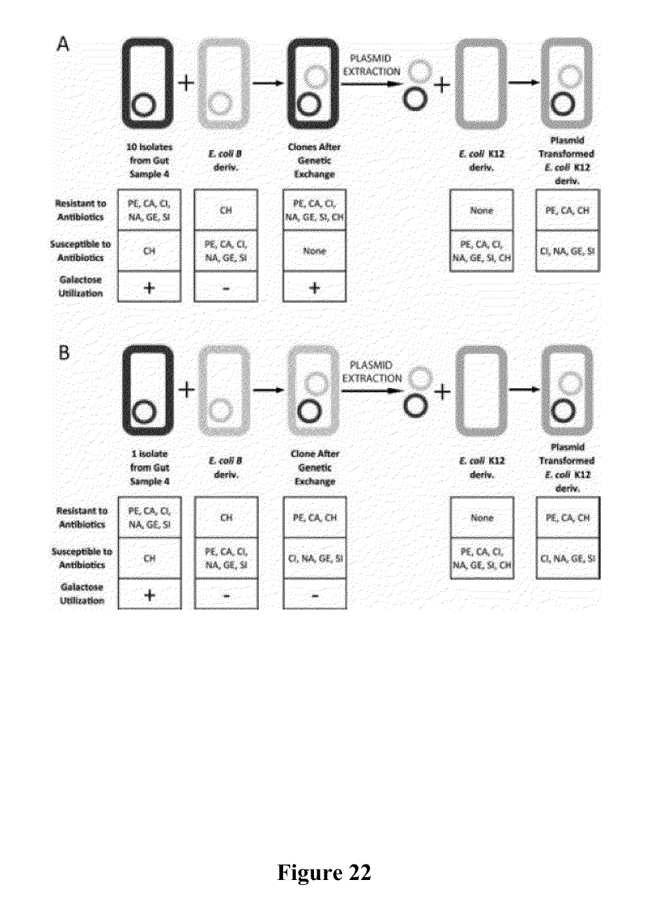

Strikingly, 87% of the O3 day 1 isolates were resistant to chloramphenicol, which distinguishes them from virtually all other isolates in this study, which are susceptible to this antibiotic. To uncover the potential for enrichment of antibiotic resistance determinants in the human-associated microbiome, the exchange of such determinants between the chloramphenicol susceptible G1 day 1 isolates and an Escherichia coli B strain containing a plasmid-borne chloramphenicol resistance gene were assayed for. Binary combinations of cultures of the 95 microbiome isolates and the chloramphenicol-resistant E. coli B strain were incubated for 24 hours at 37° C., followed by selection on combinations of chloramphenicol and other antibiotics used in this example, to which the E. coli B strain was susceptible. Clonal isolates were obtained from 11 mixed cultures which survived the selection, and their antibiotic resistance profiles were determined. Strikingly, 10 clonal isolates arising from the 95 mixed cultures had become resistant to chloramphenicol, as well as all the other antibiotics, consistent with the transfer of chloramphenicol resistance from the E. coli B strain to the microbiome isolates (FIG. 22). In addition, one isolate was resistant to chloramphenicol, carbenicillin and penicillin, consistent with the conjugal transfer of a beta-lactam resistance determinant from a microbiome isolate to the E. coli B strain (FIG. 22). That axenic cultures of the microbiome isolates and the E. coli B strain remained susceptible to the relevant antibiotics over the time scale of this experiment was re-confirmed. To verify that resistance determinants exchanged were encoded on extra-chromosomal DNA, plasmids were extracted from the 11 isolates with enriched antibiotic resistance, and transformed into another E. coli strain susceptible to chloramphenicol, carbenicillin and penicillin. In all cases the donor resistance to these three antibiotics was successfully conferred to the transformed E. coli strain. Subsequent phylogenetic analysis revealed that all microbiome isolates that successfully exchanged antibiotic resistance determinants belonged to the family Enterobacteriaceae. Interestingly, 71 other microbiome isolates belonging to the same family did not exchange antibiotic resistance determinants in this example, highlighting that subtle strain variations can impact these phenomena. The E. coli B strain used in the genetic exchange experiments is F-, and starts out unable to serve as a conjugal donor. The acquisition of plasmid-borne chloramphenicol resistance from E. coli B by 10 microbiome isolates is therefore not a result of a single conjugal event. Without intending to be bound by scientific theory, potential mechanisms for this transfer include, but are not limited to, transformation through natural competence of the microbiome isolates, phage-mediated transduction, and/or conversion of the E. coli B strain to a conjugal donor by transfer of conjugation machinery from the microbiome isolates (de la Cruz, Fernando & Davies, Julian Horizontal gene transfer and the origin of species: lessons from bacteria. Trends in Microbiology 8 (3), 128-133 (2000); Andrup, L. & Andersen, K. A comparison of the kinetics of plasmid transfer in the conjugation systems encoded by the F plasmid from Escherichia coli and plasmid pCF10 from Enterococcus faecalis. 145 (8), 2001-2009 (1999)). These results highlight the possibility for rapid exchange of antibiotic resistance determinants in and out of the human associated microbiome and underscore the dynamic nature of this antibiotic resistance reservoir.

From a clinical standpoint, the importance of an antibiotic resistance reservoir depends on its accessibility to human pathogens. This example demonstrates that constituents of the reservoir of antibiotic resistance determinants encoded by the human microbiome and other bacteria can be readily exchanged. These results reveal that the human-associated microbiome of healthy individuals constitutes a mobilizable reservoir of antibiotic resistance determinants, highlighting the accessibility of this reservoir to otherwise susceptible bacteria including human pathogens.

Environmental microbiomes, including those associated with animals used for human food, harbor a substantial reservoir of multiple-antibiotic resistance (D'Costa, V. M., McGrann, K. M., Hughes, D. W., & Wright, G. D. Sampling the antibiotic resistome. Science 311 (5759), 374-377 (2006); Dantas, G., Sommer, M. O. A., Oluwasegun, R. D., & Church, G. M. Bacteria Subsisting on Antibiotics. Science 320 (5872), 100-103 (2008); Aarestrup, F. M. et al. Effect of abolishment of the use of antimicrobial agents for growth promotion on occurrence of antimicrobial resistance in fecal enterococci from food animals in Denmark. Antimicrob Agents Chemother 45 (7), 2054-2059 (2001)). If humans hope to curb the rapid spread of antibiotic resistance in human pathogens, they must consider the impact of antibiotic use on all the interactions between the microbiomes associated with humans, agriculture and the environment. Much of the immense and diverse reservoir of antibiotic resistance genes present in the environment have not yet been observed in human pathogenic bacteria (D'Costa, V. M., McGrann, K. M., Hughes, D. W., & Wright, G. D. Sampling the antibiotic resistome. Science 311 (5759), 374-377 (2006); Riesenfeld, C. S., Goodman, R. M., & Handelsman, J. Uncultured soil bacteria are a reservoir of new antibiotic resistance genes. Environmental Microbiology 6 (9), 981-989 (2004)). However, the direct and continuous contact between farm animals and the soil increases the possibility of genetic exchange between their associated microbiomes, allowing for the transfer and selection of potentially novel soil resistance genes in farm animal associated microbiomes. It is clear that the large quantities of antibiotics currently used in agriculture selects for resistance genes in microbes associated with farm animals (Aarestrup, F. M. et al. Effect of abolishment of the use of antimicrobial agents for growth promotion on occurrence of antimicrobial resistance in fecal enterococci from food animals in Denmark. Antimicrob Agents Chemother 45 (7), 2054-2059 (2001)), and these antibiotic resistant microbes can be directly transferred to human associated microbiomes (Johnson, J. R. et al. Antimicrobial drug-resistant Escherichia coli from humans and poultry products, Minnesota and Wisconsin, 2002-2004. Emerg Infect Dis 13 (6), 838-846 (2007)). This accumulating reservoir of antibiotic resistance determinants can then be made directly accessible to human pathogens through interactions with human antibiotic resistance-enriched human-associated microbiomes.

### Example VI

### Materials and Methods for Example V

Microbiome Isolates and Antibiotic Resistance Profiling

Three sputum samples (oral microbiomes) and two fecal samples (gut microbiomes) were collected from three healthy volunteers at three different sampling times (day 1, 140 and 141), and fresh samples were plated on Luria broth (LB) agar. A total of 1102 colonies were grown in LB liquid medium for 16 hours at 37° C. These cultures were inoculated into LB medium containing concentrations of 20 mg/L of one of the 18 antibiotics: D-cycloserine, amikacin, gentamicin, kanamycin, sisomicin, chloramphenicol, thiamphenicol, carbenicillin, dicloxacillin, penicillin G, vancomycin, ciprofloxacin, levofloxacin, nalidixic acid, mafenide, sulfamethizole, sulfisoxazole, and trimethoprim. Cultures were incubated for 16 hours at 37° C. and growth was assayed by absorption at 600 nm.

Phylogenetic Profiling

16S ribosomal RNA genes were amplified using universal primers and sequenced as previously reported (Dantas, G., Sommer, M. O. A., Oluwasegun, R. D., & Church, G. M. Bacteria Subsisting on Antibiotics. Science 320 (5872), 100-103 (2008)). Phylogeny was determined using SeqMatch from the Ribosomal Database Project II server (Cole, J. R. et al. The ribosomal database project (RDP-II): introducing myRDP space and quality controlled public data. Nucleic Acids Res 35 (Database issue), D169-172 (2007)).

Mobilization of Antibiotic Resistance Determinants

Chloramphenicol susceptible gal+ microbiome isolates were grown for 16 hours at 37° C. in LB and 100 μL of each of these cultures was combined with 100 μL log phase cultures of an E. coli B derivative (F⁻ and gal⁻ and containing plasmid borne chloramphenicol acetyl transferase). Mixed cultures were incubated without shaking for 24 hours at 37° C. in LB and subsequently inoculated into LB containing combinations of chloramphenicol and one of the six antibiotics: gentamicin, sisomicin, carbenicillin, penicillin G, ciprofloxacin, nalidixic acid to which the E. coli B strain was susceptible. Cultures were incubated for 16 hours at 37° C. and clones were isolated from cultures surviving selection. Direction of transfer of resistance determinants was determined by assaying for galactose utilization using MacConkey galactose agar. Plasmids were purified from these clones and retransformed into an E. coli K12 derivative, which was subsequently assayed for resistance towards the 7 antibiotics.

What is claimed is:

1. A method of directly selecting a nucleic acid sequence that confers resistance to an inhibitory compound comprising the steps of:
a) isolating a plurality of first microorganisms;
b) creating a nucleic acid insert library directly from the isolated plurality of first microorganisms;
c) transforming a plurality of second microorganisms with the nucleic acid insert library;
d) contacting the transformed plurality of second microorganisms with an inhibitory concentration of the inhibitory compound; and
e) isolating a transformed second microorganism that is resistant to an inhibitory effect of the compound.

2. The method of claim 1, wherein the plurality of first microorganisms is a plurality of bacteria.

3. The method of claim 1, wherein the plurality of first microorganisms is isolated from an endogenous source.

4. The method of claim 3, wherein the endogenous source is one or more of a biomass, a mammalian sample and an environmental sample.

5. The method of claim 4, wherein the environmental sample is one or both of water and soil.

6. The method of claim 4, wherein the environmental sample is obtained from a toxic environment.

7. The method of claim 4, wherein the mammalian sample is derived from a human.

8. The method of claim 1, wherein the inhibitory compound is selected from the group consisting of an antibiotic, a heavy metal, a radioactive compound, a compound present in untreated biomass and a biomass byproduct.

9. The method of claim 1, wherein the plurality of second microorganisms is E. coli.

10. The method of claim 1, wherein the nucleic acid insert library is a genomic insert library.

11. The method of claim 10, wherein the nucleic acid inserts are about 30 kilobases or larger.

12. The method of claim 10, wherein the nucleic acid inserts are about 40 kilobases or larger.

13. The method of claim 10, wherein the nucleic acid inserts are between about 40 kilobases and about 50 kilobases.

14. A method of creating a microorganism having resistance to an inhibitory compound comprising the steps of:
a) isolating a plurality of first microorganisms;
b) creating a nucleic acid insert library directly from the isolated plurality of first microorganisms;
c) transforming a plurality of second microorganisms with the nucleic acid insert library;
d) contacting the transformed plurality of second microorganisms to an inhibitory concentration of the inhibitory compound;
e) isolating a transformed second microorganism that is resistant to an inhibitory effect of the compound;
f) isolating a nucleic acid sequence from the second microorganism of step e) that confers resistance; and
g) introducing the nucleic acid sequence into a third microorganism to create a microorganism having resistance to the inhibitory compound.

15. The method of claim 14, wherein the plurality of first microorganisms is a plurality of bacteria.

16. The method of claim 14, wherein the inhibitory compound is selected from the group consisting of an antibiotic, a heavy metal, a radioactive compound, a compound present in untreated biomass and a biomass byproduct.

17. A method of using the microorganism of claim 14 to decontaminate a contaminated substance comprising:
a) contacting the contaminated substance with the microorganism;
b) culturing the microorganism with the contaminated substance for an amount of time sufficient to reduce contamination of the contaminated substance.

18. The method of claim 17, wherein the contaminated substance is selected from the group consisting of contaminated soil, contaminated water and a contaminated work surface.

19. The method of claim 17, wherein the contaminated substance is a byproduct of a manufacturing process.

20. The method of claim 17, wherein the contaminated substance is an antibiotic, a radioactive compound or a heavy metal.
